(19) United States
(12) Patent Application Publication
(10) Pub. No.: US 2012/0084349 A1
(43) Pub. Date: Apr. 5, 2012

(54) User interface for user management and control of unsolicited server operations

(76) Inventors: Wei-Yeh Lee, New York, NY (US); Frank J. Kozak, Chicago, IL (US)

(21) Appl. No.: 13/135,249

(22) Filed: Jun. 29, 2011

Related U.S. Application Data
(63) Continuation-in-part of application No. 12/655,413, filed on Dec. 30, 2009.

(51) Int. Cl. G06F 15/16

(52) U.S. Cl. 709/203

(57) ABSTRACT

A trust architecture, including an intermediary for use therewith, which may be referred to as a Personal Privacy Stronghold (“PPS”), is disclosed which facilitates user management, including control, enablement, extension and augmentation, of unsolicited server operations, allowing the user to control such operations without compromising their ability to use other functionality. Such stateful operations may be used, for example, to monitor and track the user's Internet activities.

### REFERENCE TO RELATED APPLICATIONS

This application is a continuation-in-part under 37 C.F.R. §1.53(b) of U.S. patent application Ser. No. 12/655,413 filed Dec. 30, 2009 (Attorney Docket No. N0305US), the entire disclosure of which is hereby incorporated by reference.

### BACKGROUND

As the Internet continues to grow, its use for both business and personal activities is increasing, generally becoming a virtual community where people communicate with each other by sending and receiving electronic, voice and image messages for both business and pleasure. These communications may include sharing ideas and information, sending personal and business messages back and forth, researching information, expressing opinions and ideas both personal and political, and conducting business negotiations and transactions (generally referred to as “electronic commerce” or “e-commerce”). While the Internet supports many different applications and protocols, one of the most common applications/protocols used is the World Wide Web by which servers connected to the Internet provide access, via the Hypertext Transport Protocol (“HTTP”), to collections of interconnected electronic documents, referred to as “pages” or “web pages,” the collections being referred to as “sites” or “web sites.” These interconnected documents are often implemented using the Hypertext Markup Language (“HTML”) and feature content, including text and/or images, interactive functions, as well as “links” which interconnect and facilitate access to the other pages and functionality offered by the site.

The World Wide Web is intrinsically stateless, i.e., each request for a new Web page is processed without any knowledge of previous pages requested, because the basic HTTP protocol that defines the formats of the requests and corresponding responses does not define a mechanism for state information to be maintained. Hence, if a web site were to use only these basic communication protocols, it would be difficult for the web site to provide an interesting experience to its users, e.g., provide web pages that have been customized for a particular user based on the user's actions with respect to the web site or movement within, i.e. among the interconnected pages of, the web site. Generally, stateless operation refers to operations which do not depend upon, or are not a function of, a prior operation or transaction, whereas a stateful operation depends upon or is a function of a prior operation. A stateful operation with respect to a web site may be as simple as recognizing that a user or client-device has previously transacted with the site and, in response thereto, providing a customized message or page presentation to the user in a subsequent transaction. It may not be necessary that the web site actually specifically identifies the user but, instead, it may simply recognize that a particular user or client-device has accessed the site previously.

Because maintaining state information is useful, programmers have developed a number of techniques to add stateful processing to the World Wide Web. Some of these techniques may only permit stateful processing during a session, e.g. during a set of contiguous, or relatively contemporaneous, interactions with a particular web site and/or as long as the user's web browser program is not restarted, but are unable to maintain state once the user navigates to another site or restarts their web browser. Other techniques permit not only intra-session stateful operation but also inter-session stateful operation and may persist even if the user restarts their web browser program. One particular method involves the use of authentication whereby the user registers or otherwise logs in or affirmatively identifies themselves to the web site allowing the site to relate the user's activities. This method has an advantage that it can maintain state even across the different devices that a user may use to access the site and, because the user registers or otherwise identifies themselves, the specificity of the data that the site can gather is increased.

Another method of implementing stateful processing involves the use of client side persistent information, referred to as a “cookie,” which is a general mechanism and protocol used by server side of a connection to both store and retrieve information, such as state information, on the client side of the connection. With respect to cookies, a server, when returning an HTTP object to a client, may also send a piece of state information, i.e. state object or cookie, which the client, following the defined protocol, will store and which may include information relating to the state of the web site and/or the user. Included in that state object may also be a description of the range of Uniform Resource Locators (URLs) for which that state is valid. Any future HTTP requests made by the client to a URL which falls in that range will include a transmittal of the current value of the state object/cookie from the client back to the server according to the protocol. Where the site that sets the cookie has a URL within the cookie's URL range, the cookie is referred to as a “first party” cookie. A cookie, referred to as a “third party” cookie, may also be set with a URL range that includes other sites other than the URL of the site that set the cookie, allowing one site, e.g. a site presenting an advertisement, to provide state information to another site, such as the advertiser's site, should the user link from one site to the other. Thereby, cookies allow a web site to maintain state information about a user, within and/or across sessions, or across sites, storing that information on the user's computer. For example, a common use of cookies on e-commerce web sites is an electronic shopping cart feature that assists a user in selecting products for purchase where the user's selections are stored in a cookie as the user selects products for purchase. Cookies provide the additional benefit of offloading or decentralizing the burden of storing state information for multiple users to each user's client device rather than storing all of that data on the servers themselves, thereby minimizing required server resources.

Still another method of maintaining state recognizes that the communications generated by a user, i.e. the data packets which the user's web browser program, client or device transmits, as they communicate with a web site, may be characterized by numerous operational parameters as a result of the programs and protocols used to communicate, not the least of which may include the Internet Protocol address of the computer or device from which the communications are sent or proxied, the features or capabilities of the browser client or other application program used, and other parameters such as geographic location. While each individual parameter of any one communication from any one user may not be unique with respect to a communication from another user, statistically the variations across a subset of those parameters across a subset of the communications of a user, taken in their entirety, may be at least substantially unique among a subset of users even if not necessarily definitively identifying the particular user within the subset. As this information may be freely included with a user's communications transmitted to the Internet, a web site may be able to implement stateful functionality based thereon instead of, or in addition to, other stateful mechanisms, such as storing data using cookies.

Personal information includes information which identifies, describe or defines a user as an individual or as part of a subset of individuals and may include demographic information, firmographic information, user preferences, user activities or transactions and/or the context thereof, user identifying information, database records and accounts, and/or identifiers thereof, including financial, medical and governmental, or combinations thereof and/or derivations therefrom. Personal information may be comprised of discrete data elements, such as factual or other information directly or indirectly provided by a user, and/or may be derived therefrom and/or the relationships therebetween, such as from the user's interactions with, and navigation between, various web pages and web sites in concert with knowledge of the content or subject matter of those pages or site. It will be appreciated that the simple premise of relating discrete user interactions on the Internet, in and of itself, or together with general or specific factual information, such as user identity, site content, context, etc., may enable the implementation of complex stateful functions which collect, relate and/or derive a user's personal information, including functions which directly benefit the user, e.g. persistent shopping carts, and functions which indirectly benefit the user, e.g. personal recommendations and targeted advertisements based on behavioral tracking and analysis. Still other stateful functions may not necessarily provide a meaningful benefit to the user, such as behavioral tracking and analysis upon which recommendations or targeted advertising to other users may be based. This data may be of value to marketing organizations as it permits them to focus and improve the return on investment of their efforts. Further, such data may have value to governmental, legislative or regulatory entities seeking to identify behavioral patterns which may be indicative, for example, of social, political or criminal activity. With the addition of other contextual information, such as geographic location data and/or temporal data, the accuracy and scope, and therefore the value, of these complex stateful functions, with respect to analysis of user activity, is further increased, allowing, for example, a marketer to market the right product to the right user in the right manner and at the right time and place to substantially guarantee that the user will purchase it.

While stateful operation on the Internet present technical challenges and provide tangible benefits, such operation further implicates public policy concerns with respect to user privacy and ownership of personal information, as the value derived may not always benefit, and in some cases, may harm, the person from whom it was derived. Further, even entities which collect private information with user consent may fail, deliberately or unintentionally, to adequately protect that information from misappropriation. Privacy may include allowing individuals to determine for themselves when, how, and to what extent information about them is communicated to others. Privacy is considered to be important, and many users of the Internet are aware of privacy rights and related issues. Given the value of personal information to marketers and other third parties, an individual's right to privacy may be compromised without their knowledge or consent, especially when the technology for doing so is complex, the exact operation is opaque to the individual, technical protections are non-existent or negligently implemented, and regulatory protections and enforcement are lacking, inadequate or ineffectual. For example, web sites which collect information to facilitate their stateful operation, often with the consent of the user, may be subject to theft via hacking or may turn around and sell the collected data to third parties without the consent of the user. While regulatory reforms have been proposed or implemented to protect privacy on the Internet, given the increased amount and specificity of an individual's private information that is being made available and the corresponding increased value placed thereon, it is expected that the demand for, and corresponding threats to, the user's private information will dramatically increase.

There have been some attempts to empower users with control over the use of stateful operations, such as cookies. For example, many web browsers allow a user to determine certain conditions for accepting cookies. The user of a browser application may enable and disable cookies, and in some instances, the user can request that the browser prompt the user before accepting a cookie, thereby alerting the user to the fact that a web site is attempting to set a cookie on the user's client device. However, the operation of these controls is not always easy to understand or convenient to use, thereby discouraging their use. Further, if the browser blocks the setting of a cookie on a user's client device, then the web site may return an error message that states that the web site cannot be properly viewed because the user has disabled the use of cookies, thereby denying certain functionality within the web site to the user.

As another example of user control over cookies, a user may employ a privacy service on the World Wide Web that acts as an intermediary for all of the data traffic to and from the user's client device, thereby allowing the privacy service to filter the user's data traffic and to perform certain privacy-enhancing functions on the user's data traffic. One of the privacy-enhancing functions of the privacy service may include blocking the transfer of cookies from a web site to a user's client device by caching cookies at an intermediate server, which then returns the cookies to the appropriate web site as necessary based on the requests that are sent from the client device through the intermediate server. However, these privacy services merely allow the user to switch on and off the cookie blocking/caching functionality.

One particular area where stateful operation is employed both to enhance and benefit the user experience, as well as for less beneficial purposes, is in the area of electronic commerce. The Internet is a complete marketplace, providing resources for researching products and services, shopping for products or services, and conducting purchases. With respect to researching and shopping on-line, the Internet provides users with search engines and access to a substantial amount of information. The Internet also provides a medium for product and service providers to advertise their offerings to an ever-growing audience. Media content providers publish their media on the World Wide Web on the web sites that they sponsor. The media content providers also provide the space on their web sites, or more specifically on the web pages containing the media content, for advertisements.

The larger media content providers include search engines, such as Google or Yahoo!, and traditional media publishers, such as the New York Times, Wall Street Journal, and CNN, for example. Media content providers rely on advertising as one source of revenue by selling space on their web pages to advertisers to display advertising content. Since media content providers may be literally anyone that has a web site, a wide variety of enterprises and individuals may be relying on advertising on the web as a source of revenue. Advertising is effective when the products or services being advertised are actually purchased. One way to increase the effectiveness of the advertisements is to, for example, tailor the distribution of the advertisement to a targeted audience or tailor the content of the advertisement to the individuals or groups of individuals to which it is presented, all based on a gathering and analysis of users' personal information.

The larger media providers have contributed to the growth of advertisement on the Internet by implementing their own Ad servers, i.e., systems for managing advertising content, advertising campaigns and revenue generation, and their own operational advertising sales teams. More recently, Adnetworks, which are enterprises that provide access to ad servers which distribute the advertisements and eliminate the need for Content Sites to manage their own advertising sales teams, have supplanted some proprietary Ad servers to provide a broader one-stop-shop for advertisers. AdNetworks also dramatically reduce the advertising investment required by small content providers like bloggers and smaller web sites. Doubleclick is one example of an AdNetwork that has made a business of providing access to ad servers. Doubleclick and others like it may even offer on-line marketing resources such as strategies for on-line ad campaigns and ways to monitor an ad campaign's success.

Entities seeking to maximize advertising revenue, on the Internet or otherwise, such as those entities which obtain revenue from the placement of the advertisement, those entities that obtain revenue from the distribution of the advertisement, those entities that obtain revenue by creating the advertisement, as well as those entities whose products or services are the subject of the advertisement, have an interest in reliably and accurately monitoring and tracking users of the Internet, placing a high value, economic or otherwise, on the stateful operations which make that possible. This includes providing that such operations can be performed even if that means inseparably interweaving their use with user-desired functionality, the extent of their true function or the ability to control them, from the users themselves. Thereby, these entities centrally gather, or log, data regarding users and their activities, derive profiles of those users which can be used to drive advertising content and/or distribution decisions, and monetize those profiles.

### BRIEF DESCRIPTION OF THE DRAWINGS

The examples of the invention described below can be better understood with reference to the following figures. The components in the figures are not necessarily to scale, emphasis instead being placed upon illustrating the principles of the invention. In the figures, like reference numerals designate corresponding parts throughout the different views.

FIG. 1A is a block diagram of an example of a system for performing commercial transactions over the Internet.

FIG. 1B is a block diagram of an example of a personal data endpoint used in the system in FIG. 1A.

FIG. 2 is a block diagram of another example of the system shown in FIG. 1A.

FIG. 3 is a block diagram of another example of the system shown in FIG. 1A.

FIG. 4 is a block diagram of another example of the system shown in FIG. 1A.

FIG. 5 is a block diagram of another example of the system shown in FIG. 1A.

FIG. 6A is a cross-functional flow chart illustrating operation of an example of a method for performing anonymous personal usage tracking and synchronization.

FIG. 6B is a flow chart illustrating operation of an example method for controlling communication of a user's usage data.

FIG. 6C is a cross-functional flow chart illustrating operation of a personal data endpoint having ad server functions.

FIG. 7 is a cross-functional flow chart illustrating operation of a method for performing usage tracking and synchronization in a system that includes an anonymizing proxy server.

FIG. 8 is a cross-functional flow chart illustrating operation of a method for performing usage tracking and synchronization in a system that includes an external personal data endpoint.

FIG. 9 is a cross-functional flow chart illustrating operation of a method for performing usage tracking and synchronization in the system shown in FIG. 3 including an external personal data endpoint and anonymizing proxies.

FIG. 10 depicts block diagram of an intermediary for use in a client-server architecture according to one embodiment.

FIG. 11 depicts a block diagram of exemplary logical implementations of the disclosed trust architecture and intermediary for use therein according to one embodiment.

FIG. 12 depicts an alternative block diagram of the logical implementation of the disclosed trust architecture and intermediary for use therein.

FIGS. 13A-H depicts a flow chart demonstrating operation of the intermediary of FIG. 10 according to one embodiment.

FIG. 14 depicts a flow chart demonstrating operation of the intermediary of FIG. 10 according to another embodiment.

FIG. 15 depicts a flow chart demonstrating operation of the intermediary of FIG. 10 according to another embodiment.

FIGS. 16A-C depicts a flow chart demonstrating operation of the intermediary of FIG. 10 according to one embodiment.

FIG. 17 depicts a block diagram of an exemplary computer system for implementing the disclosed embodiments.

FIG. 18 depicts an alternate block diagram of the intermediary of FIG. 10 according to one embodiment.

### DETAILED DESCRIPTION OF THE DRAWINGS AND PRESENTLY PREFERRED EMBODIMENTS

A trust architecture, including an intermediary for use therewith, which may be referred to as a Personal Privacy Stronghold (“PPS”), is disclosed which facilitates user management, including control, enablement, extension and augmentation, of unsolicited server operations, allowing the user to control such operations without compromising their ability to use other functionality. Such stateful operations may be used, for example, to monitor and track the user's Internet activities. Further information describing the PPS may be found in U.S. patent application Ser. No. 12/655,413 entitled “System And Method For Providing User Control Of The User's Network Usage Data And Personal Profile Information,” the entire disclosure of which is hereby incorporated by reference.

As was discussed above, entities which operate web sites on the Internet, as well as other service providers/entities which support revenue generating functionality via, or in support of, those web sites, such as entities associated with the creation, distribution and evaluation of advertising, are incentivized to monitor and track user activities using stateful functionality, both to offer advanced functionality to attract and retain users, as well as derive additional revenue via the exploitation of user personal/private information derived therefrom.

Since web sites have costs to operate, the operating entities thereof may provide their content and/or services, such as news, product information, search functions, email functions, etc., in exchange for some form of compensation, monetary or otherwise, from the user, e.g. in exchange for a site access/subscription/membership fee, in exchange for the user's purchase of, or the chance the user may purchase, products or services offered for sale via the site, and/or in exchange for the user viewing and/or selecting advertisements, referred to as a “click thru” (in which case the site may be compensated by the advertiser or the advertisement distributor), etc. Advertisements may include display, banner or text advertisements, which may include selectable links to the advertiser's or another third party web site, comprising graphic images and/or text which are located in a portion of a web page or in a separate “pop up” window. Advertising compensation ranges from simply paying for placement or paying for click-thru/selection, referred to as “pay-per-click” to paying only if the user ultimately purchases the advertised product or service. As will be described, advertisers, or the entities operating in support thereof, may compensate a site for access to personal information regarding the users of the site, regardless of whether the advertising entity presents advertising on the site. Such information may be used for other purposes, such as the presentation of advertising on other sites.

Due to the dynamic nature of a web site, advertisements presented via a given web site need not be static and, in fact, may be changed quite rapidly, such as each time a web page is accessed. In some cases, advertising presented on a web page can be changed while the user is viewing that page. The dynamic nature of advertising presentation allows advertisements be selected for presentation based conditions and other factors. In the simplest system, an advertisement may be selected and fixed at the time a web page is created, and thereby presented each time the web site is accessed. Alternatively, random advertisements may be selected from a pool of available advertisements, such as each time a web page is loaded. Still further, as will be surmised from the discussion below, advertisements may be selected according to algorithms based on the personal information of the user accessing the web page gathered via the application of stateful operations.

While, as discussed above, web sites, referred to as first party web sites, may use stateful functionality to enhance the user experience in the hopes of attracting and retaining users, this functionality may also be used to increase, or as an additional source of, revenue such as by enhancing the site's value proposition to marketing or advertising entities, e.g. increase the amount they can charge for advertisement placement, or, via the sale of the data derived from the use of stateful functions. In fact, the purpose, and revenue proposition, for some web sites, Internet service providers or other Internet entities, such as the AdNetworks described above, referred to as third party web sites, third party providers or third parties, may be the monitoring/tracking, or profiling, of users, and/or or the creation, distribution, or management of advertisements, for other web sites. For example, by establishing a user base comprising a particular user demographic, the value of advertising placement on a web site to a marketer of products tailored to that demographic is increased as advertisements placed on that site are more likely to be successful and result in more sales of the product. Where a product advertisement may be tailored to appeal to different demographics, the ability to identify the particular demographic of a given user and present a suitable advertisement to that user may also increase the conversion rate of the advertising, i.e. the completion of an actual sale or simply the success in having the user select the advertisement to link to additional product information. In addition, with respect to mobile e-commerce, discerning the geographic location of the user, or other contextual information, can be used to further tailor the targeting and presentation of an advertisement to suitable times and locations.

More recently, marketing entities, in their efforts to improve the conversion rates of advertisements, have begun to broaden the types of data they seek to collect, such as location data, as well as the sources from which the data is collected, such as mobile devices, and analyze the collected data in new ways to derive advanced insights into the behavior of users, both specifically and generally, for the purpose, for example, of improving the conversion rates. For example, data collected relating to page visits and/or click-thru's, i.e. the clicking of an advertisement or other link provided via web page, in concert with knowledge of the content, e.g. subject matter or key words, of those advertisements or pages, and derivation of the recency and frequency of access, may be used to discern behavioral patterns and/or create profiles and/or profile databases of user behavior and/or segment or cluster users into target groups. Further, analyzing data in the aggregate, collected from one or many sources, may reveal explicit and implicit relationships between discrete elements not otherwise discernable from those discrete elements individually. Using these behavioral analytics, marketing entities are able to more tightly tailor, e.g. personalize, their message and/or distribution of advertising, to not only place the right advertisement for the right product in front of the right user at the right time and in the right place, but specifically tailor the message of that advertisement to persuade the particular user to buy the product or service, e.g. a 1 to 1 relationship. While advertisement tailoring commonly comprises a product focus, i.e. understanding the preferences or interests, e.g. the likes/dislikes, of the user and selecting products accordingly, more recent analytical techniques focus on the message, i.e. deriving data about the user to understand their motivations and tailoring the advertisement message accordingly to capitalize on those motivations and persuade the user, referred to as “persuasion profiling.”

Web sites may monitor and/or track, or otherwise collect data about, a user, intra- or inter-session, intra- or inter-site, using different mechanisms, such as: authentication whereby the user specifically identifies themselves to the site upon access thereto; via client side persistent information, e.g. cookies or active/executable programs/applets, whereby the site stores data, such as a state object or computer program, on the user's client which enables the site to track the user; via session tracking whereby the site utilizes dynamically encoded links, e.g. session id's, to track the user as they navigate around the site or from site to site; and/or via “finger printing” whereby the site exploits the unique variations in the intricate parameters characterizing the user's communications therewith.

Each method of monitoring/tracking users has various benefits and disadvantages, such as the transparency of the data gathering, the amount, types and accuracy of information that can be gathered, the reliability and consistency of the data, the specificity of the data, e.g. whether or not the user and/or the user's device can be specifically identified or merely identified as a member of a subset of users, as well as the size of that subset, whether or not the user can be tracked within a (intra-) site or between (inter-) sites, whether or not the user can be tracked within a (intra-) session or between (inter-) sessions, or whether the mechanism can be easily disabled or controlled by the user. In most cases, the monitoring/tracking functions of a site are unsolicited, and thereby may not be authorized by the user, regardless of whether or not the user is aware of their use. That is, while the user may have intended to access a given web site and may understand the implications of cookies, they may be unaware that the particular site has, in fact, utilized a cookie to monitor their activities. Further, where the user desires to access the content or functionality of a given site, if that content or functionality is intertwined with the unsolicited and unauthorized tracking functionality such that neither works without the other, the user may be unwilling to disrupt the tracking functionality, or may otherwise be coerced into allowing such functionality, out of concern that they would lose access to the site content or functionality that they desire.

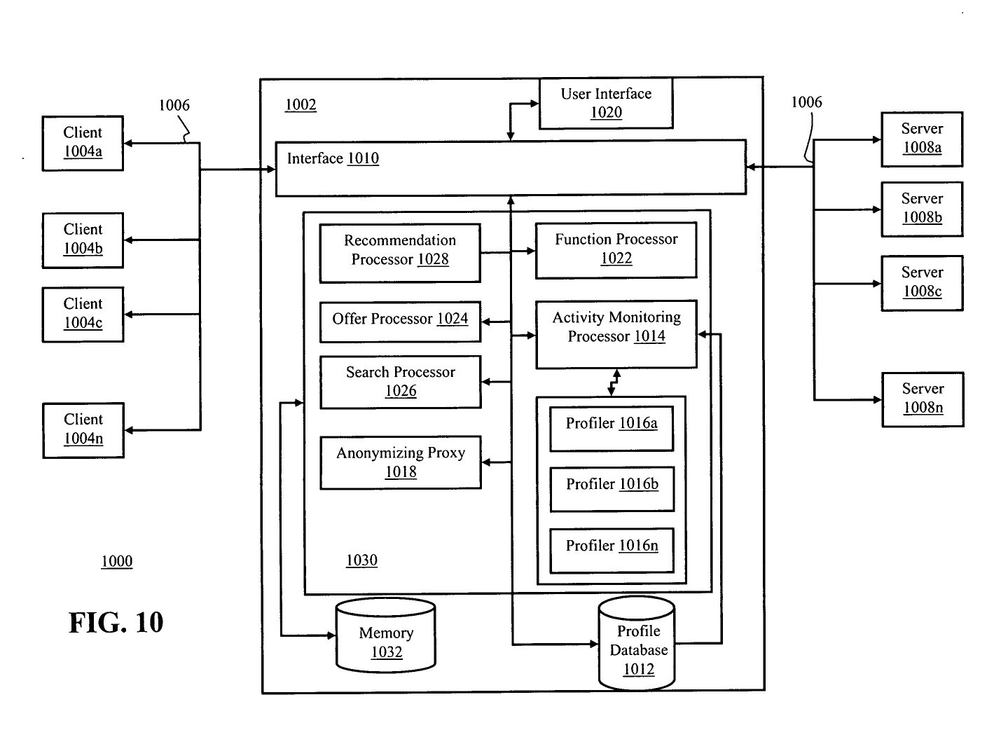

Referring to FIG. 10, there is shown a block diagram of an intermediary 1002, such as a PPS, for use in a client-server architecture 1000, such as to manage communications therebetween, according to one embodiment. The intermediary 1002, and/or the client-server architecture 1000 having the intermediary 1002 implemented therein, may be further referred to as a “trust architecture.” The client-server architecture 1000 includes at least one client 1004a-n in communication, via a network 1006, with at least one server 1008a-n. Each of the at least one client 1004a-n may include a device, or component thereof, operable to communicate over the network 1006, such as the interne, including a desktop or laptop computer, a mobile device, such as cellular telephone, smart phone, tablet computing device, and the like. A client 1004a-n may also refer to a software application, or component thereof, executing on a particular device, such as a web browser software application, electronic mail application, instant messaging application, media access application, etc., and a given hardware device may have more than one client 1004a-n implemented therein. The network 1006 may be a public or private, wired or wireless network, or combination thereof, such as the Internet. Each of the at least one server 1008a-n may include a web server, a database server, or other server connected to the network 1006. One or more of the server(s) 1008a-n are operative to perform at least one unsolicited function with respect to each of the client(s) 1004a-n, such as without direction from, or knowledge of, a user thereof (not shown), and upon which the same or another one or more of the server(s) 1008a-n is/are at least partially dependent to facilitate stateful operation thereof with respect to the respective client 1004a-n. In one embodiment, each of the unsolicited function(s) may include one of a first active function with respect to the respective client 1004a-n comprising provision of server 1008a-n originated, e.g. client- or user-identifying, data thereto or a second passive function with respect to the respective client 1004a-n comprising obtaining of client 1004a-n originated, e.g. client- or user-identifying, data therefrom. In one embodiment, the stateful operation of the one or more server(s) 1008a-n includes one of a tracking, monitoring, user identifying, user personal information gathering, usage data gathering operation, or combination thereof. While generally, a “user” may be an individual human actor, a user may also include other entities, such as corporate, charitable, and/or governmental entities or agencies, or other organizations, whereby the entity, such as an advertiser or a marketer of products or services, itself may be a user as described herein.

To clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superceding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

In one embodiment, the first active function comprises transmitting a unique identifier to a client 1004a-n to be stored, such as in a volatile or non-volatile storage medium, thereby for subsequent retrieval, such as in a cookie, or otherwise causing the client 1004a-n to transmit a unique identifier, such as a previously stored cookie stored by any of the servers 1008a-n, transmitting executable program code, such as a JAVAscript or an HTML5 program, to the client 1004a-n to be executed thereby to cause the client 1004a-n to transmit identifying data, and/or, in response to a request for content received from the client 1004a-n, adding additional content not requested by the client 1004a-n thereto and transmitting the content and the additional content to the client 1004a-n in response to the request, or combinations thereof. In one embodiment, the second passive function may include collecting identifying information about a client 1004a-n, such as identifying information characterizing one or more of the communications transmitted by the client 1004a-n, and/or relating or otherwise deriving additional or more specific identifying information from the collected identifying information.

As will be described herein, a particular user may be associated with one or more clients 1004a-n, a particular client 1004a-n may be associated with one or more users, a particular client 1004a-n may communicate with more than one server 1008a-n, a server 1008a-n may communicate with more than one client 1004a-n, and/or a server 1008a-n may communicate with one or more other servers 1008a-n. If one considers the stateful interaction between a client 1004a-n and a server 1008a-n as coupling one or more clients 1004a-n with one or more servers 1008a-n, the disclosed intermediary 1002 may operate to inhibit this coupling in the absence of a direction from the user to permit such coupling to occur, control the coupling such that it occurs only in manner as directed by the user and/or decouple the client 1004a-n from the server 1008a-n as directed by the user.

The intermediary 1002 includes an interface 1010 in communication, via the network 1006, with at least a first client 1004a of the at least one client 1004a-n and at least a first server 1008a of the at least one server 1008a-n. In one embodiment, the communications between the intermediary 1002 and the first client 1004a may be encrypted or otherwise secure. The interface 1010 is operative, such as via the execution by a processor 1030 of logic stored in a memory 1032, to, according to a direction of a user associated with the first client 1004a and derived at least in part from data indicative of previous interaction between the user and at least one of the at least one server 1008a-n, cause the first server 1008a to perform the at least one unsolicited function with respect to the intermediary 1002 on behalf of the first client 1004a, the stateful operation of the one or more of the at least one server 1008a-n at least partially dependent thereon thereby being subject to the direction of the user and, in one embodiment, disrupted thereby. It will be appreciated that the direction of the user may be based on user action and/or inaction, may include the failure to contradict and/or the acceptance, explicit or implied, of a default or pre-configured direction, may be derived from explicit and/or implicit instructions provided by the user to the intermediary 1002, may be derived at least in part from data indicative of previous interaction between the user and at least one of the at least one server 1008a-n via one or more of the at least one client 1004a-n, and/or may be derived at least in part from data indicative of previous interaction between another user and at least one of the at least one server 1008a-n via one or more of the at least one client 1004a-n, or combinations thereof.

In one embodiment, the first server 1008a may be unaware that it has been caused to perform the at least one unsolicited function with respect to the intermediary 1002 on behalf of the first client 1004a instead of with the first client 1004a itself. That is, the computer programs operating on the first server 1008a which perform the at least one unsolicited function, and which may further operate to expect a result, which may include no result, based thereon, receive the expected result, if any, such that the functions of the intermediary 1002 may be transparent to the at least one server 1008a-n. For example, the intermediary 1002 may be further operative to one of allow the at least one unsolicited function to be performed as if with respect to the first client 1004a, allow the at least one unsolicited function to be performed with respect to another client 1004b indistinguishable from at least one other of the at least one client 1004a-n, modify the at least one unsolicited function and perform the modified at least one unsolicited function with respect to the first client 1004a on behalf of the at least one server 1008a associated therewith, or inhibit the performance of the at least one unsolicited function. In this manner, the intermediary 1002 may be configured so as not to interfere with solicited server 1008a operations, such as the delivery of user-desired/solicited/requested media content or other third function performed by the server 1008a with respect to each of the at least one client 1004a or the intermediary 1002 at the direction of the user thereof, where the at least one unsolicited function is performed subsequent or substantially contemporaneous thereto. As the server 1008a may be unaware, as described above, as to whom or what it is interacting with, solicited functions intertwined with unsolicited functions may not be disrupted and may be caused to be performed with respect to the intermediary 1002 and/or the client 1004a. For example, the placement of a cookie by the server 1008a may be intercepted by the intermediary 1002 where the intermediary stores the cookie on behalf of the client 1004a and provides the cookie back to a requestor subject to additional conditions directed by the user such that the cookie may be provided back to the server 1008a to allow the server 1008a to provide requested content or functionality to the client 1004a but not be provided to other requestors and may be deleted by the intermediary 1002 when the user has completed their interactions with the server 1008a to prevent further use of the cookie.

The disclosed trust architecture and intermediary 1002 for use therewith may further implement a “personal cloud” providing the disclosed services at a user level independent of the devices or clients 1004a-n that the user may utilize to access the servers 1008a-n. That is, the functionality of the intermediary 1002 may be available or accessible to one or more users via any client 1004a-n used by a particular user, such as their mobile device, home computer, work computer, etc., such as by making some or all of the functionality or data centrally available to those devices and/or locating and/or synchronizing some or all of the functionality or data on each of the devices. Further, data utilized and/or generated by the intermediary 1002 and/or specified and/or provided by the user, such as the disclosed profile, may be centrally stored, such as in an encrypted or otherwise secure form, accessible by and/or synchronized among the user's devices, as described in more detail below. As will be described below, the intermediary 1002 may be implemented, for example, logically and/or physically between the clients 1004a-n and the servers 1008a-n, such as at a network 1006 access point, point-of-presence, peering point, etc. through which communications between the clients 1004a-n and servers 1008a-n must pass. The intermediary 1002 may be at least partially implemented as part of, as software and/or hardware, a router, gateway, switch, hub, modem, or other appliance, etc. Alternatively, the intermediary 1002, or portion thereof, may be implemented as a component, software, hardware, or a combination thereof, of the clients 1004a-n, such as a software component, e.g. a plug-in, of the web browser application of the client 1004a-n. The intermediary 1002 may further include components, software and/or hardware, which are shared and/or synchronized among clients 1004a-n. It will be appreciated that the functionality of the intermediary 1002 may be provided on a subscription or other limited use basis only to a subset of users, and their respective clients 1004a-n, such as to users of devices manufactured by a particular manufacturer or subscribers to a particular internet service provider, and, as such, the implementation of the intermediary 1002 may be arranged so as to be accessible only to that subset of users and their respective clients 1004a-n. Accordingly, in one embodiment, the interface 1010 may be further operative to, according to the direction of the user, cause the first server 1008a or a second server 1008b to perform the at least one unsolicited function with respect to the intermediary 1002 on behalf of a second client 1004b, etc.

In one embodiment, the data indicative of previous interaction between the user and at least one of the at least one server 1008a-n, from which the direction of the user is derived at least in part, may be included, contained or recorded in one or more electronic data files or records, such as a profile or user profile maintained by the intermediary 1002, alone or with other user profiles, such as in a database or other storage 1012, and may be encrypted or otherwise securely maintained, which may be referred to as a profile database. For example, the interface 1010 may be further operative to intercept a communication, such as one or more data packets, transmitted from the first client 1004a, or another client 1004a-n associated with the user, to a destination, such as one of the at least one server 1008a-n, prior to the receipt thereby, and one of copy at least a portion of the communication and store the copy in a storage 1012 associated with the intermediary 1002, store data about or representative of the communication in the storage 1012, delete the communication, forward the communication to the destination, forward the communication to a different destination, modify at least a portion of the communication and forward the modified communication to the destination, modify at least a portion of the communication and forward the modified communication to a different destination, or combinations thereof. For example, the communication may be a request for content by the client 1004a to a server 1008a wherein the interface 1010 modifies the request to request different content from the server 1008a or modifies the request, such as by modifying the destination address of the request, to request content from, or otherwise forwards the request to, a different server 1008b, or combination thereof. The interface 1010 may be further operative to intercept a communication transmitted from a source, such as one of the at least one server 1008a-n or another of the at least one client 1004a-n, to the first client 1004a, or another client 1004a-n associated with the user, prior to the receipt thereby, and one of copy at least a portion of the communication and store the copy in the storage 1012, store at least a portion of the communication in the storage 1012, store data about or representative of the communication in the storage 1012, delete the communication, forward the communication to the first client 1004a or another client 1004a-n associated with the user, forward the communication to a different destination, modify at least a portion of the communication and forward the modified communication to the first client 1004a or another client 1004a-n associated with the user, modify at least a portion of the communication and forward the modified communication to a different destination, or combinations thereof. For example, the communication may comprise a web page having links therein to cause the client 1004a to request additional content from another server 1008a-n, wherein the interface 1010 modifies the those links to cause the client 1004a to request content from a different server 1008a-n, such as by modifying the URL of the link to identify the different server 1008a-n.

The intermediary 1002 may further include a profile generator 1014 coupled with the interface 1010 and operative to analyze at least a subset of the stored copies of communications transmitted to or from the first client 1004a and generate a profile based thereon, the profile thereby comprising the data indicative of previous interaction between the user and at least one of the at least one server 1008a-n. Herein, the phrase “coupled with” is defined to mean directly connected to or indirectly connected through one or more intermediate components. Such intermediate components may include both hardware and software based components. Where the first client 1004a is operative to communicate via the network 1006 using a plurality of communications protocols, such as world wide web communications protocols, electronic mail communications protocols, instant messaging communications protocols, data transfer protocols or other proprietary or non-proprietary application communication protocols, the interface 1010 may be further operative to intercept only those communications using a subset of communications protocols specified by the user, the disclosed functions of the intermediary 1002 thereby being restricted to those specified communications protocols. Thereby, for example, the intermediary 1002 may be enabled to manage communications between web browser and web servers but otherwise allow other communications, such as electronic mail or instant messaging, to occur uninterrupted.

The profile may include a set of data, such as one or more records of a database, or other collection of data which stores and/or represents an aggregation, extraction and/or a derivation thereof, of the user's network activity, such as their past/historical interactions with one or more of the servers 1008a-n, one or more of the clients 1004a-n, and/or one or more other users. For example, the profile may store data representative of a user's web access activity, such as identifiers of web pages accessed by the user, referred to as “page visits,” data indicative of the content of those web pages, data representative of links selected by the user which link to other pages, referred to as “click throughs,” data voluntarily or involuntarily entered or uploaded by the user or otherwise provided to a web page, such as search/query terms, personal information, etc. The profile may store data representative of the user's electronic communications, such as electronic mail messages, instant messages, twitter messages, SMS (text) messages or other network communications. The profile may store data representative of the user's demographic or firmographic. The profile may store data which contextualizes other data, or changes thereto, stored therein, such as temporally, geographically, environmentally, or with respect to a specified internal or external origin, reference or scale. For example, the profile may store the time that, or duration over which, a particular web page was accessed, or the geographic location, or change therein, from which a particular web page was accessed. The profile may store data representative of the behavior of the user, the preferences of the user and/or the motivations, or underlying sensitivities, of the user. In particular, the profile may store derived data representative of the predicted behavior of the user. The data stored by the profile may be static and/or discrete data, such as factual, e.g. biographic, data, selections, preferences, samples, snapshots or extracts of dynamic data, defined below, and other discrete data items which, for example, may be less likely to change or change less frequently than other data. Alternatively, or in addition thereto, the data stored by the profile may be dynamic such as, for example, data which changes frequently and/or is continually, periodically or regularly derived from dynamic data as that data changes or static data as additional static data is accumulated or otherwise aggregated to the profile and/or data which varies based on a context of the client 1004a-n or user associated therewith, such as data which varies temporally or geographically.

As will be described, the data stored in the profile may relate to the user and/or other users associated with the user. For example, a user's profile may additionally store data associated with the spouse, children or other dependents or relatives of the user. Alternatively, a user's profile may additionally store data associated with employees, agents or other subordinates of the user.

The profile, being stored by the intermediary 1002, may be implemented as part of the personal cloud of the user, logically decentralized and accessible to any client 1004a-n used by the user. In one embodiment, as will be described in more detail below, a user may share their profile, or access thereto, or a specified portion thereof, with another user or other entity.

As described above, the profile may be created passively by the intermediary 1002 by monitoring the interactions between the user, via the clients 1004a-n used thereby, and the other clients 1004a-n, and associated users thereof, and/or the servers 1008a-n. Alternatively, or in addition thereto, the profile, as will be described in more detail below, may be actively created, modified and/or augmented, such as via the explicit provision of data by the user such, e.g. via control/preference settings/specifications, surveys or questionnaires, or other interfaces, or the participation and/or opt-in to the use of one or more passive data collection mechanisms.

The profile may further include data which controls access to the other data stored in the profile. For example, the profile may include data representative of access permissions, restrictions and/or conditions, referred to generally as “permission data.” Permission data may define which other users or other entities, and/or groups or classes thereof, such as servers 1008a-n or operators thereof, may or may not, as well as how and when they may, access the profile or portion thereof. Permissions, via the permission data, may be defined as inclusive and/or exclusive and default permissions may be defined in the absence of explicitly provided permissions. The permission data may define access to the profile by user and/or communications protocol, or otherwise define temporal and/or geographic restrictions governing access to the profile data, or combinations thereof. For example, the permission data may define dates or times when access is permitted and other dates or times when access is not permitted, and/or define, for temporally contextualized data in the profile, which data may or may not be accessed based on a temporal specification. Further, the permission data may define geographic regions or boundaries where access is, or is not, permitted to the profile, or portion thereof, or to particular data therein contextualized by the specified geographic parameters. For example, the permission data may prevent or permit access to the profile, or portion thereof, when the client 1004a-n, and/or user associated therewith, is located in a particular location. Alternatively, or in addition thereto, the permission data may prevent or permit access to data which was gathered or otherwise derived in a particular location. In this way zones of privacy may be created. In one embodiment, where the profile stores or derives data of varying detail/specificity, “blurring” may be implemented whereby, dependent upon the context of access and/or permission data specified, access to profile data may be limited to data of specified detail/specificity or the data may be modified to limit its detail/specificity. For example, contextual data relating to location may be limited to data representative of location within a certain margin or accuracy range to prevent the revelation of the specific location thereof. For example, the city in which the user lives may be accessible but the specific street address is not accessible. Permission data may be further utilized to define conditions under which profile data, or a portion thereof, may be accessed, such as geographic, temporal and/or monetary conditions. For example, the permission/restriction data may define a price for which the user will permit access. Additionally, the permission data may define data external to the profile that the user prefers to access, such as profiles, or portions thereof, of other users, which will be described in more detail below.

The intermediary 1002 evaluates the permission data to determine whether to enable or prevent access to the appropriate profile data. For example, the intermediary 1002 may cross map the permission data of one user against the permission data of another user to determine what a given user wants to see and what they are allowed to see. Cross mapping may occur at the time a user or entity attempts to access profile data. Alternatively, or in addition thereto, cross mapping may occur continuously, regularly or periodically, so as to, for example, present or otherwise display to any one user the information that is available to them to access.

As will be described below, the disclosed trust architecture, and intermediary 1002 for use therein, supports the implementation of additional applications and services provided thereby, referred to as “trusted apps.” These trusted apps may facilitate user control of the profile, re-enable functionality disrupted by the intermediary 1002 and/or extend or augment the functionality of the intermediary 1002. In addition to performing a specific service or function, a particular trusted app may further feed data relating to the user's interactions with, and the operations of, the trusted app back into the profile to further augment and/or modify the contents thereof.

In one embodiment, discrete, logically or otherwise, programs, referred to as profilers, profiling programs or profiling agents 1016a-n, are implemented by the intermediary 1002 to monitor, collect and/or derive profile data. Profilers 1016a-n may be defined to monitor, collect or derive particular data such as data related to a particular communications protocol, data of specific type and/or data related to a specific subject matter. For example, a profiler 1016a may be provided to monitor a user's web access activity and/or derive relationships, preferences or behavioral indicators therefrom, while another profiler may be provided to monitor, or derive data from, a user's instant messaging activity. Profilers 1016a-n may be implemented at a central processor of the intermediary 1002 or at the client 1004a-n, or combination thereof. It will be appreciated that one or more profilers 1016a-n may be implemented by a single computer program or multiple computer programs. Client 1004a-n based profilers 1016a-n may be implemented so as to be able to function when the client 1004a-n has no network 106 connectivity, e.g. is off line, such as when the cellular data network is unavailable. Such profilers 1016a-n may continue to collect data for later reporting when network 106 connectivity is reestablished.

The intermediary 1002 may perform its functions at the direction of the user, which may be derived at least in part from the profile. In particular, the user may provide explicit instructions to the intermediary 1002, such as via prompts or other interface mechanisms, to control the operation of the intermediary 1002 with respect to which servers 1008a-n will be caused to perform their stateful operation with respect to the intermediary 1002 on behalf of the client 1004a-n and user thereof. Alternatively, or in addition thereto, this direction of the user may be derived in whole or in part from the profile, such as based on one or more user preferences stored therein. In this way the user provides that the unsolicited operations of the servers 1008a-n are subject to their direction, express or implied, for example, to allow them to be performed with respect to the intermediary 1002, with respect to the client 1004a-n, or not at all. The profile provides a mechanism by which the user's preferences may be captured or derived to impart this control in a more automated and convenient manner, eliminating the need to continually interrupt the user for example. As will be described below, the profile further provides opportunities to provide enhanced or additional functionality to the user and/or provide monetization opportunities to the user.

As was discussed above, one function of the intermediary 1002 is to disrupt the stateful operation of the servers 1008a-n with respect to the client 1004a-n. In so doing, those servers 1008a-n that, for example, enable the monitoring and profiling by entities which derive revenue from advertising, may be prevented from performing their function, disrupting the advertising revenue model supported thereby. For example, as will be described in detail below, the intermediary 1002 may prevent a server 1008a-n from relating discrete user interactions therebetween by anonymizing the interactions and preventing the server 1008a-n from correlating one interaction with another, such as by preventing the server 1008a-n from depositing or retrieving a cookie, preventing link click-through tracking, and/or anonymizing the client's 1004a-n communications. This may prevent the server 1008a-n from selecting and/or presenting an advertisement to the user when the user accesses a web page on the server 108a-n and, therefore, the operator of the server 1008a-n may not receive compensation therefore. Accordingly, entities, which as described above, centrally gather, or log, data regarding users and their activities, derive profiles of those users which can be used to drive advertising content and/or distribution decisions, and monetize those profiles, all with limited, if any, user control or regulatory oversight, may be prevented from doing so.

The disclosed trust architecture, and intermediary 1002, logically decentralizes and enables user control of profile creation and access, and facilitates monetization by allowing the profile, or portion thereof, to drive advertising content and/or distribution decisions under the control of the user. The value, monetary or otherwise, of the profile is derived and/or improved because it may include data that is otherwise unavailable due to the operation of the intermediary 1002. Further the disclosed intermediary 1002 empowers the user to benefit from the profile value, directly or indirectly, as will be described in more detail below. For example, as the intermediary 1002 may disrupt stateful operations of server 1008a-n, the profiling of users based on that stateful operation is also disrupted. The intermediary 1002, by creating its own user profile, then provides an alternative means for the disrupted server 1008a-n to obtain the desired profile data, but subject to the direction, e.g. control, of the user. The profile compiled by the intermediary 1002 may further represent an improvement over what the servers 1008a-n might have derived had they been permitted to do so, as the intermediary 1002 may be privy to more, and/or more detailed, information about the user, such as their specific identify and/or demographic group, including information voluntarily provided by the user, such as their preferences and other biographical or factual information, thereby increasing the value of the profile. As will be described in more detail below, applications and/or functionality may be provided by the intermediary 1002 to allow the user to derive monetary value or other compensation, directly or indirectly, in exchange for allowing access to their profile, thereby further incentivizing the user to provide more, and/or more accurate/detailed, information, again increasing the profile value, etc. Such compensation may include monetary compensation or access to site content, e.g. free of advertising, in exchange for profile access. The user may permit access to their profile on a one-time basis, such as for access to current or historical specific factual or discrete information, or on a subscription (periodically or in real time) basis, such as for access to on-going user activity or other dynamic information.

In one embodiment, the intermediary 1002 inhibits passive stateful operations, such as operations which leverage the variations in the operational parameters characterizing the communications from the clients 1004a-n, referred to as a “finger print.” For example, wherein each of the at least one client 1004a-n is operative to transmit a plurality of communications, each of the plurality of communications of each of the at least one client 1004a-n being characterized by a set of attributes, at least one attribute of the set of attributes characterizing the plurality of communications of the first client 1004a being non-unique with respect to a corresponding attribute of another set of attributes characterizing the plurality of communication of another client 1004b of the at least one client 1004a-n, but wherein the set of attributes characterizing the plurality of communication of the first client 1004a is substantially unique with respect to the set of attributes characterizing the plurality of communications of the other client 1004b, the interface 1010 may be further operative, such as via an anonymizing proxy 1018 coupled therewith, to modify one or more attributes of the set of attributes characterizing the plurality of communications of the first client 1004a such that the modified set of attributes characterizing the plurality of communications of the first client 1004a is not substantially unique with respect to the set of attributes characterizing the plurality of communications of the other client 1004b. The set of attributes may include source IP address, user agent string, a client application identifier, data describing one or more capabilities of the first client, or combinations thereof. Thereby, the communications are anonymized, only in so far as they are non-unique with respect to a subset of clients 1004a-n, but not necessarily non-unique overall, such that a server 1008a-n may not be able to reliably distinguish one client 1004a from another client 1004b to base their stateful operation thereon. It will be appreciated that some parameters may not be altered, such as those parameters which affect the user's ability to access desired content. For example, the data identifying the type of web browser program used by the user may not be altered to prevent a web site from providing incompatible data. The interface 1010 may be further operative to modify, only during a session comprising the plurality of communications of the first client 1004a, the one or more attributes of the set of attributes characterizing the plurality of communications of the first client 1004a such that the modified set of attributes characterizing the plurality of communications of the first client 1004a is not substantially unique with respect to the set of attributes characterizing the plurality of communications of the other client 1004b.

As was discussed above, servers 1008a-n may augment requested content with additional unsolicited content prior to transmitting the requested content to the client 1004a-n. The additional content may include advertising content, additional selectable links, or references, e.g. URL's, which automatically load objects from other servers 1008a-n, such as advertisements, and/or codes inserted into selectable links to facilitate tracking of click-thru's. In one embodiment, the interface 1010 may be further operative to receive a second communication, i.e. a response, transmitted to the first client 1004a in response to a first communication transmitted, i.e. a request, by the first client 1004a, prior to receipt thereby. The interface 1010 may modify at least a portion of the second communication and forward the modified second communication to the first client 1004a, such as in accordance with the direction of the user.

For example, the interface 1010 may be further operative to identify at least one embedded reference, such as a URL, within the second communication, which may be at least a portion of an HTML web page, to a first object external to the second communication, e.g. an advertisement, the at least one embedded reference operative to cause the first client to transmit a third communication to request the first object; and modify the at least one embedded reference such that the modified at least one embedded reference is operative to cause the first client to transmit the third communication to request a second object, e.g. a different advertisement, instead of the first object. This may permit, for example, the intermediary 1002 to substitute embedded advertisements and provide, instead, a user selected and/or more relevant advertisement, such as an advertisement selected in accordance with the profile of the user. The substitute advertisement may be provided by an ad server (not shown) operated by the intermediary 1002 or by a third party.

Alternatively, or in addition thereto, the interface 1010 may be further operative to identify at least one embedded reference within the second communication to a first object external to the second communication, the at least one embedded reference operative to cause the first client to transmit a third communication to request the first object and delete the at least one embedded reference. Thereby, the unsolicited advertisement, for example, may be blocked.

Alternatively, or in addition thereto, the interface 1010 may be further operative to identify at least one embedded reference within the second communication to a first object external to the communication, the at least one embedded reference operative to cause the first client to transmit a third communication to request the first object and wherein the at least one embedded reference comprises additional data unrelated to the request for the first object which would be included in the third communication, such as data used to track click-thru of the at least one embedded reference, and modify the at least one embedded reference to remove the additional data, the modified at least one embedded reference still being capable of causing the first client to transmit the third communication to request the first object without the additional data. In this way, click-thru tracking may be inhibited allowing the user to freely navigate from, for example, a search results page, to one of the result pages, without being tracked by the search engine provider.

Alternatively, or in addition, to modifying requested content to disrupt stateful operation, the intermediary 1002 may inhibit or modify the operations of the unsolicited content. For example, the interface 1010 may be further operative to identify a communication from the first client 1004a, such as an HTTP GET request, comprising a request for a first object, such as an advertisement, from a first source, such as an Ad server, and one of respond to the request by providing a second object, e.g. a different advertisement, to the first client 1004a, forward the communication to a second source, e.g. a different Ad server, modify the communication to request a second object, e.g. a different advertisement, instead of the first object from one of the first or second sources, delete or otherwise drop the request, or combinations thereof. The interface 1010 may be further operative to identify the communication based on a prior communication transmitted to the first client 1004a and operative to cause the first client 1004a to transmit the communication. For example, the interface 1010 may monitor responses sent to the first client 1004a in response to requests for content, and analyze the responses to identify and log embedded references therein. Upon detection of a subsequent request from the client 1004a, the destination of the request may be compared against the log of embedded references and, if there is a match, take appropriate action. In this way, the interface 1010 may be able to distinguish user initiated requests for content from automatically initiated requests for advertisements initiated by the unsolicited references. Alternatively, or in addition thereto, the interface 1010 may be further operative to identify the communication based on an identification of the first source to which the communication is addressed, such as from a list of sources, e.g. a “black list.”

As was discussed above, servers 1008a-n may utilize client-side persistent data, e.g. cookies, to implement stateful operations. In particular, a server 1008a-n may, when a user first accesses a web site provided thereby, store a unique identifier on the client 1004a-n used by the user, such as in a volatile or non-volatile storage of the client 1004a-n or device. Should the user return to that web site at a later time using the same client 1004a-n, the stored unique identifier will be returned to the server 1008a-n thereby informing the server 1008a-n that the user has previously visited the web site. Additional data may also be stored on the client 1004a-n to further inform the server 1008a-n as to the prior activities and/or identity of the user. Client-side persistent data may also be stored by a server 1008a-n for subsequent retrieval by another server 1008a-n to facilitate a transfer of state information. For example, a given server 1008a-n may store data on the client 1004a-n identifying the server 1008a-n in a manner allowing another server 1008a-n, such as an advertising server, to retrieve the stored data and, thereby, know, for example, from what web site the user clicked a link to arrive at the advertiser's web site. This would allow the advertiser site to obtain otherwise unobtainable data regarding the user, such as data the user voluntarily provided to the first web site but would likely not volunteer directly to the advertiser, provide compensation for the click-thru or otherwise gauge the effectiveness of their advertising campaign.

In one embodiment, the interface 1010 may be further operative to, such as via the anonymizing proxy 1018 described above, intercept a communication transmitted from a source, such as one of the at least one server 1008-an, to the first client 1004a prior to the receipt thereby, the communication comprising data, such as a cookie, intended by the source to be stored by the first client 1004a and provided by the first client 1004a to a requestor, such as the source or another entity upon request. The interface 1001 may then be operative to delete the data or store the data on behalf of the first client 1004a and, on behalf of the first client 1004a and according to the direction of the user, provide the data to a requestor upon request. The interface 1010 may be further operative to store the data only during a communication session between the first client 1004a and the at least one server 1008a-n or store the data until instructed by the user to delete it. In this way, the interface 1010, and/or the anonymizing proxy 1018, implements “cookie hosting” in three forms, permanently hosted and provided upon request, session anonymous, i.e. stored and provided upon request only for the current session, and completely anonymous, i.e. cookies are deleted or not stored. The contents of the cookie may also be modified and/or augmented at the direction of the user to control the type and extent of information provided by the cookie.

Alternative, or in addition, to storing client side persistent data, such as cookies, some servers 1008a-n may provide executable software programs, such as in HTML5 or JAVAscript form, which, when executed or interpreted by the client 1004a-n, such as by a web browser program executing thereon, the gather, create or restore data regarding the client 1004a-n or user thereof. These programs may be designed to bypass restrictions enabled by a user to prevent the browser from storing and providing client-side persistent data, such as by recreating cookie files deleted by the user, referred to as “zombie” or “super” cookies. In one embodiment, the interface 1010 may be further operative to intercept a communication transmitted from a source to the first client 1004a prior to the receipt thereby, the communication comprising data intended by the source to be executed by the first client 1004a, such as HTML5 or JAVAscript code, to cause the first client 1004a to provide identifying data to a requestor upon request, and modify the data at the direction of the user to prevent the data from being executed by the first client 1004a to cause the first client 1004a to provide identifying data to a requestor upon request. The interface may be further operative to provide the modified data to the first client 1004a to be executed thereby to cause the first client 1004a to provide non-identifying data to a requestor upon request.

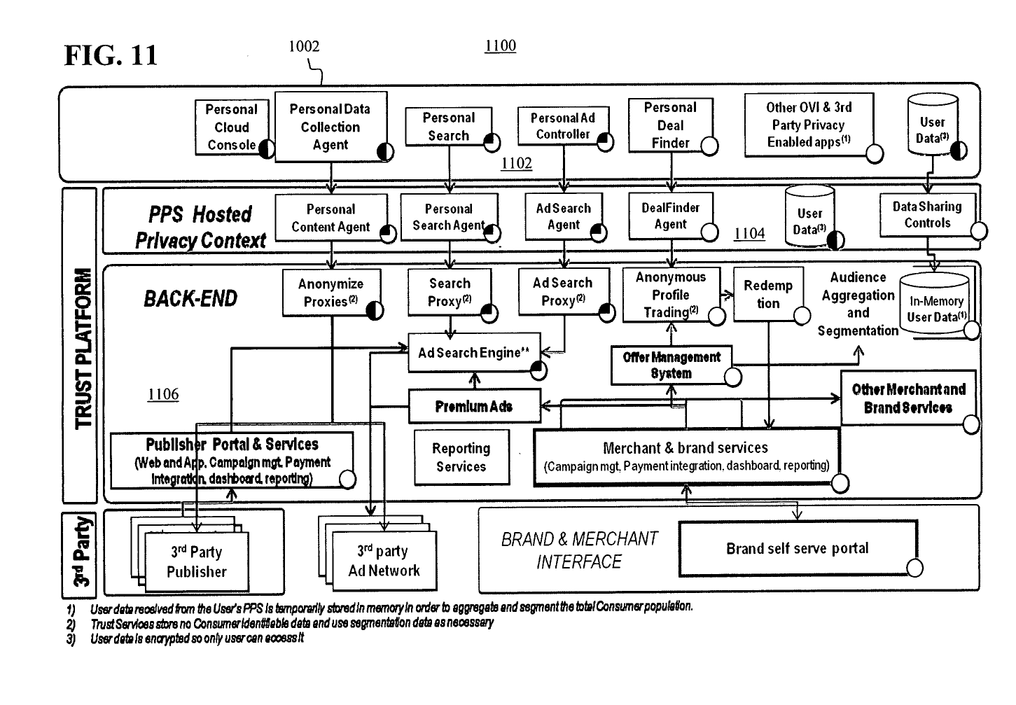

FIG. 11 shows a block diagram of an exemplary logical implementations of the disclosed trust architecture 1100 and intermediary 1002 for use therein. Generally the architecture 1100 includes several logical “layers” or contexts, referred to as the PPS or Local Privacy Context 1102, the PPS Hosted Privacy Context 1104, and the Back-End 1106. In particular, logical components of the Local Privacy Context 1102 support application of the trust architecture functionality with to or in association with each client 1004a-n and may include components which are implemented at, within or coupled with the client 1004a-n such as part of the device operating system, email program, instant messaging program or web browser client program, such as via a “plug-in” component. For example, these components may come pre-installed by the manufacturer of a device. Alternatively, the components of the Local Privacy Context 1102 may be implemented in a network appliance, router, switch, gateway, hub, modem or the like, through which the relevant communications flow, such as a home Internet gateway. Further, these components may be implemented so as to function, at least in part, locally and independent of the rest of the architecture 1100, such as when the client 1004a-n is unable to communicate with the rest of the architecture 1100. In this case, these components may perform functions locally and/or queue communications in a buffer to be completed, for example, once the client 1004a-n is again able to communicate. As will be discussed, in one embodiment, one or more of the logical components of the Local Privacy Context may be configured such that all communications to and from the client 1004a-n flow through the Local Privacy Context and may be processed thereby. In an alternate embodiment, only a subset of communications to and from the client 1004a-n, such as only those communications of a particular protocol, may flow through the Local Privacy Context 1102, the subset being, for example, determined by the user. The Local Privacy Context 1102 may redirect communications by the client 1004a-n to the Hosted Privacy Context 1104 for further processing and/or routing to their intended destination, such as a server 1008a-n coupled with the network 1006. Further, the Local Privacy Context 1102 may receive communications from the Hosted Privacy Context 1104 or the network 106 and process and/or deliver them to the client 1004a-n.

The Hosted Privacy Context 1104 may include logical components which support application of the trust architecture 1100 functionality to multiple clients 1004a-n such as those clients 1004a-n associated with a particular user. The application of the trust architecture across one or more clients 1004a-n that a particular user may use may be referred to as a “personal cloud.” For example, the Hosted Privacy Context 1104 may facilitate sharing of a user's privacy preferences between the various devices which the user uses to access the network. The logical components of the Hosted Privacy Context 1104 may implement functions in concert with one or more of the logical components of the Local Privacy Context 1102 and/or, as will be discussed, with one or more of the logical components of the Back End 1106. It will be appreciated that the logical components of the Hosted Privacy Context 1104 may be implemented at or within the client 1004a-n, at a server (not shown) in communication with the client 1004a-n, or a combination thereof.

The Back End 1106 may include logical components which support application of the trust architecture 1100 functionality across one or more clients 1004a-n of multiple users and/or facilitate communications between the Hosted Privacy Context 1102 and the network 1006, such as servers 1008a-n or other third-parties. The logical components of the Back End 1106 may implement functions in concert with one or more of the logical components of the Hosted Privacy Context 1104 and/or one or more of the logical components of the Local Privacy Context 1102. It will be appreciated that the logical components of the Back End 1106 may be implemented at the client 1004a-n, at a server (not shown) in communication with the client 1004a-n, or a combination thereof.

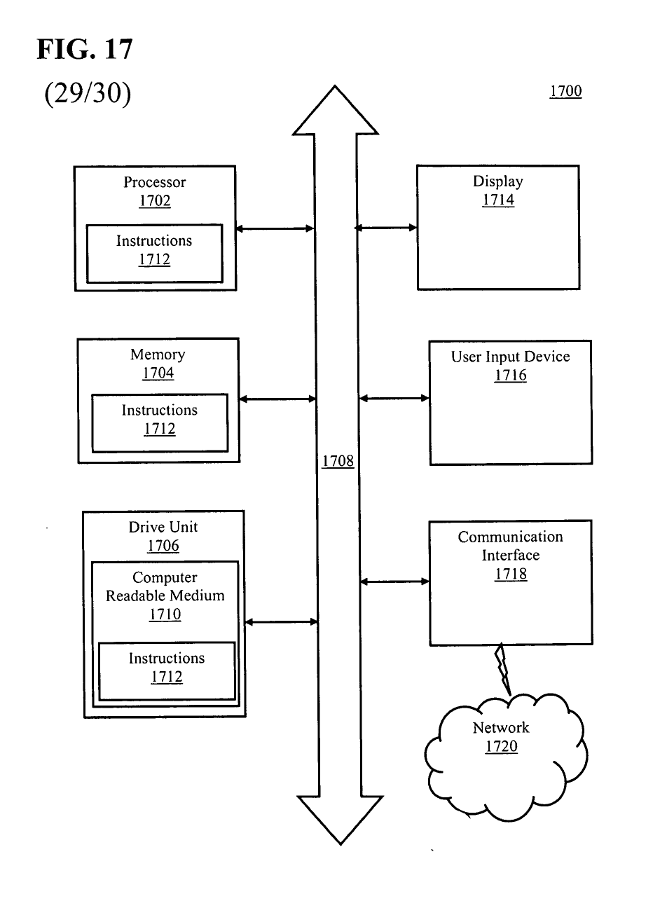

It will be appreciated that the logical architecture may include more or fewer components depending upon the functionality to be implemented and further, that there may be many ways to implement logical architecture of FIG. 11, now or later developed, and may include hardware, software or a combination thereof. In one embodiment, the computer 1700 disclosed below with reference to FIG. 17 may be used. The intermediary 1002, and trust architecture 1100 created thereby, may be implemented as a subscription or opt-in based service whereby a user installs the Local Privacy Context 1102, or components thereof, on one or more clients 1004a-n or devices which they use for network 1006 access. The Local Privacy Context 1102 is then operative to, as directed by the user, intercept and redirect at least a user determined subset of the communications from the client 1004a-n to the Hosted Privacy Context 1104. Other communications, such as those the user does not wish to route through the intermediary 1002, may flow to the network 1006 as usual. Communications to the client 1004a-n, from either the network 1006 or from the Hosted Privacy Context 1104, such as those communications responsive to previously transmitted communications, flow through the Local Privacy Context 1102 or not, as directed by the user. In an alternate embodiment, the intermediary 1002, and trust architecture 1100 created thereby, may be implemented as a mandatory or opt-out based service, such as by a device manufacturer, an Internet or telecommunications service provider or an employer whereby the components of the Local Privacy Context may be pre-installed or configured on the clients 1004a-n of the user to perform the disclosed functions. It will be appreciated further that the disclosed intermediary 1002 may be implemented so as to only be able to process data routed to it by a client 1004a-n, may be configured to intercept all data from a client 1004a-n and ignore data that is not to be processed thereby, or combinations thereof. The routing of communications among the clients 1004a-n, servers 1008a-n and the intermediary 1002 may be accomplished by reconfiguring or otherwise causing senders to route communications to the intermediary 1002, such as by configuring a client 1004a-n to use the intermediary 1002 as a proxy server whereby the intermediary 1002 acts on behalf of a sender to send a communications and receive responses thereto, or by interception and modification of the communication in transit, such as by modifying the destination address of the communications or modifying address translation, e.g. by modifying translation table entries of a Domain Name System (“DNS”) server, or packet routing mechanisms to the same effect, such as via deep packet inspection or other packet modification techniques. It will be appreciated that there may be many techniques and mechanisms, now available or later developed, which may be utilized to facilitate implementation of the disclosed embodiments.

Each of the logical components of the Local Privacy Context 1102, Hosted Privacy Context 1104 and Back End 1106 may, alone or in combination with another, implement a discrete function. Some components may be removed to remove functionality while other logical components may further be added to add new, different or modified functionality. The disclosed intermediary 1002 and trust architecture created thereby, further facilitate the implementation of such additional functions/functionality/applications, referred to as “trusted apps” or applications, to control, augment and or extend the architecture to facilitate user control of the intermediary 1002, to re-enable stateful functionality disabled or disrupted by the architecture, and implement new functionality.

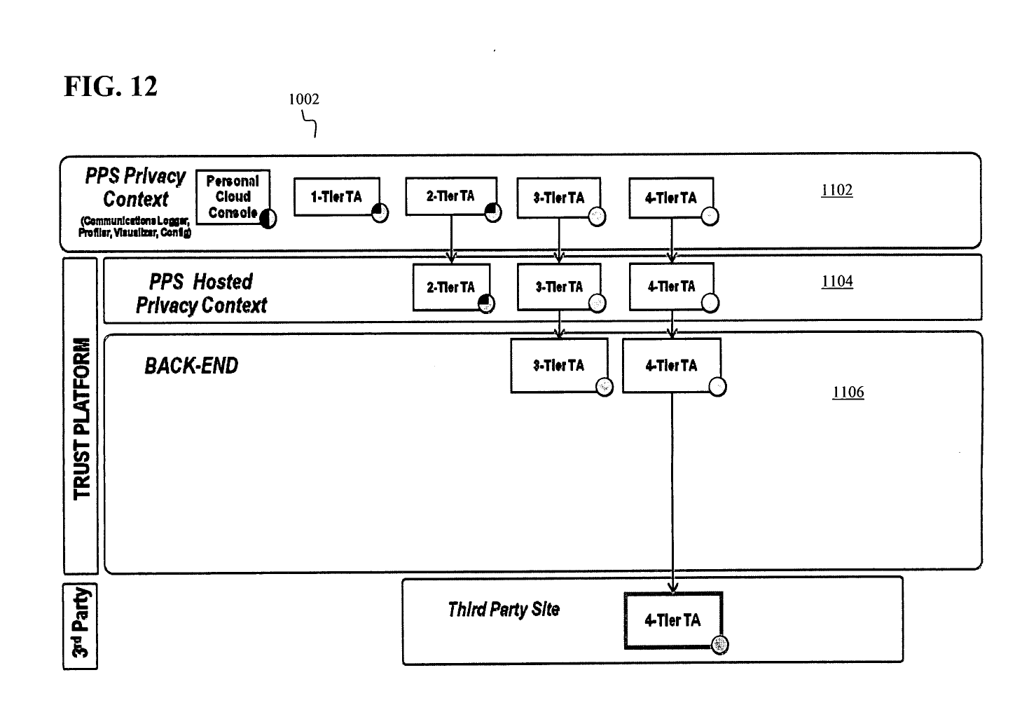

Referring to FIG. 12, trusted apps may be categorized by the functionality provided within the Local Privacy Context 1102, the Hosted Privacy Context 1104, the Back End 1106, and/or in concert with one or more external third parties, or combinations thereof. Trusted apps which provide intra-client 1004a-n and/or intra-device functionality may be referred to as “Tier 1” apps and may include applications such as data collection agents, i.e. applications which collect data relating to communications to or from the client 1004a-n, profilers, i.e. applications which process data collected by collection agents to derive profile information therefrom, or combinations thereof, as was described above, or content management apps, i.e. apps which allow a user to view, modify or otherwise manage content stored in their profile. In one embodiment, separate, logically or otherwise, data collection, profile and content management apps may be provided for different specific types of communications or profile content as well as communications/content generic apps whose functionality is generally applicable. Tier 1 apps may be operative to function in the absence of connectivity with the network 1006 or provide functions which do not require such connectivity.

Trusted apps which provide inter-device/client 1004a-n and/or intra-user functionality, instead of or in addition to intra-device/client 1004a-n functionality, may be referred to as “Tier 2” apps and may include apps, such as data collection, profiler and content management apps, whose functionality is shared amount the devices/clients 1004a-n used by a user, e.g. functionality of the user's personal cloud. Exemplary Tier 2 apps include apps which provide generally applicable functionality, such as apps which allow the user to control their profile, or the profiles of their children or other subordinates via or among various clients 1004a-n, or share their profile or other content with other users.

Trusted apps which provide inter-user functionality and/or which rely on common infrastructure components, instead of or in addition to intra-device/client 1004a-n and/or inter-device/client 1004a-n functionality, such as the components of the Back End 1106, may be referred to as “Tier 3” apps and may include apps which facilitate data sharing among users, such as social networking functionality, or which facilitate access to a common database, such as a search or advertisement database, or common function or set of functions.

Trusted apps which provide third party services, or access thereto, instead of or in addition to intra-device/client 1004a-n, inter-device/client 1004a-n, or inter-user functionality, such as services offered by the servers 1008a-n, may be referred to as “Tier 4” apps and may include apps which facilitate searching for information, access to third party content or other services.

In particular, trusted apps may be implemented, as a Tier 1, 2, 3 or 4 app, which allow a user to control or manage the content of and/or access to their profile, or otherwise allow the user to augment or modify their profile. Trusted apps may be implemented, as a Tier 1, 2, 3 or 4 app, to replace, re-create, fix and/or re-enable functionality which is displaced, disrupted, broken or disabled by the operations, such as the anonymizing functions, of the intermediary 1002, and trust architecture 1100 created thereby. Trusted apps may be implemented, as a Tier 1, 2, 3 or 4 app, which extend the utility of the profile as a user controlled logically decentralized inter-device and inter-user accessible secure information repository and provide services, such as content management, in association therewith, such as to provide an alternative to centralized third-party controlled repositories and services. Further, trusted apps may be implemented, as a Tier 1, 2, 3 or 4 app, which leverage the logical positioning of the intermediary 1002 between the clients 1004a-n and servers 1008a-n to enhance existing services or provide new services. While some trusted apps may be directed to managing or augmenting the user's profile and other trusted apps may be directed to providing other functionality, any of the trusted apps, as an additional function, may provide/store additional profile data to further augment the user's profile for use by the app which provided the data or any other trusted app subject to the permissioning and control by the user as described herein. As different users of the intermediary 1002 may desire to use or otherwise access the functionality of different trusted apps, each trusted app may be provisioned as a distinct instance to each subscribing user or as a single instance servicing all of the subscribing users, which may be controlled by a user accessible app provisioning function (not shown), accessible, for example, via a web page provided via the user interface 1020. The provisioning of a particular app may include transmitting the app or a component thereof, such as a plug-in, JAVA script or other computer program, to the client 1004a-n, or device, for execution thereby. Once instantiated, or otherwise provisioned, the trusted app executes, such as via the processor 1030, the client 1004a-n, or combination thereof, to perform the requisite function with respect to the subscribing user(s).

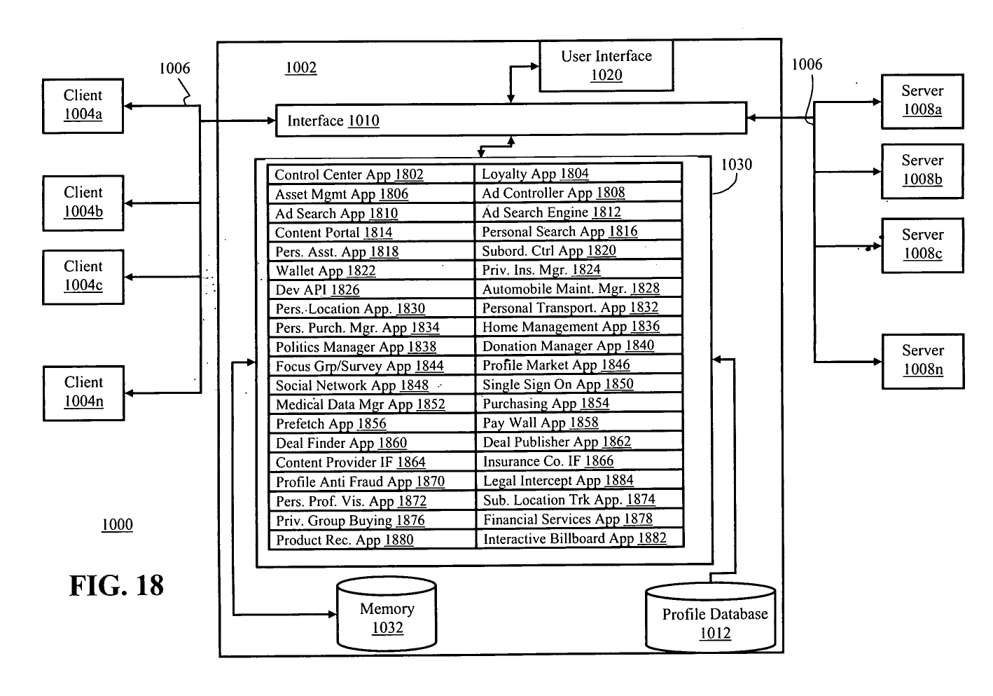

In one embodiment, as shown in FIG. 18, trusted apps may include one or more instances, provisioned to subscribing users, as described above, of a (Personal) Control Center/Console app 1802, a Loyalty app 1804, an Asset Management app 1806, an Advertisement (ad) Controller app 1808, an Advertisement (ad) Search app 1810 and Advertisement (ad) Search Engine 1812, a Content Portal app 1814, a Personal Search app 1816, a Personal Assistant app 1818, a Subordinate Control app 1820, a wallet app 1822, a Private Insurance Manager app 1824, Developer Application Program Interfaces 1826, an Automobile Maintenance Manager app 1828, a Personal Location app 1830, a Personal Transportation app 1832, a Personal Purchase Manager app 1834, a Home Management app 1836, a Politics manager app 1838, a Donation Manager app 1840, a Focus Groups and Survey app 1844, a Profile Marketplace app 1846, a Social Network app 1848, a Single Sign on app 1850, Medical Data Manager app 1852, a Purchasing app 1854, a Prefetch app 1856, a Pay Wall app 1858, a Deal Finder app 1860, a Deal Publisher app 1862, a Content Providers Interface 1864, an Insurance Company Interface app 1866, a Profile Anti-Fraud app 1870, a Law Enforcement Legal Intercept app 1884, a Personal Profile Visualization app 1872, a Subordinate Location Tracking app 1874, a Private Group Buying app 1876, a Financial Services app 1878, a Product Recommendation app 1880, or an Interactive Billboard app 1882. It will be appreciated that the functionality of one or more of the exemplary trusted apps may be provided by a single trusted app, individual functions of a particular trusted app may be implemented as distinct trusted apps, and that there may be other Trusted apps that may be implemented in accordance with the disclosed embodiments.

The functionality of one or more of the trusted apps may be managed and/or accessed via one or more web page based interfaces accessible to a web browser application executing, for example, on a client 1004a-n provided by the particular logical components of the app, or by a central app management component provided by the intermediary 1002. Alternatively, or in addition thereto, the functionality of one or more of the trusted apps may be managed and/or accessed via proprietary interfaces provided by the particular logical components of the app, and/or by a central app management component provided by the intermediary 1002.

In particular, the Control Center/Console app 1802 may provide functionality to allow the user to manage operation of the intermediary 1002 with respect to themselves, and as will be described, their subordinates, as well as manage and/or visualize their profile, and/or their subordinates' profiles, stored in the profile database 1012. The Control Center app 1802 may be considered a “front-end” or “portal” to the trust architecture and may provide access to other trusted apps or the functionality thereof. In particular, functionality may be provided which allows the user to specify how the intermediary 1002 interacts with servers 1008a-n on behalf of the user, or as will be described, another user, such as by specifying whether, and/or the degree to which the mediation/disruption/interruption/coupling/decoupling of stateful operations of the servers 1004a-n, such as cookie hosting, link blocking, GET request redirection, fingerprint anonymization, advertisement substitution, etc. may be applied. Further, functionality may be provided to allow a user to manage their profile, or another user's profile, e.g. inspect or otherwise visualize the content of their profile, or another user's profile, control what content is included in their profile, or another user's profile, and specify permission data to control access to their profile, or another user's profile. The control center app 1802 may provide content-generic functionality to allow profile management and/or functions, e.g. via apps, for managing specific content types.

As described above, management of the intermediary 1002 and/or profile may be implemented, for example, via one or more web browser accessible web pages generated by a Control Center Component of the Local Privacy Context 1102. Via the web pages, the user may view and analyze the profile information collected and/or derived on their behalf. The user may further edit, modify or augment the profile information such as to correct or adjust preferences represented therein, or provide additional data. In addition, the user may control the content, or the type thereof, of the profile by specifying which type of data may be collected, as well as when and where that data may be collected, such as by activating or deactivating specific data collection agents/profilers which target specific types of information. As was described above, data may be collected via communication logging, such as by logging data related to web access, email, SMS, instant messaging, Skype, etc. Data may also be collected via device sensor logging, such as GPS, compass, accelerometer, temperature, air pressure, proximity, near field communications, such as RFID or Bluetooth, optical or photographic or audio data, or combinations thereof. In particular, a personal location app 1830 or profiler may be provided which continuously or periodically determines the user's or client's 1004a-n location and stores this data in the profile and may further analyze the location data to derive and store data representative of a location or transportation profile, of the user such as the most visited locations or routes taken most often, modes of transportation, e.g. car, bus, public transportation, airplane, boat, etc., overall or temporally qualified, such as by weekday vs. weekend, morning vs. evening, etc. Further data, such as demographic, firmographic, and/or behavioral data, may also be collected via personal data entry, such as via forms or contextual data entry, or collected via derivation and/or extraction from other profile data or from external data sources such as proprietary or public databases. The user may also set permission data which controls access to, and/or, as will be described, management of, the profile by other entities, such as servers 1008a-n or other third parties, other users of the trust architecture, other trusted apps, other devices or clients 1004a-n, or combinations thereof. Such permission data may include conditions under which access may be granted which may further include temporal, geographic and/or compensatory conditions or other dependencies.

Via an interface, such as web page interface which may be provided by a Personal Profile Visualization app 1872, the user may visualize the contents of their profile, such as by viewing the actual data entries or representations or derivations thereof. For example, where location data is stored the profile, the user may be able to display the lists of locations, such as the geographic coordinates. Alternatively, they may able to view the location data via a map where the various locations are displayed thereon. The user may be able to display inferences, such as preferences, opinions or trends in behavior, derived from their activities, such as their purchase history, which may be used by a marketer to select a relevant advertisement. Further, functionality may be provided to analyze contextual data, such as geographic location or temporal information to derive a “contextual event horizon,” i.e. a predicted, probable or estimated future state or context of the user based on the current user context. Via the visualization of the profile contents, the user may be able to, for example via one or more other trusted apps, modify the contents, such as to change or delete content or add new content.

In one embodiment, the Control Center app 1802 facilitates user visualization and management of subordinate profiles such as the profiles of children or other dependents or employees, as well as operation of the intermediary 1002 with respect thereto. Such functionality, which may be provided via an additional component or app, e.g. a Subordinate Control app 1820, allows a parent, employer, principal, custodian or other superior, for example, to visualize, control and manage access to, the subordinate's profile content, e.g. to prevent, filter and/or monitor access to inappropriate or controlled third party content, protect the subordinate's privacy with respect to third parties, view data such as location data or set access curfews or other temporal, geographic, activity or access limitations or restrictions. The Control Center app 1802 may further allow a subordinate profile to be released to the subordinate's control, such as when the child turns 18 year of age. It will be appreciated that a user's ability to manage operation of the intermediary 1002 with respect to another user and/or manage another user's profile may be based on appropriately setting requisite permission data allowing or denying such access. Where the profile includes data indicative of user and/or client 1004a-n geographic location, e.g. gathered from a device's 1004a-n having an embedded or otherwise connected global positioning system (“GPS”) device or inferred, implied or interpolated based on other data such as visible Wi-Fi networks, IP address, or via explicit data entry, such data may be visualized, such as on a map. For superior users monitoring subordinate profiles, the user may be permitted to visualize the present location, path or historical locations, or changes thereto, e.g. movement, of the subordinate user, e.g. a parent may be able to monitor the location, or historical locations, of a child via the child's cell phone, an employer/principal may be able monitor the location or location history of employees/agents, etc. A school administrator may be able to monitor the location of students in their care.

In one embodiment, the Control Center app 1802 may permit a user to define thresholds or other parameters to alert the user when particular changes to their profile, or a subordinate user's profile, occur, such as the access to, addition, change to, or modification of data stored in the profile, or about to occur based on a trend, pattern or direction derived from the user's profile or changes therein. For example, the user may be alerted when a third party accesses the user's profile, or defined portion thereof, a user may be alerted when a subordinate visits a particular web site, a user may alerted when the location of their device, or a subordinate's device, changes location or moves, or is about to move, beyond or toward a defined boundary/threshold or location, etc. Such functionality may be used, for example, to detect theft of the client 1004a-n or keep track of a subordinate. For example, a Subordinate Location Tracking app 1874 may be provided which defines the permissions of profiles of students to allow access to location information stored therein to administrators, chaperones, parents, guardians or law enforcement, for example, whereby the administrator of a school, chaperone parent or guardian and/or law enforcement official, such as police or parole officer, may track the locations of the students, suspects or parolees, to confirm, for example, attendance/presence of the student at or away from a school. For example, a teacher may utilize this function to track students taking a field trip to make sure they do not leave their group. A school administrator may utilize this function to make sure that a student who reports absent due to illness is in fact at their home. In the case of an employer/employee, an employer may track the locations of employees to make sure that the employee is performing their requisite duties, e.g. not taking a personal detour in a company vehicle. An employer may track the location of employees, in particular within the employer facilities, to analyze space utilization and determine if consolidation is warranted to save on operating costs associated with excess real estate capacity. In the case of a business disaster such as a fire or other event, the employer may track the locations of employees to confirm that all employees were safely evacuated. It will be appreciated that an employee/user may define, as a condition of profile access by their employer, that the employer declare an emergency state in order to gain access to the profile, such declaration being recorded and reported for later validation. This may prevent unauthorized access by the employer.

In one embodiment, all of the various parameters which control operation of the intermediary 1002 or manage the profile may be individually controlled. Alternatively, or in addition thereto, templates of predefined combinations of parameters and associated settings may be provided, such as based on degree of desired privacy from fully anonymous to fully disclosed, or based on the type or character of content, which permit the user to choose, for example, from respective categories to configure the operation of the intermediary 102 and/or profile. It will be appreciated that once a user has chosen a configuration template, they may be able to further adjust individual settings to further tailor their configurations, which they then may be able to save as their own custom template. Alternatively, or in addition thereto, the user may be able to create and save their own configuration templates. Further, a provider of the intermediary 1002 or of a client 1004a-n may preconfigure or provide default settings on behalf of the user which may or may not be modifiable by the user.

The Control Center app 1802 may further provide functionality to allow a user to voluntarily add content to the profile, such as preference, biographic, demographic, firmographic or other personal information, including information which might otherwise be inaccessible to the intermediary 1002, such as personal photographs. As will be described, this capability of leveraging the profile as a user controlled logically decentralized inter-device inter-user accessible secure information repository may be facilitated by other trusted apps as will be described.

For example, a Social Network app 1848, and/or social networking functions, may be provided which utilizes the capability of the profile to receive and store information from the user and utilize permission data to control who, and to what extent, may access this data. As opposed to conventional social networking services which centrally store and control a user's data, a Social Network app 1848 implemented using the disclosed functionality of the intermediary 1002 permits the user to retain control of their data. In particular, the user may provide personal information such as photographs, or other content to their profile. Using the permission data, as described above, the user may then “invite,” e.g. define permissions to allow, one or more other users to access their profile or portion thereof. Upon the grant of permission by a user to another user, the Social Network app 1848 may notify the other user that they have been granted such permission. Further, as the permission data permits a user to further specify profiles, or portions thereof, of users that they would like to have access to, the social network app 1848 may further inform the other user of such a “request for access.” Where, in this manner, two users are “linked” by their respective permission data, either unidirectionally or bi-directionally, the Social Network app 1848 may further monitor a given user's profile, or portion thereof, and alert those other users with access permission to any changes to the data therein. Accordingly, the Social Network app 1848 may facilitate establishing of interconnections among two or more users, as well as interconnecting one or more users for the purpose of sharing profile data/content and pushing profile data/content, such as announcements or commentary. Further, the user may define their permission data to segregate access to portions of their profile to different users, user groups or categories of users, which may be static of or dynamic categories defined by the user, by the intermediary, or a combination thereof. For example, the user may store health related information in their profile and grant access permission thereto only to their physician. Similarly, access to work related information may be restricted to co-workers and personal information may be restricted to friends or family. The Social Network app 1848 may further permit the user to discover other users of the intermediary 1002 such as via a directory of users and/or a search function. A user may choose to exclude themselves from being discoverable, such as by setting appropriate permission data in their profile.

A Wallet app 1822 may be provided for storing and managing payment methods, such as credit card or account numbers, coupons or other offers, receipts, and other shopping/commerce related information, such as shopping lists, in the user's profile. Such functionality may be used by the user to pay, on line or in physical retail establishments, for goods or services, such as by displaying, visually, audibly or via radio frequency or other communications mechanism, payment information from the profile on their device/client 1004a-n, such as via the user interface 1020, e.g. via bar code or QR code or other signal such as a near field communication signal, and presenting their device/client 1004a-n to the merchant to effect payment. Such presentation may be effected by placing their device proximate to a sensor or other reader provided by the merchant. Access to the data stored by the Wallet app 1822 may be conditioned upon geographic location such that the data may only be accessed when the client 1004a is located in a particular geographic location or region. This may minimize financial losses due to theft or fraud. Receipt and other documentary evidence may be stored electronically, such as photographically or as a data record. The Wallet app 1822 may be further associated with the pay wall app 1858, disclosed in more detail below, and/or a payment medium provided by the intermediary 1002, to manage user accounts associated therewith for recording monetary or other, e.g. points, value accrued or owned by the user. The Wallet app 1822 may facilitate account management such as viewing available balances, authorizing or scheduling payments (one time or recurring), redemption, contributions, etc. A Purchase Profiler 1016 and/or Personal Purchase Manager app 1834 may further be coupled with the wallet app 1822 to analyze data representative of purchases made by the user to derive a shopping profile of the user with respect to preferences, opinions, etc., and/or provide product and/or services recommendations, which may then be stored in the profile and accessible, at the direction of the user, to other users or apps.

The Automobile Maintenance Manager app 1828 enables functionality to store and manage data about a user's vehicle in their profile. Such data may be provided by the user, derived from location data and/or obtained from the vehicle directly, such as via client 1004a-n operating in or otherwise coupled with the vehicle and which include GPS functionality as well as be coupled with the vehicles on-board diagnostics and other internal management systems. The collected data may then be analyzed to recommend, or otherwise remind the user about, maintenance services, provide route or travel related information, notify the user of recalls or service bulletins, link to operating manuals or guides, etc. The data collected and added to the profile further adds to the profile value to other parties who derive revenue from vehicle related products or services.

A Home Management app 1836 may be provided which allows a user to store and manage information related to their household in their profile. Where the user's home features home automation, such as X10 devices, or is otherwise outfitted with intelligent monitoring/management devices such as a home alarm or smart electrical power meter or other power monitoring device, a client 1004a-n, such as the user's home computer or mobile device, may be configured to interact with these devices to obtain data therefrom and otherwise issue commands thereto. For example, data may be logged which represents the user's use of home appliances, lighting or other device, the user's occupancy of one or more areas of the home, etc. From this data, profiles may be derived and stored in the user's profile on the intermediary 1002. Further, functionality may be provided to analyze the data and make recommendations, for example, for routine maintenance, or products or services which may be of interest to the user.

A Medical Data Manager app 1852 may be provided to permit the storage and privacy protection of medical related data or other health information related to the user in their profile such as test results, lab reports, or other medical, dental, psychological records and the like. Similar to the Social Network app 1848 which leverages the permission data to control access to the profile, or portion thereof, the Medical Data Manager app 1852 may focus on controlling permissions to provide security of the health related data and access only by authorized parties, such as the user's physician or insurance company. Where the physician or insurance company is a user of the intermediary 1002, the Medical Data Manager app 1852 may facilitate appropriate cross-permissioning between user profiles to enable, for example, the physician to access and update the health related data. In one embodiment, the cross-permissioning may be implemented so as to alert the user to each access/update and/or require user consent for each access/update. Otherwise, the Medical Data Manager app 1852 may facilitate a secure interface by which health related data may be deposited into a user's profile, such as by a physician. The Medical Data Manager app 1852 may further implement mechanisms to provide compliance with HIPPA and other regulatory requirements, such as by encrypting the stored health related data and monitoring and reporting access thereto, such as via alerts and/or an audit report presented to the user. In one embodiment, functionality may be provided to allow the user to anonymously reveal portions of their health related data for further analysis and recommendations, such as to recommend products or services or provide a diagnosis of a disease or condition.

A Donation Manager app 1840 may be provided to allow a user gather, store and manage data related to charitable donations. Functionality may be provided to keep an accounting of donations for tax deduction purposes. Further, based on analysis of the user's profile, or a portion thereof, the Donation Manager app 1840 may recommend charities of interest. In particular, a charitable organization may be a user of the intermediary 1002 and provide a profile defining their mission, charter and/or affiliations. The Donation Manager app 1840 may cross-analyze the user's profile against the profiles of charitable organizations to determine recommendations for the user. The user may further permit the intermediary 1002 to make their profile visible, or not, to charitable organizations to be open, or otherwise avoid, charitable solicitations. Such solicitations may be further conditioned, such as to be only received when a disaster is declared.

A Politics Manager app 1838 may facilitate the storage and management of data representative of political affiliations, political donations, etc. and/or the receipt of political solicitations or announcements.

As a user, trusted app or other entity may add to, or modify information contained in any profile to which they have been granted appropriate access, there is a likelihood that false, fraudulent, misleading or inaccurate information may be exist in any given profile either via negligence or a deliberate act. A Profile Anti-Fraud app 1870 may be provided which permits a user to report and/or correct information in their or another user's profile. Further, the Profile Anti-Fraud app 1870 may be coupled with an anti-fraud service provided by the intermediary 1002 which monitors transactions and/or profiles for activities indicative of negligent, fraudulent or criminal activity and, for example, intercepts and/or inhibits such transactions, or otherwise alerts associated users or flags suspect profile data. Further, services to resolve issues or disputes may be provided including arbitration services, evidentiary handling services and services to provide compliance with judicial orders, as well as regulatory and criminal statutes and investigations. For example, a Legal Intercept app 1884 may further be provided for use by law enforcement, regulatory, security or governmental organizations to provide access to a user's profile, for example, subject to a warrant or other governmental mandate, such as the Patriot Act, on a one time basis or continuous or periodic basis, akin to a wire tap. Such access may be provided without alerting or otherwise notifying the subject user.

The Ad Controller app 1808 may provide the user with functionality to manage the delivery of advertising content transmitted to the clients 1004a-n by any of the servers 1008a-n, such as media content providers and/or ad networks servers. As was discussed above, media content and other providers may include advertising content along with the content desired by the user. While typically not specifically requested, not all advertising content may be unwanted by the user. The Ad Controller app 1808 enables the user to control the type, subject, timing and/or manner of the advertisements that are delivered to the client 1004a-n. Further, where the advertisements feature links to the advertiser's content, such as the advertiser's web page, the Ad Controller app 1808 may further permit the user to access that content while maintaining a desired level of privacy and/or anonymity, provided by the trust architecture. For example, the Ad Controller app 1808 may work in conjunction with the Control Center App 1802 to facilitate user manipulation of their profile, or portion thereof, such as explicit intermediary operational settings, permission data or other profile content, such that all or only some advertising content is blocked from being presented to the user and/or such that third parties, e.g. media content providers, ad networks or other advertising related entities, may access and use at least a portion of the data stored in the profile to influence or select and deliver advertisements in accordance with the user's preferences. As opposed to an advertisement selected at random, or based on the limited profiling afforded by traditional stateful processing, an advertisement selected in accordance with the user's profile may be more relevant and therefore more likely to result in a purchase by the user. Alternatively, or in addition thereto, the Ad Controller app 1808 may select and insert advertising content, and/or substitute for advertising content, in media or other content received by the user, wherein the selection is based on the user's profile or a portion thereof. In one embodiment, the Ad Controller app 1808 is coupled with an advertisement search engine 1812 provided by the intermediary 1002, such as at the back-end 1106 which is coupled with third party ad networks or servers and/or a proprietary ad server provided by the intermediary 1002. The advertisement search engine 1812 searches, on behalf of the user, for relevant advertising content to be presented to the user for which, in one embodiment, the intermediary 1002, or operator thereof, is compensated. Where the advertisement search engine 1812 searches third party ad networks or servers for advertisements, an advertising search proxy (not shown) may be used to interface with the third party ad network or server to protect the user's privacy and control, per the user's direction, the amount of information from the user's profile that is provided in order to conduct the search. In one embodiment, advertising related entities may subscribe to a service provided by the intermediary 1002 whereby embedded advertising may include hints or other data which influence the intermediary's 1002 selection of alternate or substitute advertising. For non-subscribing entities, such hints or data may be ignored. An advertising search app 1810 may further be provided to allow a user to directly utilize the ad search engine 1812 to search for advertisements.

In one embodiment, the Ad Controller app 1808 may, at the direction of the user, select an advertisement by analyzing the user's private behavioral history stored in the profile and/or the user's contextual event horizon, described in more detail below, to formulate an ad search request to a third party and/or proprietary ad search engine 1812. The user's private behavioral history generally includes, for example, the data indicative of previous interaction between the user and at least one of the at least one server 1008a-n, as described above, such as search queries, web site content, or user selected links, as well as any other data stored in the profile by the user or by another trusted app, or derivations therefrom. The contextual event horizon refers to the present and future context or circumstances of the user with respect to events, location, or other context, and may be derived from calendared events stored in the profile, such as meetings, birthdays, vacations, or other appointments, location information, such as the present geographic location of the user or client 1004a-n, and/or identified or predicted future locations or routes. When interacting with third party ad search engines, data identifying the user or the client 1004a-n may be anonymized to prevent compromising the privacy of the user. Agreements or understandings between third party ad search engines and the operator of the intermediary 1002 may be put in place to allow the Ad Controller app 1808 to provide identifying information to the third party ad search engine, such as to improve the relevance of the selected advertisements, while providing that the third party ad search engine respects the privacy of the user, such as by agreeing not to further derive information or otherwise profile the user, or sell or otherwise reveal the identifying information or other information derived based thereon to other unauthorized parties. Aggregated analysis, such as aggregated consumer segmentation, may be permitted to the extent individual user privacy is respected. Such a third party ad search engine may be referred to as a “Trusted Ad Search Engine.”

The Ad Controller app 1808 may further implement “Pay Wall” functionality, or otherwise be coupled with the pay wall app 1858 which facilitates the exchange of compensation between, for example, the user, the operator of the intermediary 1002, and/or the operator of a server 1008a-n which provides content and/or advertising, to incentivize the user to permit profile access to content and/or advertising providers and/or view advertisements, or alternatively, provide the user with the option to restrict profile access and/or avoid advertisements. It will be appreciated that, for any exchange of compensation, the operator of the intermediary 1002 may collect a fixed, variable or percentage based service fee, transaction fee, or usage fee from one or more of the parties to the transaction. Further, the intermediary 1002 may act as a central counterparty in all transactions, novating itself into any compensation transaction so as to protect the anonymity of at least the user. The Pay Wall function may be coupled or integrated with the permissioning functionality of the Control Center app 1802, described above, whereby the user defines that for which they are willing to pay or be paid. It will be appreciated that the user may further qualify the compensatory scheme based on other parameters such as client 1004a-n specific, temporal and/or geographic parameters, which may be included in the profile as was discussed.

The Pay Wall, which may be implemented as a discrete function or app 1858 accessible to other apps, such as the Ad Controller app 1808, further allows the user to derive monetary value or other compensation, directly or indirectly, in exchange for allowing access to their profile, thereby further incentivizing the user to provide more, and/or more accurate/detailed, information, again increasing the profile value, etc. Such compensation may include monetary compensation or access to site content, e.g. free of advertising, in exchange for profile access. Compensation may further include discounts, “points” or other credits which may be redeemed or exchanged by the user, as will be described in more detail below with respect to the Loyalty app 1804. The user may permit access to their profile on a one-time basis, such as for access to current or historical specific factual or discrete information, or on a subscription (periodically or in real time) basis, such as for access to on-going user activity or other dynamic information. As described above, the user may further qualify access based temporal parameters, such as time of day, day of week, etc., and/or geographic parameters, such as geographic location, region or proximity. In an alternative embodiment, where the user benefits from third party access to their profile, the user may provide compensation in order to restrict access thereto in order to continue to receive the particular benefits.

Further, as was described above, typically many web sites cost money to operate, the operating entities thereof typically provide their content and/or services, such as news, product information, search functions, email functions, etc., in exchange for some form of compensation, monetary or otherwise, from the user, e.g. in exchange for a site access/subscription/membership fee, in exchange for the user's purchase of, or the chance the user may purchase, products or services offered for sale via the site, and/or in exchange for the user viewing and/or selection of advertisements, referred to as a “click through” (in which case the site may be compensated by the advertiser or the advertisement distributor), etc. The Pay Wall app 1858 may further facilitate a user's customization of the exchange of compensation for a web sites content and/or services. For example, if a user chooses to view the content without advertisements, the Pay Wall app 1858 may facilitate the user's payment of compensation to the content providing web site via the intermediary 1002 which then blocks the advertisements. Alternatively, or in addition thereto, the user may choose allow the presentation of advertisements and/or to permit access to their profile in exchange for compensation from the content provider or an advertisement provider, whereby such profile access may permit the provision of more relevant advertising to the user. The user may further customize the exchange based on temporal and/or geographic parameters, such as by paying to view ad-free content, or being paid to view ad-inclusive content, during certain time periods and/or when they are located in certain geographic locations or regions. Customization may be further based on the device or client 1004a-n which the user is utilizing for content access. For example, the user may agree to view content with advertisements when they are viewing that content on their home computer but, when viewing content on their mobile device, they wish to view the content ad-free. In such a case, any compensation provided by the user for ad-free content may be offset, for example, by the savings in data transmission bandwidth and associated fees.

As discussed below, entities may desire access to user profile content for the purpose of deriving information and/or relationships therefrom, such as by aggregating profile content from multiple users. A Profile Marketplace app 1846 may be provided which allows users to make their profile, or portion thereof, available in exchange for compensation and further allows other entities, such as marketing or research entities to post offers for access to profiles, or portions thereof. Users may view posted offers, which may specify the criteria defining the profiles of interest, the type and amount of compensation to be paid, and the extent of profile access desired, e.g. the type of data, one time access or continuous or periodic access, etc. Users may accept offers, respond with counter offers, such as to modify the compensation or the extent of profile access, or decline offers. Upon acceptance, the intermediary 1002 via the Profile Marketplace app 1846, brokers the exchange, e.g. as a central counterparty to the transaction, such as by crediting the appropriate compensation to an account of the user and adjusting the user's profile permission data to allow the requisite access. As will be appreciated, profile access may be limited so as to provide user anonymity.

A Focus Group and Survey app 1844 may further be provided when marketing or research entities wish to directly interrogate users to obtain information which may not be available via their profile. As with the profile marketplace app 1846, such entities may post offers which are presented or otherwise viewable by other users who may then accept or decline the offers. Upon acceptance, the intermediary 1002, via the Focus Group and Survey app 1844, may present the questions on behalf of the marketing or research entity, as well as collect and provide the results thereto, whereby, if directed by the user, user anonymity is preserved. Focus groups, comprising the scheduled participation of multiple users, as well as surveys and questionnaires, may be supported. A user's responses to the interrogatories may be further stored in the user's profile as was discussed.

A Personal Search App 1816 may be implemented which recognizes that web searching, i.e. the use of servers 1008a-n which provide the services of receiving and processing user queries to identify web sites and other content relevant to the query, may reveal private information about the user, in particular when coupled with user identifying information, including the type and content of a search query, a user's query history or the user's pattern of queries. The Personal Search App 1816 permits the user to conduct web searches or otherwise utilize servers 1008a-n which provide search services without compromising their privacy. As was described above, the intermediary 1002 acts to disrupt stateful operations which permits servers 1008a-n to relate discrete user interactions thereby, for example, preventing a web search engine from maintaining a user's search history and/or deriving patterns therefrom. However, in some cases the user may wish to view or access their search history, such as to view results of a prior search query, or derive a pattern or other information therefrom.

The Personal Search app 1816 provides functionality to allow a user to conduct web searches without compromising their privacy. In one embodiment, the Personal Search app 1816 provides a query interface, such as via a web page presented on the client 1004a-n, for the user to enter their search query, which may include one or more search terms and other qualifications or parameters. The Personal Search app 1816, via the intermediary 1002, may then initiate search queries on behalf of the user to one or more search engines/servers 1008a-n, which may be specified by the user, such as in their profile, and may include a proprietary search engine operated by the intermediary 1002. Each query may be anonymized such that the server 1008a-n cannot identify the user or client 1004a-n. Each query may be stored in the user's profile in a user accessible query history log along with, for example, the context of the query, such as the time or date or geographic location of the client 1004a-n, etc. As was described above, the query data, contextualized or not, may be further used by other trusted apps, like other profile information, to enhance the profile value. The results of the search queries may then be received by the Personal Search app 1816 and be processed in accordance with the directions of the user, as specified as part of the query or provided in the profile. For example, the results may simply be passed to the client 1004a-n for presentation to the user. Alternatively the results may be sorted and/or filtered, such as in accordance with the user's profile, to provide the most relevant results first or at the top of a list, as determined based on the user's profile. This order may be different than the order in which the results were received by the Personal Search App 1816 from the search engine which may have prioritized paid search results ahead of relevant search results. Advertisements, results which appear because they were paid to appear, and/or stateful functionality, such as encoded click-thru links, may be removed, subordinated to other content, allowed or substituted, for example, in exchange for compensation as described above with respect to the pay wall and ad controller apps. Where queries are sent to multiple search engines, the results therefrom may be aggregated prior, or subsequent, to the above mentioned processing and presentation to the user. It will be appreciated that the Personal Search app 1816 may implement caching of search results to improve or accelerate search performance. This search results cache may be user specific or shared across users of the intermediary 1002.

The Deal Finder app 1860 may generally enable one or more users to locate and obtain offers, incentives, discounts, rewards or deals related to products or services of interest, which may be monetary in form or in another form such as redeemable or exchangeable credits or points, generally referred to as “offers.” In one embodiment, the user, via the permission data above, makes their profile, or portion thereof, available to a deal finder application or function, operated by the intermediary 1002, which has access to various offers available from product or service providers or other offer providers, such as a database which contains data representative of offers provided by the providers thereof. The deal finder server may analyze the user's portfolio, or portion thereof, and identifies, anonymously with respect to the offer providers, offers which may be of interest to the user based on the analysis. The identified offers may then be presented back to the user, such as via the user interface 1020, for the user to select or otherwise accept. In one embodiment, a particular offer may be contingent or otherwise conditioned upon the user granting access to their profile by, or otherwise identifying themselves to, the offer provider on a one time or periodic basis whereby the user's acceptance of the offer instructs the intermediary 1002 to provide the requisite profile access such as by automatically adjusting the permission data accordingly, the intermediary 1002 then brokering the offered compensation back to the user, such as by crediting an account associated with the user, providing desired content, etc. In another embodiment, providers of products or services, or other entities, which may also be users of the intermediary 1002, may populate their profiles with one or more offers and define their profile permission data so as to allow other users access thereto to see and accept available offers. Users may further specify specific products or services of interest to the deal finder function, such as by identifying them in an electronic shopping cart or electronic wish list, which identifies relevant offers based thereon. Offer providers may specifically post and/or distribute offers such as via a marketplace web page provided by the intermediary 1002. Offers which may be conditioned on redemption at a later time, upon acceptance, may be stored in the user's profile, such as via the Wallet app 1822, which manages the offer and facilitates later redemption, such as by reminding the user that the accepted offer remains unredeemed.

A Deal Publisher app 1862 may be provided for vendors, marketing or advertising users to publish offers to users and may work in conjunction with the Ad Controller app, the profile marketplace app, the pay wall app, the deal finder app 1860, or any other app which permits users to seek out offers. As a user of the intermediary 1002 having a profile of their own, data relating to offers made, as well as other activities of, the vendor, marketer or advertiser may be stored in the profile for further analysis and derivation. Apps may be provided to assist in determining the effectiveness of an offer, for example. A business or corporate entity's profile may further have value to other marketing or vendor entities such as business to business entities.

As was described above with respect to the profile market place app 1846, it will be appreciated that a particular offer may be made for the express purpose of access to particular user profiles, e.g. the offer may include a reward or other compensation in exchange for access to user profiles meeting a particular criteria, such as of users of a particular age group. In one embodiment, offers, or the extent or amount of compensation provided thereby, may be contingent on multiple user participation, e.g. the offer must be accepted by a minimum number of users to be valid or otherwise redeemed, i.e. an assurance contract. This may enable group/social buying functionality allowing groups of users to leverage their collective buying power to improve the amount of a discount or reward or enable an offer provider to incentivize a larger number of users to accept their offer. Such functionality may be separately provided via a Private Group Buying app 1876. Further, a user may express interest in one or more products or services, such as via an electronic shopping cart or wish list, whereby the intermediary 1002 aggregates similar interests from other users, matches the collective interest against available offers, segmented by product or service where appropriate, or otherwise presents the collective interest to offer providers to allow them to provide a suitable offer responsive thereto. Where multiple offer providers may be interested in providing a suitable offer, the intermediary 1002 may facilitate bidding among the offer providers and users to obtain the offer most desirable thereto, i.e. an offer which is most desirable to the users, or a majority thereof, and acceptable to the offer provider.

The deal finder app 1860 may be further enabled to identify offers available at a particular geographic location where the user and/or client 1004a-n is, or will be, located. In operation, the user defines their profile permission data to permit access to data representative of their geographic location, such as may be provided by a GPS device coupled with the client 1004a-n which may include a mobile or vehicle based device. The deal finder app 1860 may then monitor the user's location and compare it, continuously, periodically, or at the direction of the user, with a database of offer providers, and their associated offers, having respective physical locations. Upon determining that a user is located at or proximate, or within a defined margin, or is otherwise moving to, explicitly or trending towards, the location of an offer provider, the personal deal finder app 1860 may present the associated offers, or a subset thereof, to the user via the client 1004a-n, such as via the user interface 1020 or the user may be provided with a browsable database of offers from which they can select, such as via the user interface 1020. For example, a user may be presented with the locations of gas stations having the lowest gas prices along their intended route. Offers may be pre-arranged by the offer provider or dynamically generated, such as based on the user's profile, or portion thereof, where the user permits such access, and the offer and/or selection of the offer may be customized to the user. Offers may be stored in a database provided by the intermediary 1002 or by the offer provider, such as via an in-store or network 1006 accessible database. In one embodiment, the in-store database may be part of a device or appliance which may communicate with the client 1004a-n to directly provide the respective offers to the client 1004a-n. The user may redeem the offer by presenting their device/client 1004a-n having the offer displayed thereon to the offer provider, such as a cashier or clerk. Alternatively, redemption may occur via the user's interaction with the client 1004a-n to accept the offer.

Similar to the Deal Finder app 1860 in the mobile context, a Personalized Interactive Billboard app 1882 may be provided whereby, via an audio and/or visual display or other appliance located in a retail establishment or other physical location, such as a billboard along a highway, offers or advertisement may be presented to users based on the determination that they are proximate to the display, the offers or advertisements having been selected based on the user's profile. As described elsewhere, the user may subscribe to such presentations for compensations, such as via the Ad Controller app 1808 or Profile Marketplace app 1846. Where multiple users may be proximate to a given display or appliance, multiple offers or advertisements may be displayed, simultaneously or otherwise and/or offers or advertisements may be selected based on the average interests of those users, i.e. a crowd profile derived from multiple user profiles. In this way, a display, such as a billboard, may adapt to the audience around it.

A loyalty app 1804 may be provided which rewards the user for various activities that they undertake via the intermediary 1002. The loyalty app 1804 leverages the activity monitoring functionality of the intermediary 1002, such as via the profilers described herein which monitor user interactions via the client 1004a-n and store data representative thereof in the profile database 1012. The functionality of the loyalty app 1804 may be independently implemented or implemented as part of another app, such as the ad controller 1808 or deal finder apps 1860. The reward may include compensation in the form of monetary compensation or redeemable or exchangeable credits or points which may be vendor specific or redeemable with multiple vendors. Activities which may earn rewards include purchasing products or services, on-line or in a physical retail establishment, paying for purchases using a payment service offered by the intermediary 1002, viewing advertisements, permitting access to their profile, or a portion thereof, etc. As opposed to a vendor specific loyalty program for which a user must typically register and provide personal information, the disclosed loyalty app 1804 permits a user to earn rewards without compromising their privacy, and allows the earning of rewards across vendors or which may be redeemed at more than one vendor. Vendors of products and services are incentivized to participate, e.g. allow reward redemption, because they otherwise would not be able to track the user for the purpose of awarding rewards due to the operation if the intermediary 1002 which may disrupt such tracking. The intermediary 1002 may charge vendors a fee, such as participation, subscription or usage fee, to participate in the loyalty function. As a user's profile may contain various types of activity related data, including historical product purchases, location information, etc., rewards may be designed to incentivize particular personal choices, such as charitable activities, e.g. by detecting charitable donations, safe driving, e.g. by detecting appropriate rates of change in location to discern vehicle speed, or healthy or green living, e.g. by detecting purchase of products identified as healthy or environmentally friendly. The loyalty app 1804 may further provide account management functionality to create and maintain accounts reflecting accrued rewards as well as facilitate user monitoring and redemption, such as via the user interface 1020. Further, the user may be allowed to sell or otherwise exchange accrued rewards, or portions thereof, with other users. Where rewards are vendor specific, such functionality may create a trading market, e.g. a spot market, where users may exchange one vendor's rewards for another and negotiate the rate of exchange therebetween.

Further leveraging the ability to store user provided data in the profile, an asset management app 1806 may be provided whereby the user may store information related to various assets that they own, lease or otherwise control or over which they have responsibility. Such information may include descriptive information about the asset, a serial number or other identifier, such as a license plate number or vehicle identification number, one or more photographs of the asset, the location of the asset, warranty information, etc. Where the asset is coupled with a locating device, such as a GPS device, location data may collected periodically and stored/updated in the profile. Where the asset is coupled with an active identification mechanism, such as an RFID tag, GPS device, Zigbee based identification mechanism, Bluetooth based identification mechanism or other near-field communication (“NFC”) based identification mechanism, the asset management app may further provide functionality to interface with the appropriate sensor or interface of the client 1004a-n to detect, read and/or manipulate the identification mechanism. In one embodiment, the asset management app 1806 may be configured to report or alert the user, such as via the user interface 1020, that a particular asset has been detected or that a particular asset has stopped being detected and/or has or has not been detected for a defined period of time, such as if the asset were stolen. It will be appreciated that a particular asset, such as an automobile, computer or cellular telephone, may be or include a client 1004a-n. The asset management app 1806 may further be integrated with third party services such as warranty or maintenance services provided by the asset manufacturer, provider or another party. Such integration may be implemented via the cross permissioning of at least the portion of the profile comprising the asset information with a profile associated with the third party and may allow the user to register for warranty services and/or access product information such as user manuals, and/or allow the third party to notify the user, such as to notify the user regarding available updates, upgrades, services bulletins or recall notifications. In the case of assets which are, or include, a client 1004a-n or otherwise are capable of determining and reporting their location or for which their location may be determined otherwise and reported, such as via a client 1004a-n, to the intermediary, in real time or on a periodic or scheduled basis, the asset management app 1806 may provide additional functionality based thereon. For example, functionality may be provided to visualize the present location, historical locations and/or predicted, estimated or anticipated locations, of a given asset on a map. Further, where the user is located at a different location, the asset management app 1806 may be further enabled to direct the user to the asset location, e.g. to help them find their parked automobile. Where the asset is a cellular telephone, or GPS tag, associated with a child, the asset management app may assist the parent in locating the child. The asset management app 1806 may further enable the user to define conditions under which the location data may be evaluated along with associated actions, such as alert notifications. For example, the asset management app may be configured to report any change in location of a particular asset, changes which deviate from a threshold, such as by crossing a boundary, moving in a particular direction or toward a particular location or region, or exiting or entering a geographic region, a rate of change which exceeds a threshold, etc. Such alerts may be used to detect asset proximity, theft of an asset or unauthorized use thereof and/or verify compliance with usage restrictions.

A content portal app 1814 may be provided which enables a user to access content of interest, such as content provided by one or more of server 1008a-n, via a unified interface. Content of interest may be specifically defined by the user, such as in their profile, or derived from the profile contents, and may include web content, news, RSS feeds, product information, etc., related to one or more particular subject matters, available from one or more sources, such as one or more of the servers 1008a-n. The content portal app 1814 may provide an interface, such as a web page presented via the user interface 1020, by the user may specify content of interest or otherwise control the functions of the content portal. Once defined, the content portal app 1814 may retrieve, on demand or periodically, the desired content or otherwise schedule content to be delivered to the intermediary 1002, such as via RSS or other push mechanism. The obtained content may then be presented to the user either aggregated in a unified presentation, such as via single web page presented via the user interface 1020, or using multiple web pages other presentation, such as a tabbed presentation. In one embodiment, the content portal app 1814 may monitor content for changes thereto and report only the changed content. As discussed above, advertising and other unsolicited functionality may be removed, or substituted for, such as in exchange for compensation. The content portal app 1814 may further provide functionality to allow a user to share or recommend particular content, with or without commentary, to other users, such as another user who has permission to access the user's profile or portion thereof. Where a user is the recipient of shared or recommended content, the content portal app 1814 may provide functionality whereby the receiving user can add the content source to their profile to be presented to them via their content portal app 1814 display. It will be appreciated that the obtained content, or information regarding the source thereof, may be stored in the user's profile for use by other apps as described herein.

A Prefetch App 1856 may be provided which analyzes the user's profile and/or content portal specified content and intelligently prefetches content to minimize latency. In addition to predicting and prefetching content likely to be of interest to the user, the Prefetch app 1856 may implement temporal and spatial locality algorithms to predict and retrieve content from recently accessed locations or content proximate to other recently accessed content.

A personal transportation app 1832 may be provided which tracks, and stores data in the profile representative of, the means and methods by which a user transports themselves between locations, including the modes of transportations, such private car, public transportation, rail, air, boat, walking, etc., and the routes taken. The personal transportation app 1832 may further analyze the tracked data to provide recommendations to the user to, for example, reduce transportation costs, improve efficiency in commuting between locations, reduce the user's environmental impact, etc. Further, the personal transportation app 1832 may be coupled with the Product Recommendation app 1880, the Personal Location app 1830, the Deal Finder app 1860, etc. to provide recommendations as to products and/or services related to the tracked data such as products or services related to the user's mode of transportation or products or services available proximate to the user's route.

A Personal Assistant app 1818 may be provided which provides functionality for personal information management and may be accessible via any client 1004a-n used by the user, such as via the user interface 1020. In particular, the Personal Assistant app 1818 may facilitate the storage and manipulation of data in the user's profile related to appointments, schedules, tasks and contacts, as well as context, such as location, and reminders or alarms related thereto. Thereby, the user can store data related to planned activities, such as vacations, business trips, grocery shopping, commuting, medical or dental appointments, holidays, deadlines, etc. Further, the Personal Assistant app 1818 may analyze this data and provide recommendations based thereon, such as recommended products or services, schedule optimizations, etc. For example, where a user is scheduled to travel to a particular location, the Personal Assistant app 1818 may recommend products or services related thereto. The Personal Assistant app 1818 may further provide functionality to monitor user activities via the intermediary 1002 and automatically recommend and/or generate data entries based on detected activity patterns or predicted trends. Based on responses to recommendations, the user may train the logic of the Personal Assistant app 1818 to provide more relevant recommendations. It will be appreciated that the data stored in the profile may be further accessible, based on the permission data set by the user, to other users or apps. For example, a user may share their calendar with another user or meeting scheduling functionality may be provided whereby the Personal Assistant app 1818 analyzes the calendars of users wishing to meet and identifies mutual schedule availability. The Personal Assistant app 1818 may further feature functionality tailored for mobile devices/clients 1004a-n such as a recommendation function which provides recommendations based on the present position of the user and client 1004a-n. The personal assistant app 1818 may include a recommendation processor, or be otherwise coupled with a Product Recommendation app 1880, which may provide recommendations, which may or may not be sponsored, of products, services or actions to be taken by the user, or combinations. In one embodiment, recommendations may be randomly generated. The recommendation processor may base the generated recommendations on the contents of the user's profile, including contextual information, such as location, and/or derivations therefrom, such as patterns or trends, and may be limited by the user based on topic/subject-matter, location or date. The recommendation processor may learn and adapt future recommendations based on feed back from the user with respect to past recommendations. A user may choose whether or not to be presented with sponsored recommendations, and such recommendations may be coupled with compensation provided to the user in exchange for following the recommendation. The personal assistant app 1818 may be enabled to function without network connectivity, such as on a client 1004a-n where the network is unavailable. Data representative of recommendations provided to the user, or the user's following thereof, may be stored in the profile for use access by other users or apps as permitted by the user.

A Private Insurance Manager app 1824 may be provided to allow a user to gather, store and manage data related to their insurability and risk for the purpose of further managing insurance rates for health, vehicle and property insurance. The private insurance manager app 1824 may access profile data gathered by other apps, such as the personal transportation app 1832, the asset management app 1806, the medical data management app 1852, etc. and/or gather relevant data itself and store it in the profile. The private insurance manager app 1824 may then analyze relevant profile data, or a portion thereof, to assess the user's risks and insurance needs. User's may then visualize their risks and the factors contributing thereto allowing them to manage their risk, such as by making lifestyle changes. Via the app 1824, the user may make their profile and the resultant risk analysis available to insurers to obtain lower premiums. For example, based on data gathered relating to a user's driving or purchasing habits, they may be able to demonstrate that they are a safe driver to an insurance company or demonstrate that they lead a healthy lifestyle to a health insurance company. Insurance companies may also utilize the functionality of the private insurance manager app 1824, such as via an Insurance Company Interface app 1866, to offer insurance products or services and/or evaluate potential or currently insured parties. For example, an insurance company may offer potentially lower rates in exchange for access to a user's profile, or portion thereof, so that they can assess the user's risk of loss.

A Single Sign On app 1850 may be provided allowing a user to store authentication credential for on-line services, e.g. user-id's and passwords, in their profile. The Single Sign On app 1850 may provide an interface whereby a user can enter one or more authentication credentials, or otherwise modify or manage existing entries. Alternatively, or in addition thereto, the Single Sign On app 1850 may detect when a user is accessing an authenticated site and offer to store the credentials at that time. When the user attempts to access an authenticated site for which the requisite credentials are stored in their profile, the Single Sign On app 1850 may automatically provide the credentials to the site to facilitate the user's access. As the profile, as discussed above, is made available by the intermediary 1002 among one or more clients 1004a-n used by a user, the functionality of the Single Sign On app 1850 may be accessed from any of those devices.

A Purchasing app 1854 may be provided which allows users to interact with servers 1008a-n which provide e-commerce services, such as a vendor products for sale, as well as retail establishments, without compromising their privacy. The Purchasing app 1854 may operate in concert with the Wallet app 1822 to facilitate anonymized payments. For example, the intermediary 1002 may act as a central counterparty to any transaction, guarantying payment to the vendor on behalf of the user and guarantying performance to the user on behalf of the vendor such that the user need not identify themselves to the vendor. The Purchasing app 1854 may provide a shopping cart function which allows the user to store indications of products or services they wish to purchase from one or more vendors, such as one or more of the servers 1008a-n. When the user “checks out” or otherwise indicates that they wish to consummate their purchases, the Purchasing app 1854 facilitates the exchange of compensation between an account of the user, such as a credit card, bank account, or account provided by the intermediary 1002, and the one or more vendors from which the products or services are to be purchased. The Purchasing app 1854 may further facilitate anonymized delivery of the purchased products or services. For electronically delivered products or services, the Purchasing app may arrange for the products or services to be delivered to the intermediary 1002 which then relays them to the user via a client 1004a-n. For physically delivered products or services, the intermediary 1002 may be affiliated with a depot or delivery company which may receive the physical products or services and forward them to the user.

A Financial Services app 1878 may be provided which allows a user to gather, store and manage financial related information in their profile, such as account numbers, balances, portfolio contents, etc. Similar to the Content Portal app 1814, the user may further specify the web sites, record keeping systems or servers 1008a-n of their financial service providers which, along with any requisite authentication credentials, which may be managed by the Single Sign On app 1850, allows the Financial Services app 1878 to obtain and present account information to the user, individually or consolidated with other account information of the user. The Financial Services app 1878 may further access the user's profile, or portion thereof, to analyze the user's financial condition, spending habits, etc. and make recommendations based thereon to improve the user's financial well being or otherwise assist the user in attaining a financial goal. Where a user's financial advisor, or other financial services provider, is a user of the intermediary 1002, the user may grant access permission to their profile, or portion thereof, to allow their financial advisor to review their financial information, etc. Marketers and vendors of financial products or services may also access the user's profile, at the user's direction, such as via the profile marketplace app 1846 or other apps described above, to market their financial products or services as was described above.

As will be appreciated, the base functionality of the intermediary 1002 may be leveraged in numerous ways to provide a variety of services to the user while maintaining user control over their privacy. To facilitate the addition of new services, a Content Provider Interface 1864 and Developer Application Program Interface 1826 may be provided. The Content Provider Interface 1864 allows content providers, such as the servers 1008a-n, to function in concert with the functionality of the intermediary 1002 to operate statefully without compromising user privacy. Further the Content Provider Interface 1864 may provide access to the profile marketplace created by the profile marketplace app 1846 and other app functionality, for a fee for example, to allow a content provider to post offers and otherwise provide their products or services to users. The Application Program Interface 1826 permits third party developers to develop and implement additional trusted apps which provide users with additional functionality to store data in their profile, manage and monetize that data. The Application Program Interface 1826 provides managed connections to user profiles and provides that apps operate correctly and at the direction of the user.

As was described, the disclosed exemplary trusted apps may be implemented which allow a user to control or manage the content of and/or access to their profile, or otherwise allow the user to augment or modify their profile. Trusted apps may be implemented to replace, re-create, fix and/or re-enable functionality which is displaced, broken or disabled by the operations, such as the anonymizing functions, of the intermediary 1002, and trust architecture 1100 created thereby. Trusted apps may be implemented which extend the utility of the profile as a user controlled logically decentralized inter-device accessible secure information repository and provide services in association therewith, such as to provide an alternative to centralized third-party controlled repositories and services. Further, trusted apps may be implemented which leverage the logical positioning of the intermediary 1002 between the clients 1004a-n and servers 1008a-n to enhance existing services or provide new services.

Referring back to FIG. 10, in one embodiment, the disclosed intermediary 1002 may further include a user interface 1020, which may be implemented using a web based interface, such as an interactive web page accessible to the user and presented via the client 1004a-n, operative to receive an instruction provided by the user to cause the intermediary 1002 to one of allow the at least one unsolicited function to be performed as if with respect to the first client 1004a, allow the at least one unsolicited function to be performed as if with respect to another client 1004b indistinguishable from at least one other of the at least one client 1004a-n, modify the at least one unsolicited function and perform the modified at least one unsolicited function with respect to the first client 1004a on behalf of the at least one server 1008a associated therewith, or inhibit the performance of the at least one unsolicited function. The user interface 1020 may be implemented via logic stored in a memory and executable by a processor to, via a user accessible interface, such as an interactive web page, receive an instruction provided by the user to cause the intermediary 1002 to one of allow the at least one unsolicited function to be performed as if with respect to the first client 1004a, allow the at least one unsolicited function to be performed as if with respect to another client 1004b indistinguishable from at least one other of the at least one client 1004a-n, modify the at least one unsolicited function and perform the modified at least one unsolicited function with respect to the first client 1004a on behalf of the at least one server 1008a associated therewith, or inhibit the performance of the at least one unsolicited function.

As was described above, the second passive function may include collecting identifying information about the first client 1004a, and/or relating or otherwise deriving additional or more specific identifying information from the collected identifying information. Further, the first active function may include transmitting a unique identifier to the first client 1004a to be stored thereby for subsequent retrieval, may include transmitting executable program code, such as a JAVA or HTML5 applet, to the first client 1004a to be executed thereby to cause the first client 1004a to transmit identifying data, may include causing the first client 1004a to transmit a unique identifier, may include, in response to a request for content from the first client 1004a, adding additional content not requested by the first client 1004a thereto and transmitting the content and the additional content to the first client 1004a in response to the request, or combinations thereof.

In one embodiment, as was described above, for example, with respect to Control Center app 1802 and permissioning, the user, such as a parent or employer, may be associated with another user, such as a child or employee, and with a second client 1004c, the user interface 1020 being further operative to receive the instruction of the user to one of allow or inhibit the at least one unsolicited function with respect to the user, the other user, the first client 1004a, the second client 1004c, or a combination thereof.

In one embodiment, as was described above with respect to the personal pay wall app 1858, the interface 1010 may be further operative to inhibit the at least one unsolicited function in exchange for a compensation from the user. For example, compensation may be transferred to each of the at least one server 1008a-n for which the at least one unsolicited function was inhibited. The interface 1010 may be further operative to facilitate compensation to the user from a one of the at least one server 1008a to allow the performance of the at least one unsolicited function thereby at least as if with respect to the first client 1004a.

In one embodiment, as was described above, the intermediary 1002 may further include at least one activity monitoring processor or profiler 1016a-n, each operative to monitor interactions of the first client 1004a comprising communications transmitted by the first client 1004a, transmitted to the first client 1004a, or combinations thereof, and store data representative of the interactions in a database such as the profile database 1012, described in detail above, from which the direction of the user is at least in part derived. Each of the at least one activity monitor may be operative to monitor communications characterized by a particular communications protocol, by a particular subject matter, or combination thereof. Where the user is associated with a second client 1004c, at least one of the at least one activity monitoring processor may be further operative to monitor interactions of the second client 1004c comprising communications by the second client 1004c, transmitted to the second client 1004c, or combinations thereof, and store data representative of the interaction of the second client 1004c in the profile database 1012. The data stored in the profile database may be used, for example, by the intermediary 1002 to implement its own stateful functions, described above, with respect to the first client 1004a, second client 1004c, or generally with respect to the user thereof. The interface 1010 may be further operative to facilitate a display of the stored data from the database 1012, facilitate augmentation of the database 1012 by the user, and/or facilitate augmentation of the database 1012 by the first client 1004a based on a temporal context, geographic context, environmental context, or a combination thereof.

As was described, the intermediary 1002 may further include at least one profile processor/generator 1014 coupled with the profile database 1012, each of the at least one profile processor/generator 1014 being operative to analyze at least a subset of the stored data representative of the interactions of the first client 1004a, for example, and generate at least one user profile based thereon, wherein the direction of the user is derived from at least one of the at least one user profile. The profile may include, as was described above, data characterizing the user at least one of demographically, firmographically, contextually, behaviorally, temporally, preferentially, or combinations thereof.

The user interface 1020 may be further operative to facilitate displaying or otherwise viewing the at least one user profile, modifying the at least one user profile, augmenting the at least one user profile or combinations thereof, by the user, such as via one or more of the trusted apps, or interfaces provided thereby, described above.

In one embodiment, the interface 1010 may be further operative to facilitate access to at least a subset of the at least one user profile by a third party, such as the at least one server 1008a whose performance of the first function was inhibited, by the interface in exchange for compensation, such as via the Control Center app 1802, the Personal Pay wall app 1858 or the permissioning functionality, described above. Access may be allowed on periodic, e.g. subscription basis, and the amount of compensation may be based on the amount of the profile accessed and/or the frequency of access. The accessible subset may be, dynamically or statically, defined contextually, temporally, geographically, based on specificity, or combinations thereof.

Referring back to FIG. 10, in one embodiment, where the stateful operation of the servers 1008a-n may further include performance of a third function with respect to the respective at least one client 1004a-n based on a first result of the at least one unsolicited function to achieve a second result, the disclosed interface 1010 of the intermediary 1002 may be further coupled with a first processor 1022, referred to as a function processor 1022, which is operative to, according to a direction of a user associated with the first client 1004a and derived at least in part from data indicative of previous interaction between the user and at least one of the at least one server 1008a-n, cause the first server 1008a to perform the unsolicited function with respect to the intermediary on behalf of the first client 1004a, the stateful operation of the one or more of the at least one server 1008a-n at least partially dependent thereon thereby being subject to the direction of the user such that the third function is prevented from being performed to achieve the second result. The first processor is further operative to perform a fourth function with respect to the first client 1004a based at least in part on the direction of the user which modifies the at least one unsolicited function, and/or the performance thereof, modifies the third function, and/or the performance thereof, modifies the first result, modifies the second result, supplants the third function, or combinations thereof, to achieve a third result. It will be appreciated that the third result may be substantially similar to the second result.

In one embodiment, the function processor 1022 may be implemented as logic stored in a memory and executable by a processor to, according to a direction of a user associated with the first client and derived at least in part from data indicative of previous interaction between the user and at least one of the at least one server, cause the first server to perform the unsolicited function with respect to the intermediary on behalf of the first client, the stateful operation of the one or more of the at least one server at least partially dependent thereon thereby being subject to the direction of the user such that the third function is prevented from being performed to achieve the second result. Further, additional logic stored in the memory and executable by the processor may perform a fourth function with respect to the first client based at least in part on the direction of the user which modifies the at least one unsolicited function and/or the performance thereof, modifies the third function, and/or the performance thereof, modifies the first result, modifies the second result, supplants the third function, or combinations thereof, to achieve a third result.

In one embodiment, the second passive function may include collecting identifying information about the first client 1004a, and/or relating or otherwise deriving additional or more specific identifying information from the collected identifying information. Further, the first active function may include transmitting a unique identifier to the first client 1004a to be stored thereby for subsequent retrieval, may include transmitting executable program code, such as a JAVA or HTML5 applet, to the first client 1004a to be executed thereby to cause the first client 1004a to transmit identifying data, may include causing the first client 1004a to transmit a unique identifier, may include, in response to a request for content from the first client 1004a, adding additional content not requested by the first client 1004a thereto and transmitting the content and the additional content to the first client 1004a in response to the request, or combinations thereof.

In one embodiment, the third and fourth function may be implemented by a pay wall app 1858 and may each include causing compensation to be provided to the user based on activity thereby, such as the purchase of products or services, viewing of advertisements, selection of advertising links, etc., and wherein the first result may include identification of the user to which compensation should be provided. The third function may further include causing compensation to be provided to the user based on activity thereby with respect to one of the at least one server 1008a-n, the compensation caused to be provided by the third function being redeemable by the user therewith, and further wherein the fourth function comprises causing compensation to be provided to the user based on activity thereby with respect to at least one, i.e. any, of the at least one server 1008a-n, the compensation caused to be provided by the fourth function being redeemable therewith. The compensation may include monetary compensation or redeemable points and may be exchangeable with another user.

In one embodiment, the third and fourth functions may be implemented by the ad controller 1808, ad search 1810, content portal 1814, and/or personal search 1816 apps and may comprise facilitation of the provision of content, such as via access to a search engine operative to select content, to be transmitted to the first client 1004a wherein the content may include an advertisement. The content provisioned as result of the third function may be the same as or different from the content provisioned as a result of the fourth function. For example, the content provisioned as a result of the fourth function may be in accordance with interests of the user, whereas, due to the disruption of third party stateful processing by the intermediary 1002, content provisioned as a result of the third function is not in accordance with the interests of the user. The fourth function may further include facilitation of the provision of content selected based at least on the second function.

The fourth function may block the provisioning of content facilitated by the third function, such as based on the identity of the provider of the content, e.g. based on a blacklist, and or based on an exchange of compensation paid by the user.

The third function may include causing the first client 1004a to request the provision of first content from a provider thereof, wherein the fourth function further includes modifying the third function to cause the first client 1004a to request the provision of second content different from the first content. Alternatively, or in addition thereto, the third function may include causing the first client 1004a to request the provision of first content from a provider thereof, the fourth function further comprising modifying the request by the first client 1004a to request the provision of second content different from the first content. Alternatively, or in addition thereto, the third function may include causing the first client 1004a to request the provision of first content from a provider thereof, the fourth function further comprising intercepting the request from the first client 1004a prior to the receipt by the provider thereof and responding to the request with second content different from the first content.

Referring back to FIG. 10, in one embodiment, the disclosed intermediary 1002 may further include at least one activity monitoring processor/profile generator 1014 coupled with the interface 1010 implemented, in one embodiment, by logic stored in a memory and executable by a processor. Each of the at least one activity monitoring processor/profile generator 1014 may be operative, and/or executable by the processor, to monitor interactions of the first client 1004a comprising communications transmitted by the first client 1004a, transmitted to the first client 1004a, or combinations thereof, and store data representative of the interactions, e.g. a profile, in a database 1012, e.g. a profile database, from which the direction of the user is at least in part derived. The disclosed intermediary 1002 may further include a user interface 1020, implemented, in one embodiment, as logic stored in a memory and executable by a processor. The user interface 1020 may be operative, and/or executable by the processor, to receive instruction provided by the user to cause the intermediary 1002 to one of allow the at least one unsolicited function to be performed as if with respect to the first client 1004a, allow the at least one unsolicited function to be performed as if with respect to another client 1004b indistinguishable from at least one other of the at least one client 1004a-n, modify the at least one unsolicited function and perform the modified at least one unsolicited function with respect to the first client 1004a on behalf of the at least one server 1008a-n associated therewith, or inhibit the performance of the at least one unsolicited function, or combinations thereof, the received instruction being stored in the database 1020 from which the direction of the user is at least in part derived. The user interface 1020 may be further operative, and/or executable, to receive other data, such as from the user, another user and/or the first client 1004a, and perform a third function with respect thereto according to the direction of the user. In one embodiment, the user interface 1020 is further operative to store the other data in the database 1012 from which the direction of the user is at least in part derived.

In one embodiment, the other data may include at least one product or service that the user is interested in purchasing, data representative of a receipt for purchase of a product or service, data representative of a credit instrument, the third function, which may be implemented via the mobile wallet app 1822, being operative to enable payment thereby, via the first client 1004a, or combinations thereof.

In one embodiment, the other data may include a context of the first client 1004a-n, such as a geographic location of the first client, movement, or rate thereof, of the first client, an environmental condition of the environment in which the first client is located, or change thereof, or combination thereof.

Each of the at least one server 1008a-n may be further operative to perform the at least one unsolicited function with respect to a second client 1004c of the at least one client 1004a-n without direction from the user thereof. The interface 1010 may be further operative to, according to the instruction of the user associated with the first and second clients 1004a,c, which may be received via the user interface 1020 from either the first client 1004a, the second client 1004c or another client 1004a-n or combination thereof associated with the user, cause each of the at least one server 1008a-n to perform the at least one unsolicited function with respect to the intermediary on behalf of the second client 1004c. It will be appreciated that the other data may be received via from the first client 1004a, the second client 1004c, or other client 1004a-n associated with the user, or combination thereof.

In one embodiment, the user, such as a parent, employer or other superior, may be associated with another user, such as a child, employee or other subordinate, and with a second client 1004c, the user interface being further operative, such as via the control center 1802 and/or subordinate control 1820 apps, to receive the instruction of the user to one of allow or inhibit the at least one unsolicited function with respect to the user, the other user, the first client 1004a, the second client 1004c, or a combination thereof.

In one embodiment, the other data received from the user includes authentication data for one or more of the at least one sever 1008a-n wherein the third function, which may be provided by the single sign on app 1850, comprises detecting that the user is accessing one of the at least one server 1008a-n for which authentication data is stored and automatically providing the authentication data thereto on behalf of the user, as was discussed above in relation to the single sign-on app 1850.

In one embodiment, the other data includes permission data defining a subset of the database 1020, or profile therein, and a subset of other users, which may include a marketer of a product or service, which may have access thereto. The permission data may further define a subset of data of one or more other users which the user wants access to. The interface 1010 may then be further operative to provide access, such as via the social network app 1848, the pay wall app 1858, the deal finder app 1860, and/or the profile marketplace app 1846, or other apps described above, to at least a portion of the database 1012, or profile stored therein, of one user to another user based on the permission data, such as in exchange for compensation to the user therefore.

In one embodiment where the users allowed access to the profile includes a marketer of a product or service, the other data may include identification of one or more products or services of interest to the user. Further, the interface 1010 may be further operative to correlate at least a portion of the database 1012, i.e. profile, of the user with at least a portion of the database 1012, i.e. profile, of the marketer and determine if the product or service of the marketer is of interest to the user.

In one embodiment, the other data may include data personal to the user, such as photographs, biographic data of the user, personal declarations, personal commentary, messages, or combinations thereof.

In one embodiment, the other data may include a geographic location of the user, which may be provided by the first client 1004a, such as via a GPS device therein, where the intermediary 1002 further includes an offer processor 1024 coupled with the interface 1010 and operative, such as via the deal finder app 1860, to determine one or more financial incentives based on the geographic location of the user and present the determined one or more financial incentives thereto. The one or more financial incentives may be determined by accessing a database associated with a retail establishment (not shown) located at the geographic location.

In one embodiment, the other data may include one or more search terms, where the intermediary 1002, via the search app 1810, further includes a search processor 1026 coupled with the interface 1010 and operative to transmit, such as without identifying the user or the first client 1004a, the one or more search terms to one or more search engines (not shown), which may be operated by the intermediary 1002 or by a third party, such as on a server 1008a-n, on behalf of the user, receive the results therefrom, and present the received results to the user. The search processor 1026 may be further operative to process the results in accordance with the direction of the user, such as to aggregate the received results from the one or more search engines and present the aggregated results to the user, filter or sort the search results in accordance with the preferences of the user. The search processor 1026 may be further operative to remove advertisements from the search results prior to the presentation thereof to the user or otherwise remove data from content links within the search results which would allow the one or more search engines to track the user's selection of the content links.

In one embodiment, the other data may include data, such as photographs, descriptive information, user commentary, identifying information, metadata, content links to related information, or combinations thereof, related to at least one asset associated, such as owned by, with the user, the third function, which may be implemented by the asset management app 1806, comprising management thereof. Where the other data includes content links, the content links may link to asset warranty information, asset maintenance information, asset registration information, asset recall information, asset operation information, or combinations thereof. Where the other data further includes a location of at least one of the at least one asset, the third function may be operative to manage movement of the one of the at least one asset, such as by presenting the location of the one of the at least one asset to the user via the user interface 1020, such as on a map. The third function may be further operative to report a change in the location of the one of the at least one asset to the user via the user interface 1020, such as when the change deviates from a threshold defined by the user. Alternatively, or in addition thereto, the third function may be operative to provide direction to the user via the user interface 1020 to direct the user to the location of the one of the at least one asset.

In one embodiment, the other data further includes sensor data or identifiers sensed by a sensor, e.g. radio frequency, optical, audio or other type of sensor, of the first client, such as an RFID, Zigbee, Bluetooth or other near field communication (“NFC”) sensor, from a like sensor tag associated, such as attached to or embedded in, with the asset. The third function may further include notifying the user via the user interface 1020 when one of the sensor senses sensor data associated with one of the at least one asset, senses less frequently or stops sensing sensor data associated with one of the at least one asset, or combinations thereof.

In one embodiment, the other data may include identification of content of interest to the user available from one or more content providers, such as servers 1008a-n, the third function, which may be implemented by the content portal app 1814, may further include obtaining the content of interest from the one or more content providers and presenting the content of interest to the user, such as via the user interface 1020. The third function is further operative to consolidate the obtained content of interest prior to the presentation thereof. The obtained content of interest may be further stored in the database 1012 from which the direction of the user is derived.

In one embodiment, the intermediary 1002 further includes a recommendation processor 1028 coupled with the interface and operative, such as via the personal assistant app 1818, to analyze at least a portion of the data stored in the database 1012, such as the user's profile or portion thereof, and generate a recommendation based thereon, such as a recommended product or service, and/or a provider thereof or a recommended action for the user for managing privacy via the intermediary 1002, wherein the recommendation processor 1028 may be further operative to present the generated recommendation to the user via the user interface 1020. The recommendation may be presented as a reminder inserted into an electronic calendar maintained by the user or the intermediary 1002. Where the other data includes data representative of at least one user preference and/or at least one context of the first client 1004a and/or user, such as the geographic location thereof, the recommendation processor 1028 may be further operative to base the generation of the recommendation thereon. In one embodiment, the recommendation processor 1028 may be further operative to analyze at least the portion of the data stored in the database 1012 by topic, date, location or combinations thereof, such as to identify patterns of behavior of the user. In one embodiment, the recommendation processor 1028 is associated with, and/or implemented at least in part within, the first client 1004a so as to be capable of functioning without network connectivity.

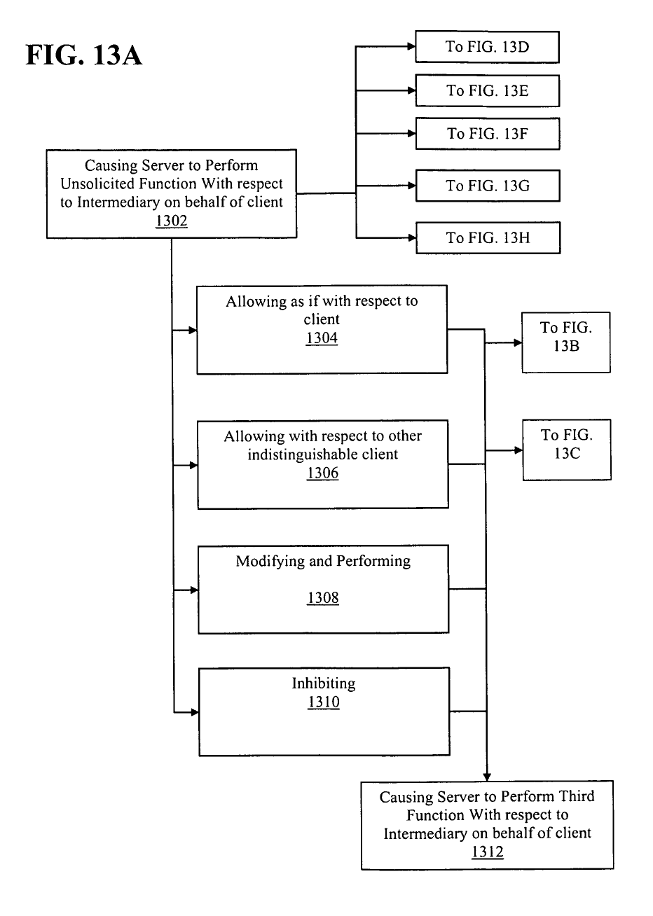

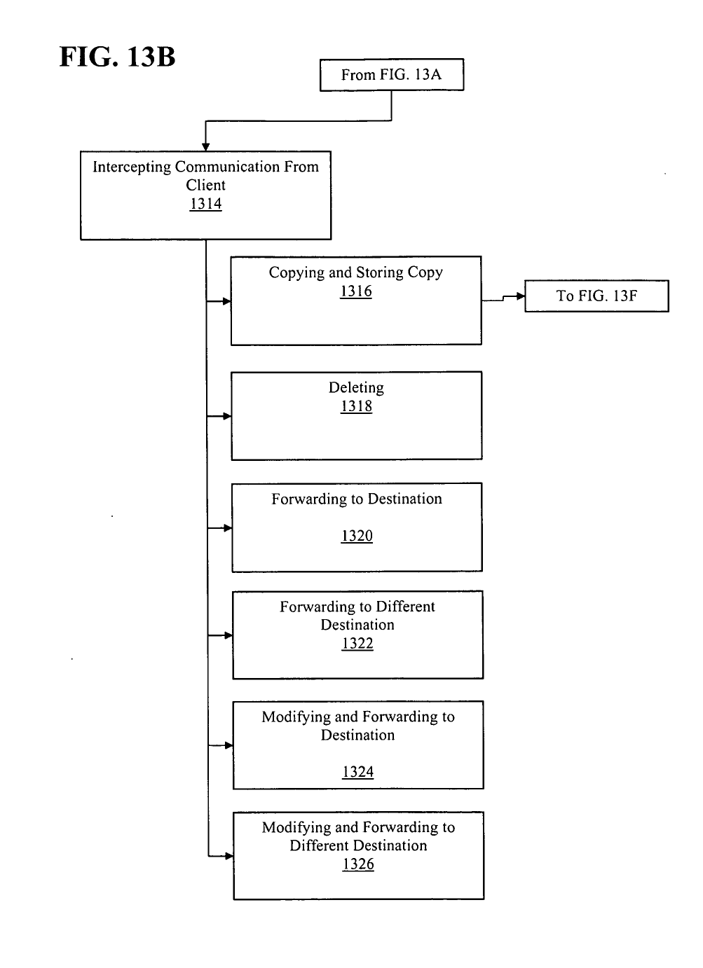

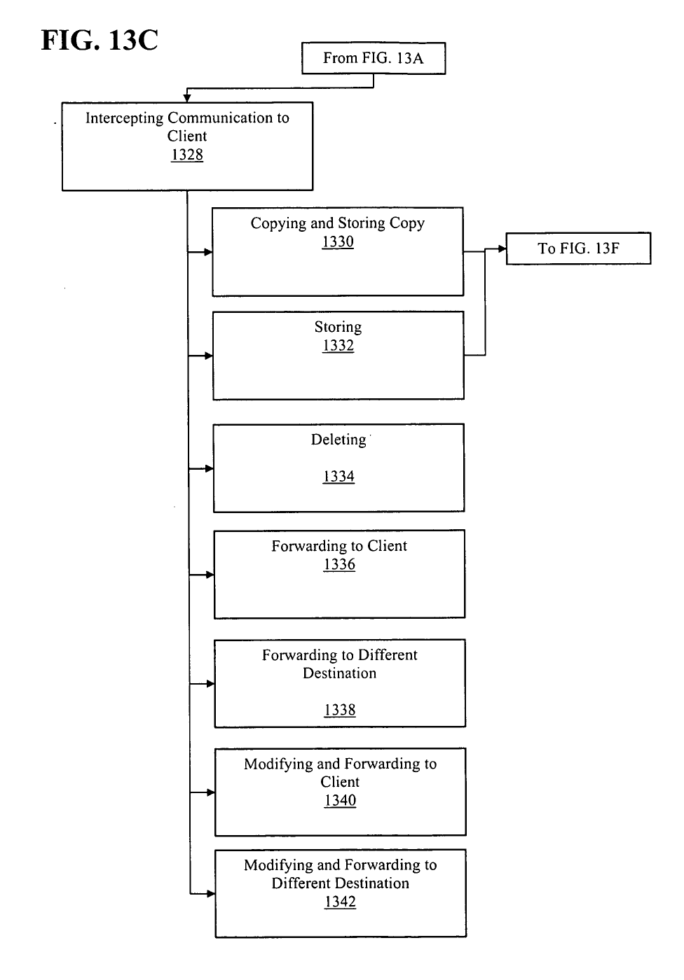

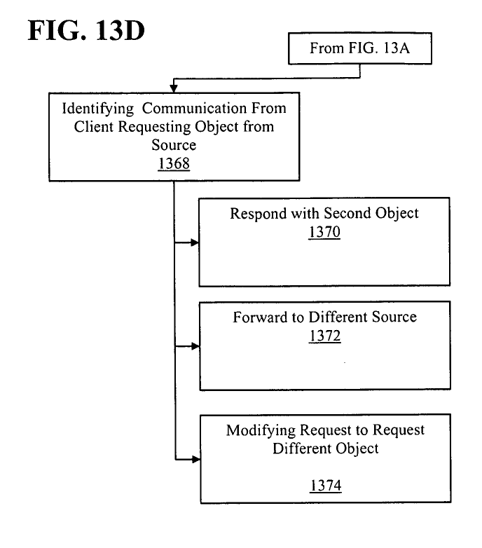

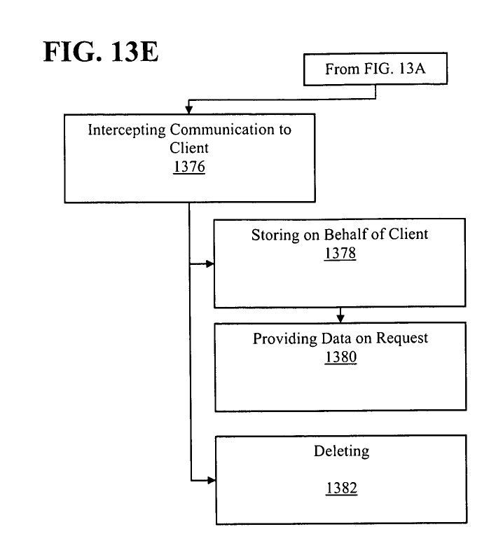

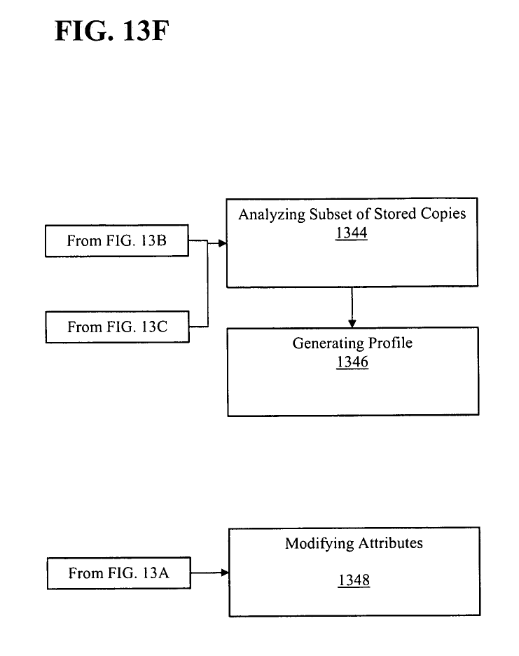

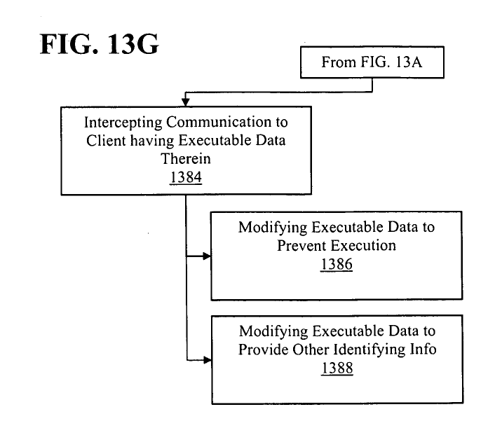

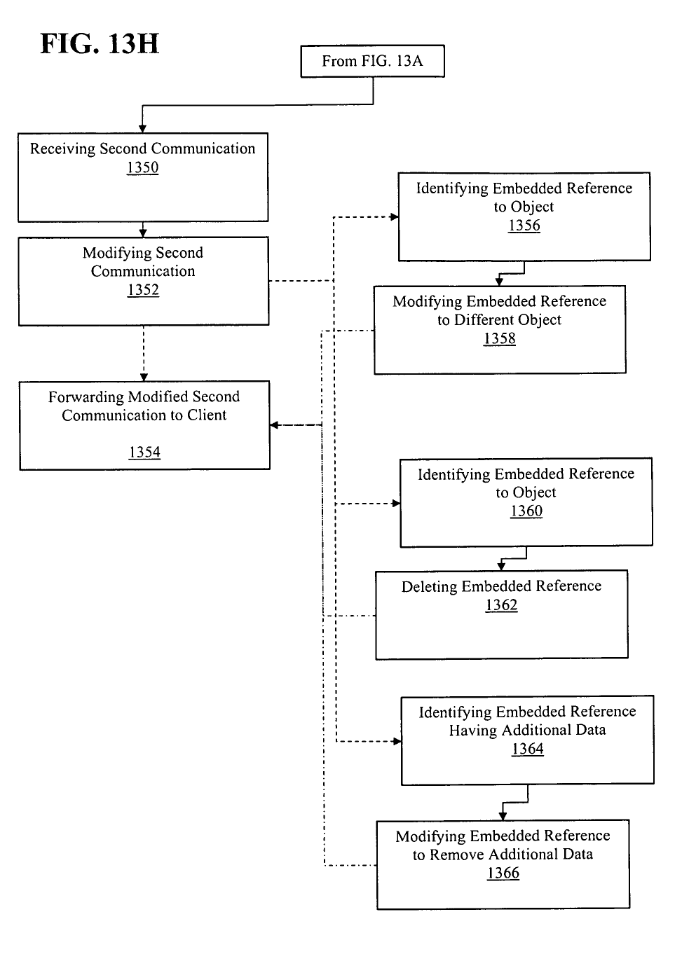

Referring to FIGS. 13A-H, there is shown a flow chart depicting exemplary operation of the intermediary 1002, described above, for managing or otherwise facilitating management of unsolicited server 1008a-n operations in a client-server architecture, the intermediary 1002 including a processor 1030 and an interface 1010 coupled therewith. The client-server architecture may include at least one client 1004a-n in communication, via a network 1006, with at least one server 1008a-n, each of the at least one server 1008a-n being operative to perform at least one unsolicited function with respect to each of the at least one client 1004a-n upon which one or more of the at least one server 1008a-n is at least partially dependent to facilitate stateful operation thereof with respect to the respective at least one client 1004a-n, each of the at least one unsolicited function comprising one of a first active function with respect to the respective client 1004a-n comprising provision of server 1008a-n originated, e.g. client- or user identifying, data thereto or a second passive function with respect to the respective client 1004a-n comprising obtaining of client 1004a-n originated, e.g. client- or user identifying, data therefrom. The stateful operation of the one or more of the at least one server 1008a-n may include one of a tracking, monitoring, user identifying, user personal information gathering, usage data gathering operation, or combination thereof.

The operation includes causing by the processor 1030 via the interface 1010, the interface 1010 being in communication, via the network 1006, with at least a first client 1004a of the at least one client 1004a-n and at least a first server 1008a of the at least one server 1008a-n, according to a direction of a user associated with the first client 1004a and derived at least in part from data, e.g. a profile, indicative of previous interaction between the user, and/or another user, via the first client 1004a and/or another of the at least one client 1004a-n, and at least one of the at least one server 1008a-n, the first server 1008a to perform the at least one unsolicited function with respect to the intermediary 1002 on behalf of the first client 1004a, the stateful operation of the one or more of the at least one server 1008a-n at least partially dependent thereon thereby being subject to the direction of the user (block 1302). The direction of the user may further be derived from instructions provided by the user to the intermediary 1002. The direction of the user may include no action by the user, such as acceptance of a default direction. The causing of the first server 1008a to perform the at least one unsolicited function with respect to the intermediary 1002 on behalf of the first client 1004a may thereby disrupt the stateful operation of the one or more of the at least one server 1008a-n with respect to the first client 1004a. Further, the first sever 1008a may be unaware that is has been caused to perform the at least one unsolicited function with respect to the intermediary 1002 on behalf of the first client 1004a. In one embodiment, the second passive function may include collecting identifying information about the first client or deriving identifying information therefrom and/or the first active function may include transmitting a unique identifier to the first client to be stored thereby for subsequent retrieval, transmitting executable program code to the first client to be executed thereby to cause the first client to transmit identifying data, causing the first client to transmit a unique identifier, in response to a request for content from the first client, adding additional content not requested by the first client thereto and transmitting the content and the additional content to the first client in response to the request, or combinations thereof.

In one embodiment, the operation may further include one of allowing the at least one unsolicited function to be performed as if with respect to the first client (block 1304), allowing the at least one unsolicited function to be performed with respect to another client indistinguishable from at least one other of the at least one client (block 1306), modifying the at least one unsolicited function and performing the modified at least one unsolicited function with respect to the first client on behalf of the at least one server associated therewith (block 1308), or inhibiting the performance of the at least one unsolicited function (block 1310).

In one embodiment, communications between the interface and the first client may be encrypted.

In one embodiment, each of the at least one server 1008a-n may be further operative to perform the at least one unsolicited function with respect to a second client 1004b of the at least one client 1004a-n without direction from the user and wherein the method further comprises causing, according to the direction of the user, the first server 1008a and/or a second server 1008b to perform the at least one unsolicited function with respect to the intermediary 1002 on behalf of the second client 1004b.

In one embodiment, wherein each of the at least one server 1008a-n is further operative to perform a third function with respect to each of the at least one client 1004a-n at the direction of a user thereof, the at least one unsolicited function may be performed subsequent thereto. The operation may then further include causing the first server 1008a to perform the third function with respect to the intermediary on behalf of the first client 1004a (block 1312). The third function may include delivery of media content to the first client 1004a in response to a request therefore received from the first client 1004a.

In one embodiment, the operation of the intermediary 1002 may include intercepting a communication transmitted from the first client 1004a to a destination, such as one or more of the at least one server 1008a-n, prior to the receipt thereby (block 1314), and one of copying at least a portion of the communication and storing the copy in a storage associated with the intermediary 1002 (block 1316), deleting the communication (block 1318), forwarding the communication to the destination (block 1320), forwarding the communication to a different destination (block 1322), modifying at least a portion of the communication and forwarding the modified communication to the destination (block 1324), modifying at least a portion of the communication and forwarding the modified communication to a different destination (block 1326), or combinations thereof. The operation of the intermediary 1002 may further include intercepting a communication transmitted from a source, such as one or more of the at least one server 1008a-n, to the first client 1004a prior to the receipt thereby (block 1328), and one of copying at least a portion of the communication and storing the copy in the storage (block 1330), storing at least a portion of the communication in the storage (block 1332), deleting the communication (block 1334), forwarding the communication to the first client 1004a (block 1336), forwarding the communication to a different destination (block 1338), modifying at least a portion of the communication and forwarding the modified communication to the first client 1004a (block 1340), modifying at least a portion of the communication and forwarding the modified communication to a different destination (block 1342), or combinations thereof. In one embodiment, wherein the first client 1004a is operative to communicate via the network using a plurality of communications protocols, the intercepting from or to the first client 1004a may further include intercepting only a subset of the communications protocols specified by the user.

In one embodiment, the operation further includes analyzing, by the processor, at least a subset of the stored copies (block 1344) and generating a profile based thereon (block 1346), the profile comprising the data indicative of previous interaction between the user and at least one of the at least one server 1008a-n.

In one embodiment, the operation of the intermediary 1002 further includes an anonymizing function, which may be referred to as an anonymizing proxy 1018, wherein each of the at least one client 1004a-n is operative to transmit a plurality of communications, each of the plurality of communications of each of the at least one client 1004a-n being characterized by a set of attributes, at least one attribute of the set of attributes characterizing the plurality of communications of the first client 1004a being non-unique with respect to a corresponding attribute of another set of attributes characterizing the plurality of communication of another client 1004b of the at least one client 1004a-n, but wherein the set of attributes characterizing the plurality of communication of the first client 1004a is substantially unique with respect to the set of attributes characterizing the plurality of communications of the other client 1004b, the method further comprising modifying, by the processor 1030, one or more attributes of the set of attributes characterizing the plurality of communications of the first client 1004a such that the modified set of attributes characterizing the plurality of communications of the first client 1004a is not substantially unique with respect to the set of attributes characterizing the plurality of communications of the other client 1004b (block 1348). The set of attributes may include source IP address, user agent string, a client application identifier, data describing one or more capabilities of the first client, or combinations thereof. In one embodiment, the modifying may further include modifying, only during a session comprising the plurality of communications of the first client 1004a, the one or more attributes of the set of attributes characterizing the plurality of communications of the first client 1004a such that the modified set of attributes characterizing the plurality of communications of the first client 1004a is not substantially unique with respect to the set of attributes characterizing the plurality of communications of the other client 1004b.

In one embodiment, the operation of the intermediary 1002 further includes receiving a second communication, transmitted to the first client 1004a in response to a first communication transmitted by the first client 1004a, prior to receipt thereby (block 1350); modifying at least a portion of the second communication (block 1352), such as in accordance with the direction of the user; and forwarding the modified second communication to the first client 1004a (block 1354). The operation may further include identifying at least one embedded reference within the second communication, which may include at least a portion of an HTML web page, to a first object external to the second communication, the at least one embedded reference operative to cause the first client 1004a to transmit a third communication to request the first object (block 1356); and modifying the at least one embedded reference such that the modified at least one embedded reference is operative to cause the first client 1004a to transmit the third communication to request a second object instead of the first object (block 1358). The operation may further include identifying at least one embedded reference within the second communication to a first object external to the second communication, the at least one embedded reference operative to cause the first client 1004a to transmit a third communication to request the first object (block 1360); and deleting the at least one embedded reference (block 1362). The operation may further include: identifying at least one embedded reference within the second communication to a first object external to the communication, the at least one embedded reference operative to cause the first client 1004a to transmit a third communication to request the first object and wherein the at least one embedded reference comprises additional data unrelated to the request for the first object which would be included in the third communication (block 1364); and modifying the at least one embedded reference to remove the additional data, the modified at least one embedded reference still being capable of causing the first client 1004a to transmit the third communication to request the first object without the additional data (block 1366).

In one embodiment, the operation of the intermediary 1002 further includes: identifying a communication from the first client 1004a comprising a request for a first object from a first source (block 1368), such as one or more of the at least one server 1008a-n, for example, by identifying the communication based on a prior communication transmitted to the first client 1004a and operative to cause the first client 1004a to transmit the communication or by identifying the communication based on an identification of the first source to which the communication is addressed; and one of responding to the request by providing a second object to the first client 1004a (block 1370), forwarding the communication to a second source (block 1372), modifying the communication to request a second object instead of the first object from one of the first or second sources (block 1374), or combinations thereof.

In one embodiment, the operation of the intermediary 1002 further includes: intercepting a communication transmitted from a source, such as one or more of the at least one server 1008a-n, to the first client 1004a prior to the receipt thereby, the communication comprising data intended by the source to be stored by the first client 1004a, such as a cookie, and provided by the first client 1004a to a requestor upon request (block 1376); and storing the data on behalf of the first client 1004a (block 1378) and, on behalf of the first client and according to the direction of the user, providing the data to a requestor upon request (block 1380). In one embodiment, the data may only be stored during a communication session between the first client 1004a and the source. In one embodiment, the operation may further include deleting the stored data (block 1382).

In one embodiment, the operation of the intermediary 1002 further includes: intercepting a communication transmitted from a source, such as one or more of the at least one server 1008a-n, to the first client 1004a prior to the receipt thereby, the communication comprising data, such as JAVAscript or HTML5 code, intended by the source to be executed by the first client 1004a to cause the first client 1004a to provide identifying data to a requestor upon request (block 1384); and modifying the data at the direction of the user to prevent the data from being executed by the first client 1004a to cause the first client 1004a to provide identifying data to a requestor upon request (block 1386). Alternatively, the data may be modified and provided to the first client 1004a to be executed thereby to cause the first client 1004a to provide non-identifying data to a requestor upon request (block 1388).

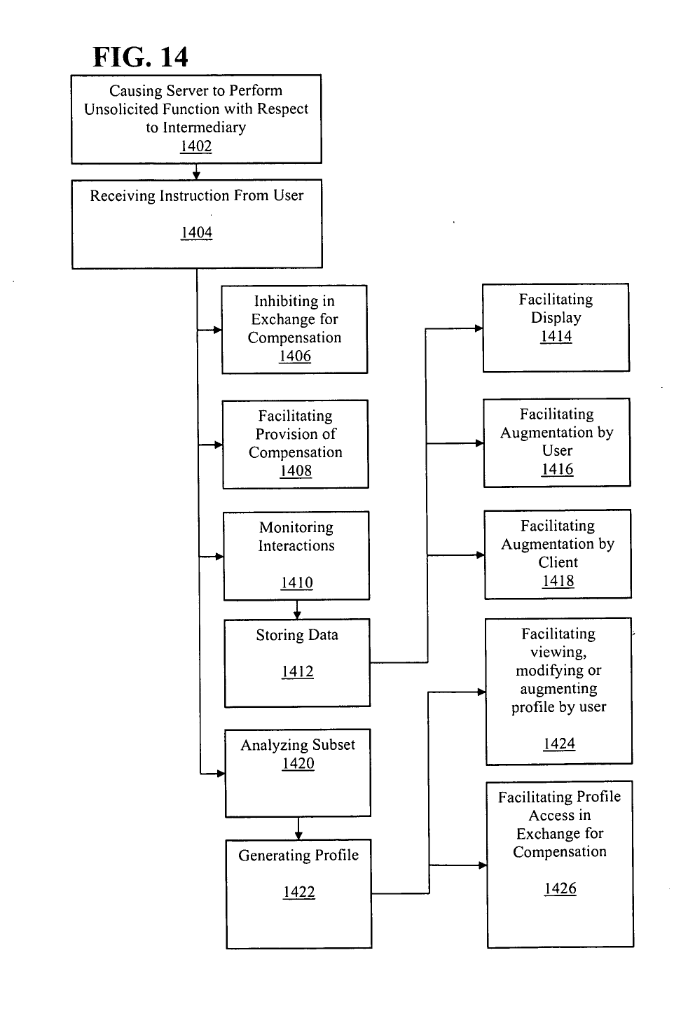

Referring to FIG. 14, there is shown a flow chart depicting exemplary operation of the intermediary 1002, described above, for facilitating management of unsolicited server operations in a client-server architecture by the intermediary 1002 comprising a processor 1030 and an interface 1010 coupled therewith, the client-server architecture comprising at least one client 1004a-n in communication, via a network 1006, with at least one server 1008a-n, each of the at least one server 1008a-n being operative to perform at least one unsolicited function with respect to each of the at least one client 1004a-n upon which one or more of the at least one server 1008a-n is at least partially dependent to facilitate stateful operation thereof with respect to the respective at least one client 1004a-n, each of the at least one unsolicited function comprising one of a first active function with respect to the respective client 1004a-n comprising provision of server 1008a-n originated, e.g. client 1004a-n identifying, data thereto or a second passive function with respect to the respective client 1004a-n comprising obtaining of client 1004a-n originated, e.g. client- or user identifying, data therefrom. The operation of the intermediary includes: causing by the processor 1030 via the interface 1010, the interface 1010 being in communication, via the network 1006, with at least a first client 1004a of the at least one client 1004a-n and at least a first server 1008a of the at least one server 1008a-n and operative to, according to a direction of a user associated with the first client and derived at least in part from data indicative of previous interaction between the user 1004a and at least one of the at least one server 1008a-n, the first server 1008a to perform the at least one unsolicited function with respect to the intermediary 1002 on behalf of the first client 1004a, the stateful operation of the one or more of the at least one server 1008a-n at least partially dependent thereon thereby being subject to the direction of the user (block 1402); and receiving, via a user interface 1020 provided by and/or coupled with the processor 1030, such as one or more web pages provided by the intermediary 1002, an instruction provided by the user to cause the intermediary 1002 to one of allow the at least one unsolicited function to be performed as if with respect to the first client 1004a, allow the at least one unsolicited function to be performed as if with respect to another client 1004b indistinguishable from at least one other of the at least one client 1004a-n, modify the at least one unsolicited function and perform the modified at least one unsolicited function with respect to the first client 1004a on behalf of the at least one server 1008a-n associated therewith, or inhibit the performance of the at least one unsolicited function (block 1404). The second passive function may include collecting identifying information about the first client 1004a, and/or relating or otherwise deriving additional or more specific identifying information from the collected identifying information. The first active function may include transmitting a unique identifier to the first client 1004a to be stored thereby for subsequent retrieval, transmitting executable program code to the first client 1004a to be executed thereby to cause the first client 1004a to transmit identifying data, causing the first client 1004a to transmit a unique identifier, in response to a request for content from the first client 1004a, adding additional content not requested by the first client 1004a thereto and transmitting the content and the additional content to the first client 1004a in response to the request.

In one embodiment, the user, such as a parent, employer or other superior, may be associated with another user, such as a child, employee or other subordinate, and with a second client 1004c, the user interface being further operative, such as via the control center 1802 and/or subordinate control apps 1820, to receive the instruction of the user to one of allow or inhibit the at least one unsolicited function with respect to the user, the other user, the first client 1004a, the second client 1004c, or a combination thereof.

In one embodiment, the operation of the intermediary 1002 further includes inhibiting the at least one unsolicited function in exchange for a compensation from the user (block 1406). The compensation may be transferred to each of the at least one server 1008a-n for which the at least one unsolicited function was inhibited.

In one embodiment, the operation of the intermediary 1002 further includes facilitating provision of compensation to the user from a one of the at least one server 1008a-n to allow the performance of the at least one unsolicited function thereby at least as if with respect to the first client 1004a (block 1408).

In one embodiment, the operation of the intermediary 1002 further includes monitoring interactions of the first client 1004a comprising communications, such as communications characterized by a particular communications protocol, by a particular subject matter, or combination thereof, transmitted by the first client 1004a, transmitted to the first client 1004a, or combinations thereof (block 1410), and storing data representative of the interactions in a database 1012 from which the direction of the user is at least in part derived (block 1412). The data may be further used to facilitate state operation with respect to the first client 1004a. In one embodiment, the operation may further include facilitating a display of the stored data from the database (block 1414), facilitating augmentation of the database 1020 by the user (block 1416), and/or facilitating augmentation of the database by the first client 1004a based on, for example, a temporal context, geographic context, environmental context, or a combination thereof (block 1418). In one embodiment, wherein the user is associated with a second client 1004c, the monitoring may further include monitoring interactions of the second client 1004c comprising communications by the second client 1004c, transmitted to the second client 1004c, or combinations thereof, and storing data representative of the interaction of the second client 1004c in the database 1012.

In one embodiment, the operation of the intermediary 1002 further includes analyzing at least a subset of the stored data representative of the interactions of the first client (block 1420) and generating at least one user profile based thereon (block 1422), wherein the direction of the user is derived from at least one of the at least one user profile. The at least one user profile may include data characterizing the user at least one of demographically, firmographically, contextually, behaviorally, temporally, preferentially, or combinations thereof. The operation of the intermediary 1002 may further include facilitating viewing or display of the at least one user profile, such as via the user interface 1020, modifying the at least one user profile, augmenting the at least one user profile or combinations thereof, by the user (block 1424). The operation of the intermediary 1002 may further include facilitating access, such as on a one time or periodic basis, to at least a subset of the at least one user profile by a third party, such as one of the at least one server 1008a-n whose performance of the first function was inhibited by the interface 1010, in exchange for compensation (block 1426), which may be fixed or vary, such as based on the amount or extent of access to the user profile. In one embodiment, the subset of the at least one user profile to which access may be facilitated may be defined dynamically and/or contextually, temporally, geographically, based on specificity, or combinations thereof.

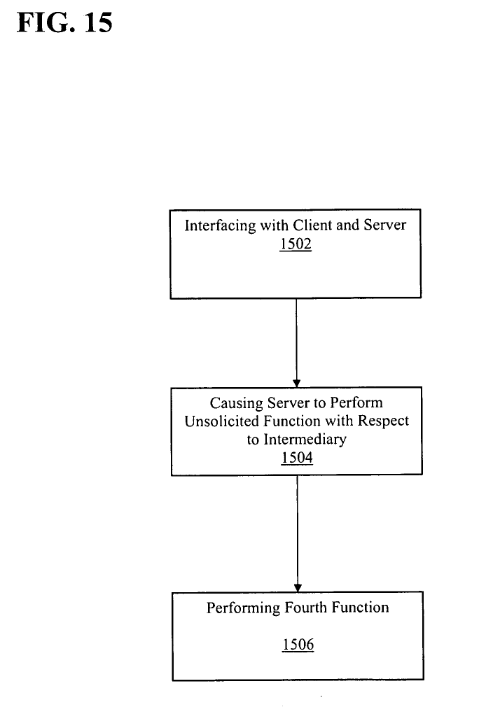

Referring to FIG. 15, there is shown a flow chart depicting exemplary operation of the intermediary 1002, described above, for facilitating management of unsolicited server operations in a client-server architecture by the intermediary 1002 comprising a processor 1030 and an interface 1010 coupled therewith, the client-server architecture comprising at least one client 1004a-n in communication, via a network 1006, with at least one server 1008a-n, each of the at least one server 1008a-n being operative to perform at least one unsolicited function with respect to each of the at least one client 1004a-n upon which one or more of the at least one server 1008a-n is at least partially dependent to facilitate stateful operation thereof with respect to the respective at least one client 1004a-n, each of the at least one unsolicited function comprising one of a first active function with respect to the respective client 1004a-n comprising provision of server originated, e.g. client- or user identifying, data thereto or a second passive function with respect to the respective client comprising obtaining of client originated, e.g. client- or user identifying, data therefrom the stateful operation further comprising performance of a third function with respect to the respective at least one client 1004a-n based on a first result of the at least one unsolicited function to achieve a second result.

The operation includes: interfacing, via the network 1006, with at least first client 1004a of the at least one client 1004a-n and at least a first server 1008a of the at least one server 1008a-n (block 1502); causing, according to a direction of a user associated with the first client 1004a and derived at least in part from data indicative of previous interaction between the user and at least one of the at least one server 1008a-n, the first server 1008a to perform the unsolicited function with respect to the intermediary 1002 on behalf of the first client 1004a, the stateful operation of the one or more of the at least one server 1008a-n at least partially dependent thereon thereby being subject to the direction of the user such that the third function is prevented from being performed to achieve the second result (block 1504); and performing a fourth function with respect to the first client 1004a based at least in part on the direction of the user which modifies the at least one unsolicited function, e.g. the performance thereof, modifies the third function, e.g. the performance thereof, modifies the first result, modifies the second result, supplants the third function, or combinations thereof, to achieve a third result, which may be substantially similar to the second result (block 1506). In one embodiment, the second passive function may include collecting identifying information about the first client 1004a or deriving identifying information therefrom, and/or the first active function may include transmitting a unique identifier to the first client 1004a to be stored thereby for subsequent retrieval, transmitting executable program code to the first client 1004a to be executed thereby to cause the first client 1004a to transmit identifying data, causing the first client 1004a to transmit a unique identifier, and/or, in response to a request for content from the first client 1004a, adding additional content not requested by the first client 1004a thereto and transmitting the content and the additional content to the first client 1004a in response to the request.

In one embodiment, the third and fourth function may be implemented by a pay wall app 1858 and may each include causing compensation to be provided to the user based on activity thereby, wherein, for example, the first result includes identification of the user to which compensation should be provided. For example, the third function may include causing compensation to be provided to the user based on activity thereby, such as the purchase or products or services, with respect to one of the at least one server 1008a-n, the compensation caused to be provided by the third function being redeemable by the user therewith, i.e. only that server, and further wherein the fourth function comprises causing compensation to be provided to the user based on activity thereby with respect to at least one of the at least one server 1008a-n, the compensation caused to be provided by the fourth function being redeemable therewith, i.e. any of the at least one server 1008a-n. In one embodiment, the user may be permitted to exchange at least a portion of the compensation with another user. The compensation may comprise a monetary compensation, a credit, points or other form of compensation.

In one embodiment, the third and fourth function may include facilitation of the provision of content, such as an advertisement, to be transmitted to the first client 1004a wherein, for example, the content provisioned as result of the third function is different from the content provisioned as a result of the fourth function. For example, the content provisioned as a result of the fourth function may be in accordance with an interest of the user. The fourth function may further include accessing a search engine operative to select content to be provisioned. The fourth function may further include facilitation of the provision of content selected based at least on, e.g. a result of, one of the first active function or the second passive function.

In one embodiment, the fourth function may prevent the provisioning of content facilitated by the third function, such as based on an identity of a provider of the content and/or in exchange for compensation paid by the user.

In on embodiment, the third function may include causing the first client 1004a to request the provision of first content from a provider thereof, such as one of the at least one server 1008a-n, where the fourth function further includes modifying the third function to cause the first client 1004a to request the provision of second content different from the first content, from the same or a different provider. In one embodiment, the third function comprises causing the first client 1004a to request the provision of first content from a provider thereof, such as one of the at least one server 1008a-n where the fourth function further includes modifying the request by the first client 1004a to request the provision of second content different from the first content from the same or a different provider. In one embodiment, the third function may include causing the first client 1004a to request the provision of first content from a provider thereof, such as one of the at least one server 1008a-n, the fourth function further comprising intercepting the request from the first client 1004a prior to the receipt by the provider and responding to the request with second content different from the first content.

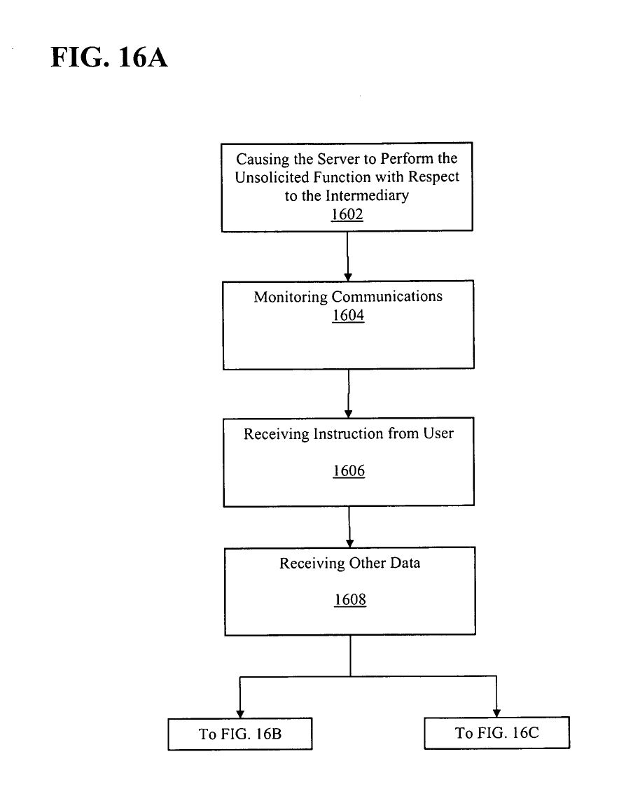

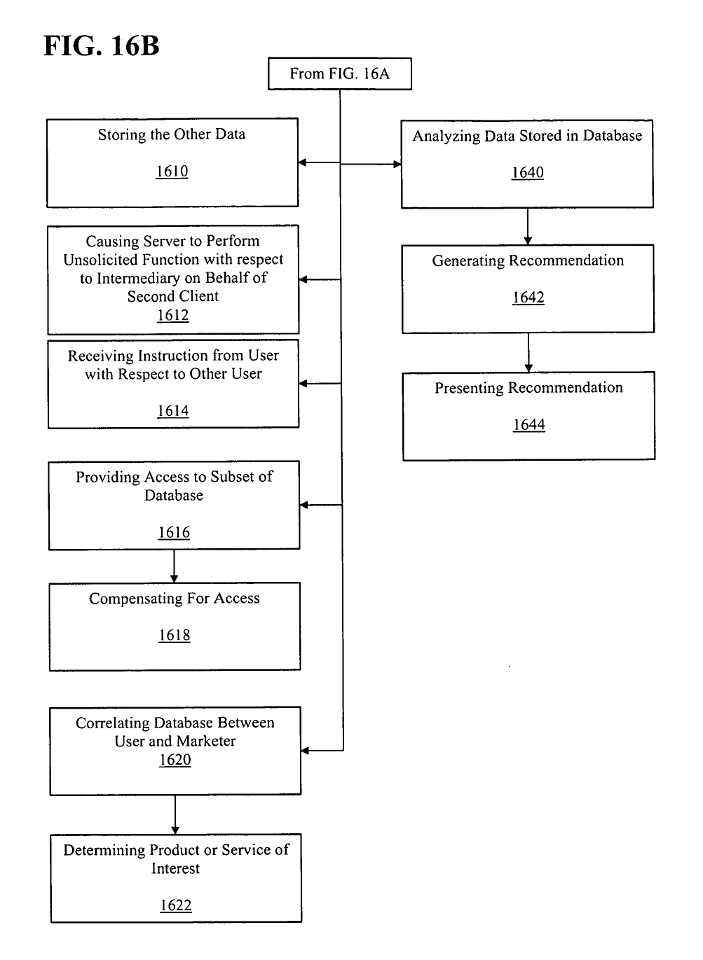

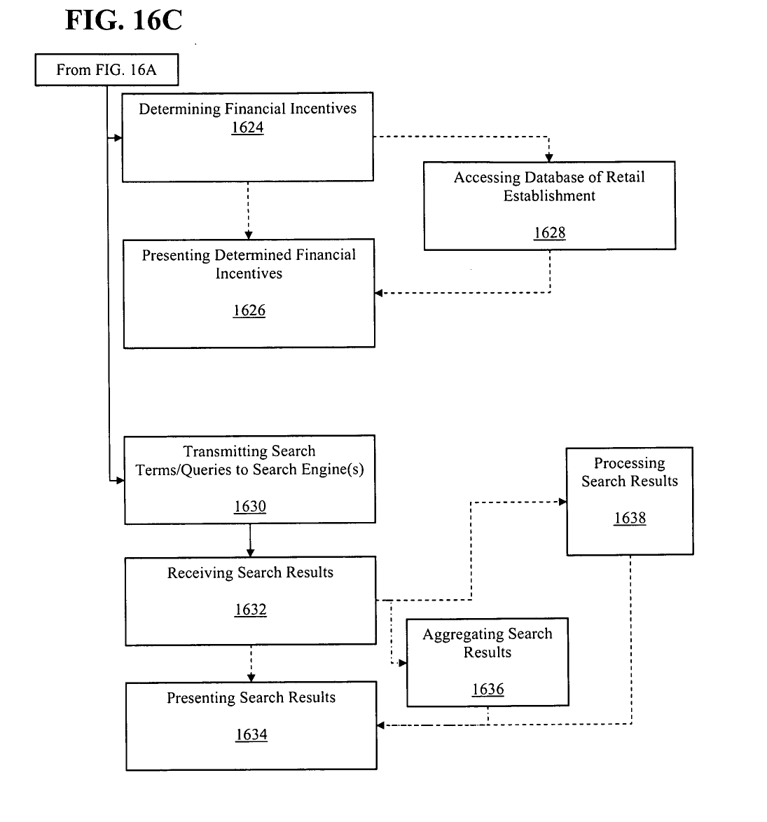

Referring to FIGS. 16A-C, there is shown a flow chart depicting exemplary operation of the intermediary 1002, described above, for facilitating management of unsolicited server operations in a client-server architecture by the intermediary 1002 comprising a processor 1030 and an interface 1010 coupled therewith, the client-server architecture comprising at least one client 1004a-n in communication, via a network 1006, with at least one server 1008a-n, each of the at least one server 1008a-n being operative to perform at least one unsolicited function with respect to each of the at least one client 1004a-n upon which one or more of the at least one server 1008a-n is at least partially dependent to facilitate stateful operation thereof with respect to the respective at least one client 1004a-n, each of the at least one unsolicited function comprising one of a first active function with respect to the respective client 1004a-n comprising provision of server originated, e.g. client- or user identifying, data thereto or a second passive function with respect to the respective client 1004a-n comprising obtaining of client originated, e.g. client- or user identifying, data therefrom, and/or relating or otherwise deriving additional or more specific identifying information from the collected identifying information.

The operation includes: causing, by the interface 1010, in communication, via the network 1006, with at least a first client 1004a of the at least one client 1004a-n and at least a first server 1008a of the at least one server 1008a-n and operative to, according to a direction of a user associated with the first client 1004a and derived at least in part from data indicative of previous interaction between the user and at least one of the at least one server 1008a-n, the first server 1008a to perform the at least one unsolicited function with respect to the intermediary on behalf of the first client 1004a, the stateful operation of the one or more of the at least one server at least partially dependent thereon thereby being subject to the direction of the user (block 1602); monitoring, via the interface, interactions of the first client 1004a comprising communications transmitted by the first client 1004a, transmitted to the first client 1004a, or combinations thereof, and storing data representative of the interactions in a database from which the direction of the user is at least in part derived (block 1604); receiving, via a user interface 1020, an instruction provided by the user to cause the intermediary 1002 to one of allow the at least one unsolicited function to be performed as if with respect to the first client 1004a, allow the at least one unsolicited function to be performed as if with respect to another client 1004b indistinguishable from at least one other of the at least one client 1004a-n, modify the at least one unsolicited function and perform the modified at least one unsolicited function with respect to the first client 1004a on behalf of the at least one server 1008a-n associated therewith, or inhibit the performance of the at least one unsolicited function, the received instruction being stored in the database 1012 from which the direction of the user is at least in part derived (block 1606); and receiving, via the user interface 1020, other data, such as from the user, the first client 1004a, or a combination thereof, and performing a third function with respect thereto according to the direction of the user (block 1608). The other data may include a context of the user and/or the first client 1004a, such as a geographic location of the user or first client 1004a, movement, or rate thereof, of the user or first client 1004a, an environmental condition of the environment in which the user or first client 1004a is located, or change thereof, or combination thereof. The other data may include at least one product or service that the user is interested in purchasing and/or a receipt for purchase of a product or service. The other data may include data representative of a credit instrument, the third function, which may be implemented by the mobile wallet app 1822, being operative to enable payment thereby, via the first client 1004a. The other data may include data personal to the user, such as photographs, biographic data of the user, personal declarations, personal commentary, messages, or combinations thereof. The other data may be further used for the derivation of the direction of the user and the operation of the intermediary 1002 may further include storing the other data in the database 1012 from which the direction of the user is at least in part derived (block 1610).

In one embodiment, wherein each of the at least one server 1008a-n is further operative to perform the at least one unsolicited function with respect to a second client 1004b of the at least one client 1004a-n without direction from the user thereof, the operation of the intermediary 1002 may further include causing, according to the direction of the user associated with the first and second clients 1004a-b, each of the at least one server 1008a-n to perform the at least one unsolicited function with respect to the intermediary on behalf of the second client 1004b (block 1612). At least one of the instruction of the user and/or the other data, may received via the user interface 1020 from either the first client 1004a and/or the second client 1004b.

In one embodiment, wherein the user, such as a parent, employer or other superior, is associated with another user, such as a child, employee or other subordinate, and with a second client 1004b, the operation of the intermediary 1002 may further include receiving, such as via the control center 1802 and/or subordinate control apps 1820, the instruction of the user to one of allow or inhibit the at least one unsolicited function with respect to the user, the other user, the first client 1004a, the second client 1004b, or a combination thereof (block 1614).

In one embodiment, the other data received from the user may include authentication data for one or more of the at least one sever 1008a-n wherein the third function comprises detecting that the user is accessing one of the at least one server 1008a-n for which authentication data is stored and automatically providing the authentication data thereto on behalf of the user, such as was described above for the single sign-on app 1850.

In one embodiment, the other data may include permission data defining a subset of the database 1012 and a subset of other users, such as a friend, family member, service provider, marketer of a product or service, etc., which may have access thereto. The permission data may further define a subset of data of one or more other users which the user wants access to. The operation of the intermediary 1002 may then further include, via the social network app 1848, pay wall app 1858, the deal finder app 1860, and/or profile market place app 1846 or other apps described above, providing access to the subset of the database 1012 of one user to another user based on the permission data (block 1616). The operation of the intermediary 1002 may further include compensating, such as via the pay wall app 1858, the user for access to the database (block 1618). Where the other user is a marketer of a product or service, the other data, which may be stored in the database 1012 and be included in the defined subset thereof, may include identification of one or more products or services of interest to the user. Further, the operation of the intermediary 1002 may further include correlating at least a portion of the database 1012 associated with the user with at least a portion of the database 1012 associated with the marketer (block 1620) and determining if the product or service of the marketer is of interest to the user (block 1622).

In one embodiment, the other data may include a geographic location of the user and/or the first client 1004a, provided, for example, by the first client 1004a, the operation of the intermediary 1002 further including, such as via the deal finder app 1860, determining one or more financial incentives based on the geographic location of the user (block 1624) and presenting the determined one or more financial incentives thereto (block 1626). In one embodiment, the operation may further include accessing a database associated with a retail establishment (not shown) located at the geographic location, or otherwise coupled with the network 1006, to determine the one or more financial incentives (block 1628).

In one embodiment, the other data may include one or more search terms/queries, the operation of the intermediary 1002, such as via the search app 1810, further including transmitting the one or more search terms to one or more search engines on behalf of the user (block 1630), receiving the results therefrom (block 1632), and presenting the received results to the user (block 1634). The transmission of the one or more search terms to the one of more search engines may further occur without identifying the user or the first client 1004a. The operation may further include aggregating the received results from the one or more search engines (block 1636) and presenting the aggregated results to the user (block 1634), such as via the user interface 1020 and/or first client 1004a. The operation may further include processing the received results, such as by filtering or sorting the received results, removing advertising content, and/or removing data from content links within the search results which would allow the one or more search engines to track the user's selection of the content links, in accordance with the direction of the user (block 1638).

In one embodiment, the other data may include data related to at least one asset associated with the user, such as a photograph, descriptive information, user commentary, identifying information, metadata, content links to related information, or combinations thereof, the third function, which may be implemented by the asset management app 1806, comprising management thereof. Where the other data comprises a content link, such a link may reference asset warranty information, asset maintenance information, asset registration information, asset recall information, asset operation information, or combinations thereof. The other data may further include a location of at least one of the at least one asset, where the third function us further operative to manage movement of the one of the at least one asset. For example, the third function may be further operative to present the location of the one of the at least one asset to the user via the user interface 1020, report a change in the location of the one of the at least one asset to the user via the user interface 1020, such as only when the change deviates from a threshold defined by the user, and/or provide direction to the user via the user interface 1020 to direct the user to the location of the one of the at least one asset.

In one embodiment, the other data may further include sensor data sensed by a sensor (not shown) coupled with the first client 1004a, such as a radio frequency sensor, an optical sensor, an audio sensor, or combination thereof. For example, the sensor may be an RFID tag reader, the sensor data comprising data stored in an RFID tag associated with at least one of the at least one asset. The third function may further include notifying the user via the user interface 1020 when one of the sensor senses sensor data associated with one of the at least one asset, stops sensing sensor data associated with one of the at least one asset, or combinations thereof.

In one embodiment, the other data may include identification of content of interest to the user available from one or more content providers, such as one or more of the at least one server 1008a-n, where the third function, which may be implemented by the content portal app 1814, further comprising obtaining the content of interest from the one or more content providers and presenting the content of interest to the user, such as via the user interface 1020. The third function may be further operative to consolidate the obtained content of interest prior to the presentation thereof. The obtained content of interest may be further stored in the database 1012 from which the direction of the user is derived.

In one embodiment, the operation of the intermediary 1002 may further include analyzing at least a portion of the data stored in the database 1012 (block 1640) and generating a recommendation based thereon (block 1642), such as by analyzing at least the portion of the data stored in the database by topic, date, location or combinations thereof, and/or to identify patterns of behavior of the user. The operation may further include presenting the generated recommendation to the user via the user interface 1020 (block 1644). Where the other data comprises data representative of at least one user preference, the generation of the recommendation may further be based thereon. Where the other data comprises data representative of at least one context of the user and/or first client 1004a, such as the geographic location of user and/or the first client 1004a, the generation of the recommendation may be further based thereon. Where the other data comprises data representative of at least one sponsored recommendation, the generation of the recommendation may be further based thereon. The generated recommendation may include, for example, a recommended product or service or recommended action(s) for the user for managing privacy via the intermediary 1002. The generated recommendation may in the form of a reminder, such as a calendar reminder operative to prompt the user on a particular calendar date and/or time. It will be appreciated that the analyzing and generating functions may be implemented within the client 1004a so as to be able to be performed with or without network 1006 connectivity.

As was described above, systems and methods provided for tracking a user's usage of resources, such as servers 1008a-n, on the Internet or other network 1006 under the user's control, and for controlling the distribution of the user's usage/private data, are disclosed. A personal data endpoint is configured to operate on a computer or other device, such as a mobile device, including, or having, a client 1004a-n, that is connected to the network 1006, e.g. Internet. The personal data endpoint includes a network data interface configured to receive data communicated to and from a user of at least one personal application, such as a web browser program, email communications program, instant messaging program VoIP program, etc. The at least one personal application is configured to send and receive data over the network 1006, e.g. Internet. In one embodiment, a usage data logger stores usage data from the received data, and stores the usage data in a usage data log. Further, a usage data filter is configured to control communication of the usage data over the Internet and to inhibit communication of information identifying the user over the Internet.

### I. Personal Profile System

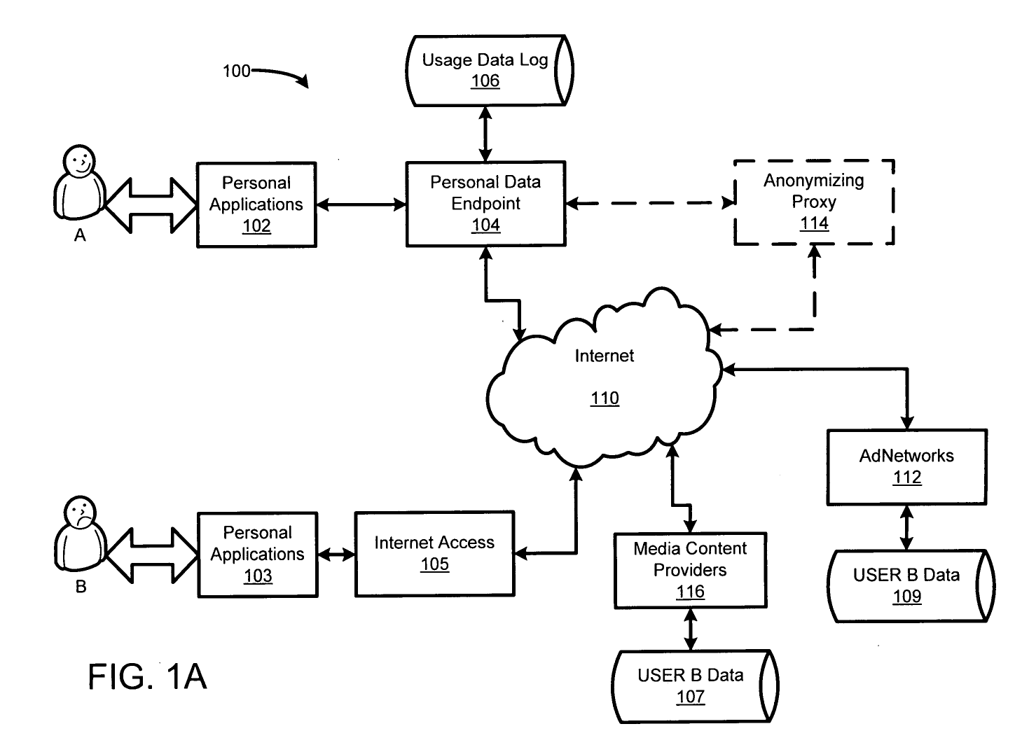

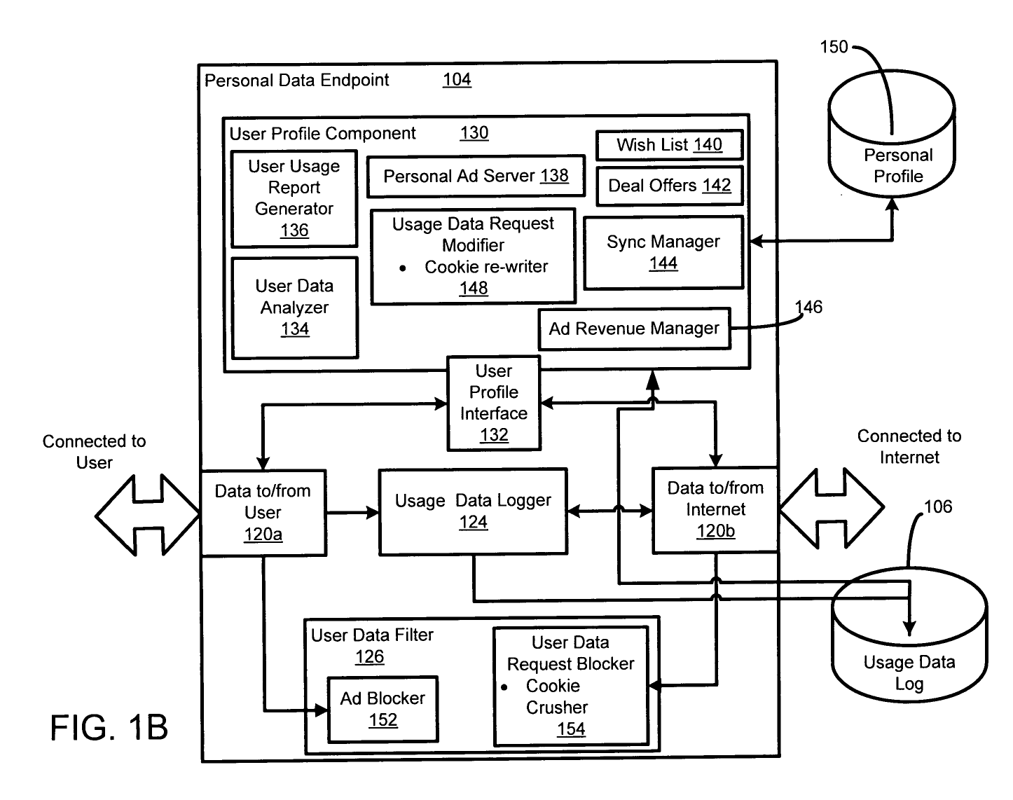

FIG. 1A is a block diagram of one embodiment an exemplary system 100 for performing commercial transactions over the Internet 110, which may include the network 1006. FIG. 1A depicts operation for two users, User A and User B. User A and User B perform commercial transactions using personal applications 102 and 103 connected via a networked device, such as clients 1004a-n, to the Internet 110. The Internet 110 may include any public data network accessible to the user via any suitable network infrastructure or protocol. The public network is “public” in that connectivity is available between any two networked entities capable of communicating on the network. Although any public data network may be used in the examples described below, reference is made to the “Internet” for purposes of illustration.

The commercial transactions available to User A and User B include: shopping, or accessing product and service information such as advertisements and electronic product brochures or catalogs; and purchasing products and services on-line. Advertisement and other product/service information are available to the users on the Internet 110 from media content providers 116 and also from AdNetworks 112. The media content providers 116 may be the actual product/service providers, or web content and media that may contain embedded ad links. The embedded ad links may include embedded ad content, Ad data requests, or links to advertisement media on the AdNetworks 112 or other accessible ad server.

User A may shop on-line by using the personal application 102, which may be, for purposes of illustration, a browser, to connect to the Internet 110 and access media provided by the web content providers 116. User B may shop on-line by using a similar personal application 103. The user (User A or User B) may begin shopping by receiving embedded ad links in the media received from the web content providers 116. The user is provided with information on products/services in the advertisement information received in the media content, and may initiate a process for obtaining additional information or a process that leads to a purchase on-line by selecting one or more links available in the advertisement information.

When a user “visits” a web site, such as a web site of the web content providers 116, the user sends a request for media content. The web content provider 116 responds to the request by sending the media. The response may also include at least one embedded ad link, such as an embedded ad or an Ad Data request. The Ad Data request may be configured to be automatically transmitted by the user's personal application, or the Ad Data request may be communicated by user selection. The Ad Data request may include personal information obtained from the user's device as well as a request for an advertisement. In the example illustrated in FIG. 1A, if the Ad Data request target is an AdNetwork or another server which is rated as privacy invading, the User A's configuration inhibits communication of User A's personal information from going to the AdNetwork. The user then simply sees the content that they requested. If the Ad Data request target is deemed as not privacy invading or if the user has assented to receiving ads from the Ad Data target, then the Ad Data request is allowed through the system to the destination Ad source. At this point the Ad Data is returned to the personal application and presented to User A. User B however lacks the protection available to User A. User B's personal information will be transmitted to the AdNetwork without User B's consent or even knowledge of its transmission.

The media content may also include user identifiers or files, such as “cookies,” that web content providers 116 and AdNetworks 112 use to monitor the user's on-line usage. The user identifiers are carried in the media content and install themselves in the hard disk of the user's networked device. Some media content may also include Trojans or malicious software used to access files and programs containing information desired by the web content providers and AdNetworks 112. User identifiers, “cookies,” Trojans and other programs used for extracting information from the user are referred to below as “usage data requestors.”

The type of information that may be desired when using usage data requestors includes information that helps the media content providers 116 and AdNetworks 112 determine the user's buying habits, product/service interests, and any other information that would allow the web content providers 116 and AdNetworks 112 to target the user for receiving particular advertisement information. Accordingly, the user's usage data may be processed to generate a user profile containing information about the user based on the usage data. This information may include the user's buying habits, product/service interests, demographic information, firmographic information, and any other personal information that the user may prefer to keep private or under the user's control. The information that may be desired by the web content providers 116 and the AdNetworks 112 is referred to below as the user's “usage data” or the user's “profile data.”

The example system 100 shown in FIG. 1A includes a personal data endpoint 104, which connects User A's personal application 102 to the Internet 110. The personal data endpoint 104 monitors the connection of the personal application 102 to the Internet 110 receiving all data going to and from User A at the personal applications 102. The personal data endpoint 104 stores records of the sites visited by User A in a usage data log 106. The personal data endpoint 104 protects the user's personal information from being distributed over the Internet 110 in an unauthorized manner. In example implementations, the personal data endpoint 104 may be configured to eliminate communication of all personal information except the IP address of the user's networked device. The IP address may be anonymized using a server pool of proxies such as The Onion Router (TOR).

User B in FIG. 1A connects to the Internet 110 via an internet access 105 without a personal data endpoint 104. The interne access 105 may be a server operating as an Internet Service Provider (“ISP”). Without the personal data endpoint 104, User B is susceptible to adware, cookies and other techniques for obtaining information about User B by unauthorized third-parties. For example, media content providers 116 may manage cookies on User B's user device or receive User B's personal information from Trojans or spyware embedded in User B's user device. The media content providers 116 may store User B's information in a database as User B data 107. Similarly, AdNetworks 112 may manage cookies on User B's user device or receive User B's personal information from Trojans or spyware embedded in User B's user device. The AdNetworks 112 may store User B's information and information derived by performing consumer behavior analysis on the usage data in a database as User B data 109. The media content providers 116 and the AdNetworks 112 may freely sell or distribute User B's information without any authorization from the User B let alone User B's knowledge.

The system 100 in FIG. 1A may also include an anonymizing proxy 114 to connect between the personal data endpoint 104 and the Internet. The anonymizing proxy 114 removes User A's Internet protocol (IP) address from User A's communications messages to prevent its transmission to third parties, such as media content providers 116 and AdNetworks 112. When using the anonymizing proxy 114, User A communicates with the Internet 110 via both the personal data endpoint 104 and the anonymizing proxy 114. The anonymizing proxy 114 may be implemented as a cluster or pool of proxy servers used by User A's networked device to communicate over the Internet 110.

User A and User B may perform commercial transactions using a browser as the personal application 102, 103. The user's personal applications 102, 103 may also include an email client, a text messaging client, financial and accounting applications, spreadsheets, or any other application configured to access data from the Internet. User A's personal data endpoint 104 may connect with a variety of personal applications 102 to obtain a variety of types of data that may be relevant to the user's shopping and buying tendencies. Such data is stored in the usage data log 106.

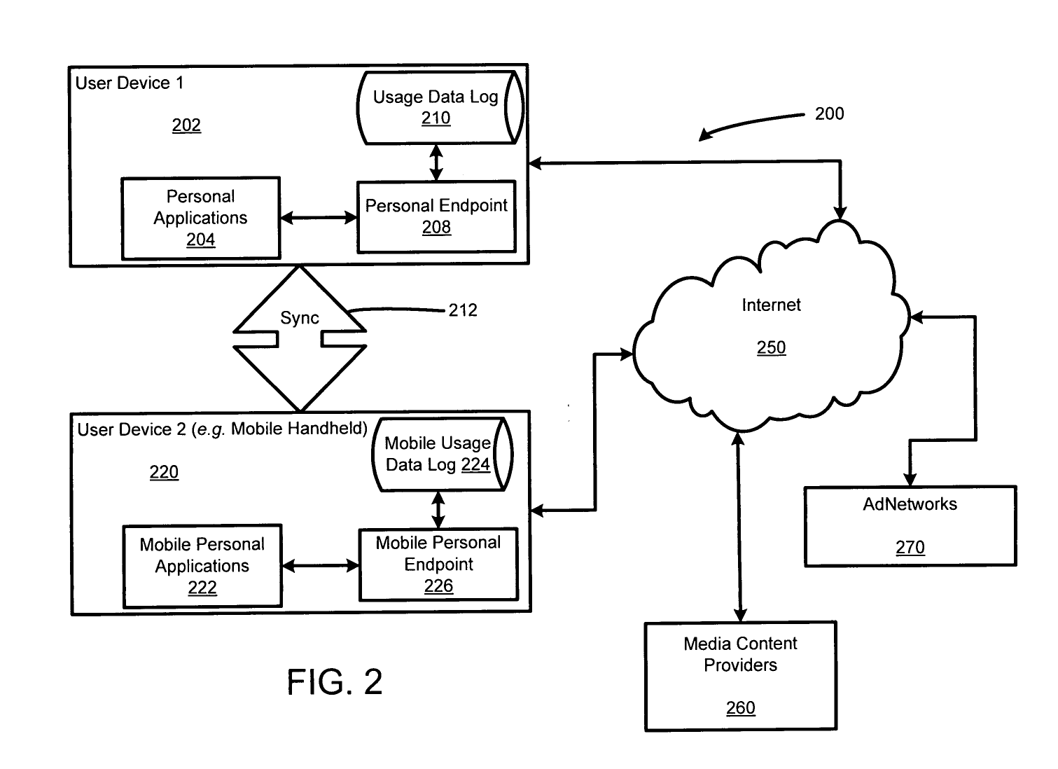

The system 100 in FIG. 1A may be implemented in many different ways. For example, a user may operate a networked device connected directly to the Internet 110 via an Internet Service Provider (ISP). The user's personal data endpoint 104 may operate in the user's networked device as a proxy server. The ISP may also include User A's personal data endpoint 104 as a proxy server or other type of servers that may be referenced when the user connects to the Internet 110. The user's networked device may also connect to the Internet 110 via an enterprise server, or some other server equipped to handle a user's connections to the Internet 110. The personal data endpoint 104 may be installed to operate on the enterprise server, or another connected server targeted for the task. Options for implementing the system 100 are described below in more detail with reference to FIGS. 2-5.

FIG. 1B is a block diagram of a personal data endpoint 104 that may be used in a system 100 shown in FIG. 1A. The personal data endpoint 104 in FIG. 1B includes a first transmitter/receiver (“transceiver”) 120a and a second transceiver 120b to transmit and receive data between the user and the Internet. A first transceiver 120a is connected to the user and a second transceiver 120b is connected to the Internet. The first transceiver 120a connects to the user via the user's personal application 102 (in FIG. 1A). It is to be understood by those of ordinary skill in the art that FIG. 1B depicts a logical representation of the transceivers 120a, b as it operates with the personal data endpoint 104. The personal data endpoint 104 may operate on the same computer operating the user's personal applications 102. The personal data endpoint 104 may also operate on another computer connected to a computer used by the user to operate the personal applications 102. Similarly, the personal data endpoint 104 may communicate with the Internet directly or via one or more other computers. The first transceiver 120a shown in FIG. 1B includes the hardware network interface and any I/O hardware and software resources needed to communicate between the user's personal application 102 wherever it may be operating and the personal data endpoint 104 software. The actual hardware and software implementation details may include a variety of solutions known to those of ordinary skill in the art; a more detailed description is therefore omitted for clarity.

The personal data endpoint 104 includes a usage data logger 124, a user data filter 126, and a user profile component 130. The usage data logger 124 is connected to the first and second transceivers 120a, b to receive data from either the user at the first transceiver 120a or from the Internet at the second transceiver 120b. The usage data logger 124 records data relating to content on the Internet accessed by the user. The data is stored as usage data in the usage data log 106. The user data filter 126 is connected to the first transceiver 120a and to the second transceiver 120b to control communication of a user's data and private information over the Internet. The user data filter 126 removes personal information and usage data or requests for advertisements from communications from the user to the Internet 110, and may prevent usage data requestors or personal information from being communicated to the user from the Internet 110.

The user data filter 126 in FIG. 1B includes an ad blocker 152 and a usage data requestor blocker 154. The ad blocker 152 inhibits communication of request for advertisements communicated from the user to the first transceiver 120a when the user has received content containing embedded ad links. The usage data requestor blocker 154 may be used to extract and delete usage data requestors, such as cookies, received from the Internet 110 over connections to web content providers 116 (in FIG. 1A).

The personal data endpoint 104 in FIG. 1B may also include a user profile component 130. The user profile component 130 may be used to configure, manage and maintain a personal profile containing usage data from the usage data log 106 as well as other personal information relating to the user. The personal profile includes data for analyzing a user's buying and shopping tendencies. The user profile component 130 may include tools for analyzing the usage data and managing information determined from the usage data and other information provided by the user.

The user profile component 130 in FIG. 1B includes a user profile interface 132, a user data analyzer 134, a usage report generator 136, a personal ad service 138, a wish list generator 140, a deal offer manager 142, a sync manager 144, an ad revenue manager 146, and a usage data requestor modifier 148. The user profile interface 132 may include a menu driven, or interactive form on a display and, input and output interfaces such as keyboard, buttons, mouse, and display to allow the user to control the menu, or interactive form on the display. The user may configure preferences and designate access control to the user's personal profile information. The user profile interface 132 may also provide access to resources connected to the Internet depending on controls and other settings provided by the user. By providing access to the Internet, the user may control how the user's usage data, usage data and other personal information is communicated to third-party resources, web content providers, and ad servers. The user's personal profile information may be stored in memory shown in FIG. 1B as a personal profile 150. The personal profile information may be stored in encrypted form to further enhance the privacy of the information.

The user data analyzer 134 processes user's usage data or information in the user's personal profile 150, and assesses the user's commercial or consumer behavior. The user data analyzer 134 may include well-known consumer behavior analysis tools used by Google, Yahoo! and other web content providers 116. Results of analysis or reports may be stored in a database, including the user's personal profile 150.

The user usage report generator 136 generates usage reports containing information about the user's commercial or consumer behavior. The usage report generator 136 may use results generated by the user data analyzer 134, or provide more raw data, such as the user's usage data. Reports may be generated for display on the user's networked device, for printout, or for communicating over the Internet under conditions governed by the user.

The personal ad service 138 provides requests for advertisement information based on the user's personal profile 150. The personal ad service 138 may be configured to maintain a queue or other type of data storage mechanism containing links to advertisement content that is relevant to the user's interests in products and services as determined from the usage data or information contained in the user's personal profile 150. When the user visits a web page containing media, the media may include embedded ad links. When the user's personal application 102 receives the embedded ad links, the personal application 102 (or another software component having an interface to both the network and the personal application 102) automatically sends requests for the advertisement content over the Internet 110. Adnetworks 112 (in FIG. 1A) receive the requests for advertisement content and respond by sending the advertisement content to the user. The personal ad service 138 substitutes the requests for advertisement content associated with the embedded ad links with the user's requests for advertisement content based on the user's interests.

The wish list generator 140 creates and maintains lists (“wish lists”) or shopping lists of products/services of interest to the user. The wish lists may be generated automatically using the user's profile information or usage data. The wish lists may also be created by the user via a user interface to the wish list generator 140 using menus, prompts, or interactive electronic forms. The wish lists may be maintained and published, or selectively communicated, to product providers and marketers on the Internet 110. The wish list generator 140 provides the user with a way of communicating information regarding the types of products and services of interest to the user and enable providers and marketers most likely capable of meeting the user's requests to respond. The wish list generator 140 may include information such as desired pricing, product details (such as size, color, etc. depending on the product), and other information that will allow the user to focus the search.

It is to be noted that the wish list generator 140 does not include personal identifying information in wish lists that are to be published, or otherwise communicated over the Internet 110. The wish list generator 140 may operate in conjunction with an electronic marketplace, or a bulletin board, or some other exchange-like system that would permit anonymous exchanges of information.

The deal offer manager 142 manages receipt and storage of deal offers from marketers and providers that may communicate deals, offers or other relevant information either in response to the user's wish list, or in response to communication of the user's wish list.

The sync manager 144 manages the process of syncing the user's profile and usage data information stored in the personal profile 150 and usage data log 106 with that of another device that the user may use to communicate over the Internet 110. The user may for example use a mobile handheld computer, or smart phone, or other portable computing device, and the portable device may include a mobile personal data endpoint that interfaces with the personal data endpoint 104 over, for example, a Wi-Fi connection. The portable device may include a sync manager, or handler, to permit a coordinated exchange of information permitting the user's network devices to remain up-to-date. Further descriptions of examples of coordinating syncing of data between devices are provided below with reference to FIGS. 2-4.

The ad revenue manager 146 manages revenue that may be generated by requests for advertisement communicated using the personal ad service 138.

The usage data requestor modifier 148 receives usage data requestors from web sites. Before sending them to the user's application 102, the usage data requestor modifier 148 modifies the usage data requestors based on information in the user's personal profile. For example, the usage data requestor modifier 148 may eliminate cookies, Trojans, or any other usage information requesting device from the communications between the user and public network sites to prevent their installation on the user's device.

The personal data endpoint 104 may be implemented as a computer program installed on any personal device. For example, the personal device may be a networked device, such as a network server or a personal computer used as a network station. The personal device may also be a mobile device such as a mobile phone, a laptop, a netbook, or any mobile device capable of communicating over a public network. In one example implementation, the personal data endpoint 104 is implemented as a plug-in, or add-on software component, for a browser, or similar type of personal application 102. The personal data endpoint 104 may include all or some of the functions described above with reference to FIG. 1B within an individual application. The functions may also be performed by other software components operating within the environment of the browser, or whatever personal application 102 being used to access the Internet 110. The personal data endpoint 104 may be implemented as a proxy server for applications that access public networks. The personal data endpoint 104 may also be implemented using a client-server structure in which a server portion operates on a network server device, and one or more client portions operate on one or more user terminals, such as a personal computer (desktop or laptop) and a portable handheld device. Various alternative implementations are described below with reference to FIGS. 2-5.

### II. Systems and Methods for Controlling Personal Information in E-Commerce

FIG. 2 is a block diagram of another example of the system shown in FIG. 1A. The system 200 in FIG. 2 includes a first user device 202, a second user device 220, a plurality of media content providers 260, and a plurality of advertisement servers 270 connected to the Internet 250. The first user device 202 may be a personal computer, such as a desktop, laptop, or other type of user workstation configured to operate as a user's “main” or “primary” access to content on the Internet 250. The second user device 220 may be any computer device as well. In the example shown in FIG. 2, the second user device 220 is a mobile computer, such as a mobile handheld device, a handheld computer (for example, Palm handhelds), a smart phone, a thin laptop (“netbook”), or a cell phone.

The first user device 202 includes at least one personal application 204, a personal data endpoint 208, and a usage data log 210. The at least one personal application 204 includes a browser, an email application, a messaging application (such as a SMS application), or any software application that allows a user to communicate over the Internet 250. The personal data endpoint 208 is a software component that is an example of the personal data endpoint 104 described above with reference to FIGS. 1A and 1B. The personal data endpoint 208 in FIG. 2 may be a plug-in for a browser, an add-on to an email program or messaging program, or a computer program that runs in the background as the user communicates over the Internet 250. The personal data endpoint 208 stores the user's usage data in the usage data log 210.

The second user device 220 includes at least one mobile personal application 222, a mobile personal data endpoint 226, and a mobile usage data log 224. The mobile personal applications 222 may include any application that provides a user with access to the Internet 250. The mobile personal application 222 may be a browser, or mini-browser, configured to run on a mobile device. The mobile personal application 222 may also be an email client, messaging application, or any other similar application. The mobile personal data endpoint 226 may be a relatively thin version of the personal data endpoint 104 shown in FIG. 1B, although the mobile personal data endpoint 226 may be more robust as mobile devices become more powerful. The mobile personal data endpoint 226 may include sufficient functions to record the user's usage data in the mobile usage data log 224 and to sync the information with the usage data log 210 in the first user device 202 at 212. The mobile usage data log 224 may be maintained in data memory that is substantially smaller in capacity than the memory available for the usage data log 210 in the first user device 202. The mobile personal data endpoint 226 may be configured to perform a synchronization of the usage data by uploading all usage data to the personal data endpoint 208. If the second user device 220 has sufficient memory, the mobile personal data endpoint 226 may be configured to perform synchronization by providing that both the second user device 220 and the first user device 202 have a mirrored image of the usage data in the usage data log 210 and the mobile usage data log 226.

The system 200 in FIG. 2 allows a user to perform commercial transactions on a mobile device used as a portable extension of the user's primary computing environment on the first user device 202. All usage data collected on the second user device 220 is made available to the user in a central location by synchronization 212 with the first user device 202. FIG. 2 shows a first and a second user device 202, 220, however, additional user devices may be added as part of the system 200 in FIG. 2.

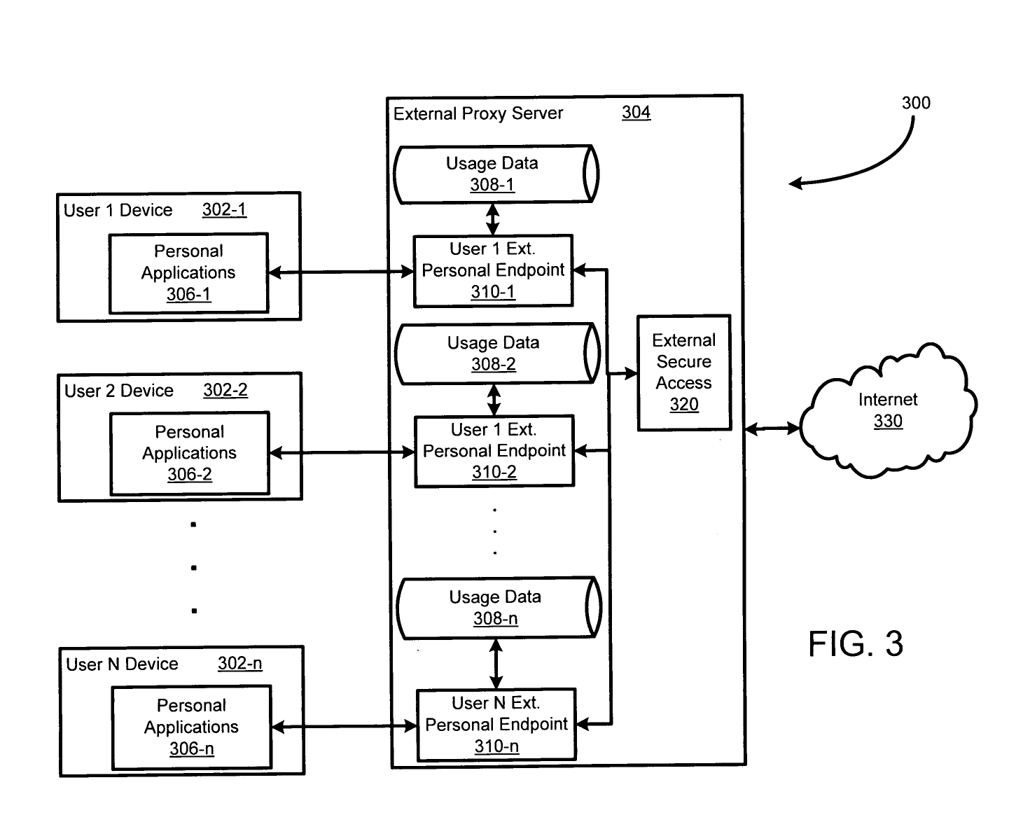

FIG. 3 is a block diagram of another example of the system shown in FIG. 1A. The system 300 in FIG. 3 includes a plurality of user devices 302-1 to 302-n (N user devices as shown in FIG. 3), an external proxy server 304 for providing the users of the user devices 302-1 to 302-n to the Internet 330. The external proxy server 304 includes a first personal data endpoint 310-1 and first usage data log 308-1 corresponding to the first user device 302-1, a second personal data endpoint 310-2 and second usage data log 308-2 corresponding to the second user device 302-2, and an nth personal data endpoint 310-n and an nth usage data log 308-n corresponding to the each of the n user devices 302-n.

The system 300 in FIG. 3 may be an example of an enterprise-implemented system. An enterprise hosts the user's Internet service using the external proxy server 304. The external proxy server 304 hosts the software components that operate as the personal data endpoints 310-1 to 310-n and the usage data logs 308-1 to 308-n. A user may connect to the Internet 330 from a user device 302-1 to 302-n using a personal application 306-1 to 306-n. The user's connection to the Internet 330 is made via the personal data endpoint 310-1 to 310-n. The personal data endpoints 310-1 to 310-n provide usage data recording functions and advertisement content control functions as described above with reference to FIG. 1B. For example, the personal data endpoints 310-1 to 310-n store usage data for the user of the corresponding user device 302-1 to 302-n. Also, for example, the personal data endpoints 310-1 to 310-n may delete or re-write cookies, or inhibit or re-configure requests for advertisement content corresponding to links in media content received from web sites over the Internet 330. The personal data endpoints 310-1 to 310-n also prohibit usage data, or other personal information from distribution over the Internet 330 in a manner not authorized by the user.

The external proxy server 304 may also include an external secure access function 320, which may provide the users with more secure access to the Internet 330 by providing that the resources to which the users connect do not receive the users' IP addresses.

The external proxy server 304 may be configured to provide the enterprise with control over the user's usage data, or with shared control over the user's usage data. The enterprise may realize advertisement revenue and may choose to share the revenue with the user. For example, the enterprise may sponsor or provide ad server resources that operate in accordance with the user profiles of the users that access the Internet via the external proxy server 304. The external proxy server 304 may be implemented as multiple computers configured as resource servers, such as a server farm or server nodes installed in the network infrastructure of one or more buildings. The external proxy server 304 may be used in the system 300 in FIG. 3 by an Internet service provider. The external proxy server 304 may also be used in the system 300 in FIG. 3 by any enterprise as part of the enterprise's computer network infrastructure.

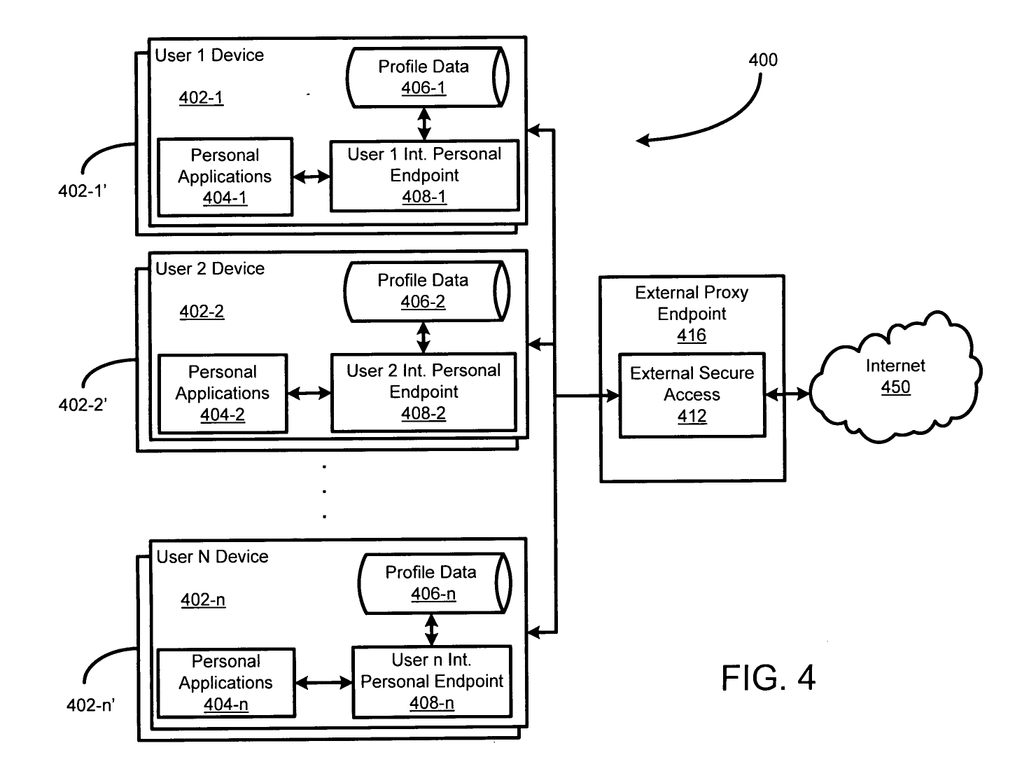

FIG. 4 is a block diagram of another example of the system shown in FIG. 1A. The system 400 includes a plurality of user devices 402-1 to 402-n connected to an external proxy endpoint 416, which provides users with access to the Internet 450. Users access the Internet 450 using the user devices user devices 402-1 to 402-n, each of which includes a personal application 404-1 to 404-n, an internal personal data endpoint 408-1 to 408-n, and a usage data log 406-1 to 406-n. The internal personal data endpoints 408-1 to 408-n are “internal” in that they operate in the user's device 402-1 to 402-n. Users may also access the Internet 450 using a mobile user device 402-1′ to 402-n′.

The internal personal data endpoints 408-1 to 408-n in each user device 402-1 to 402-n create a secure connection with the external proxy endpoint 416. The internal personal data endpoints 408-1 to 408-n perform usage data and profile management functions as described with reference to FIG. 1B above. The external proxy endpoint 416 may provide IP address anonymization, firewall tunneling, and other security functions. The external proxy endpoint 416 may include an external secure access 412 to provide a more secure connection by requiring authentication to enable the connection with the user.

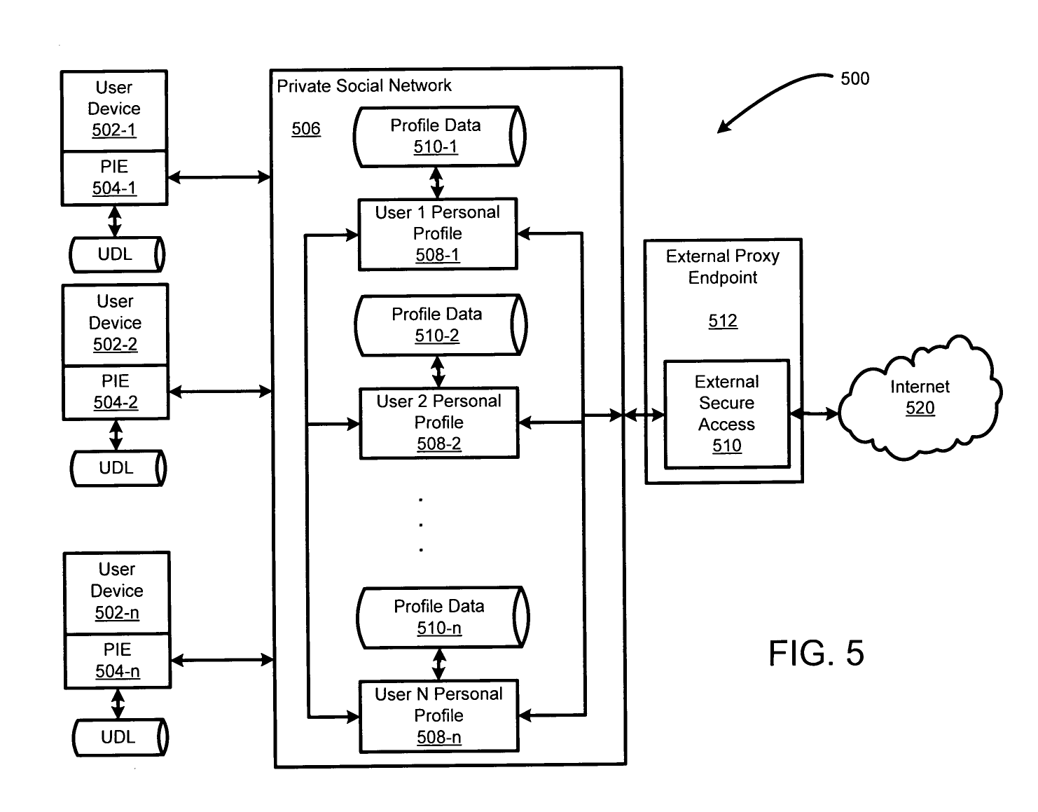

FIG. 5 is a block diagram of another example of the system shown in FIG. 1A. The system 500 in FIG. 5 uses a private social network 506, which is an on-line resource in which users create personal accounts and communicate with other users that access the private social network 506. The private social network 506 may include tools, such as email, messaging, chat tools, and other ways for users to communicate with one another. The private social network 506 may also allow the user to upload information from the user's networked device. The user may upload pictures, video, or other media for posting and/or sharing with other users of the private social network 506. Private social networks 506 may implement secure access procedures, such as requesting entry of a username and password to access one's own account. The user may also control the manner in which other users access personal information. Some examples of private social networks 506 include Facebook, Twitter, LinkedIn, Plaxo, and MySpace.

The system 500 in FIG. 5 may implement personal profiles and personal data endpoints to provide user control over the user's usage data, and to allow the users to communicate the usage data to the users' personal profiles. The private social network 506 may further include tools and resources that use the users' usage data to allow users to selectively communicate their commercial information, focus their shopping, and to allow marketers to target their product offerings.

In the system 500 in FIG. 5, users access the private social network 506 from user devices 502-1 to 502-n. The private social network 506 in FIG. 5 includes a personal profile 508-1 to 508-n for each of the n users having an account on the private social network 506. The user devices 502-1 to 502-n include a personal internal endpoint (“PIE”) 504-1 to 504-n connected to a corresponding usage data log (“UDL”). The user devices 502-1 to 502-n may be configured to operate as described above with reference to FIG. 2, 4 or 5. The user devices 502-1 to 502-n may also be configured without the PIE 504-1 to 504-n or UDL as shown in FIG. 3 and have personal data endpoint service implemented by an external server source. The personal profile 508-1 to 508-n and profile data 510-1 to 510-n may operate as a resource that uses usage data uploaded to the private social network 506 by the users to provide an interface to product/service marketers.

The users may maintain profile data 510 independent of the private social network account, but provide data from the profile 508 and profile data 510 in a controlled manner to the private social network. The user may thereby share comments, reviews, opinions, and other content with fellow private social network members without fear of distribution to potential employers or potential advertisers. The user's account may be configured to implement settings for the user's data security in conjunction with the private social network.

The system 500 in FIG. 5 also includes an external proxy endpoint 512 having an external secure access 510 for further securing connections between the users and the Internet 520 by requesting authentication to enable the connection with the user

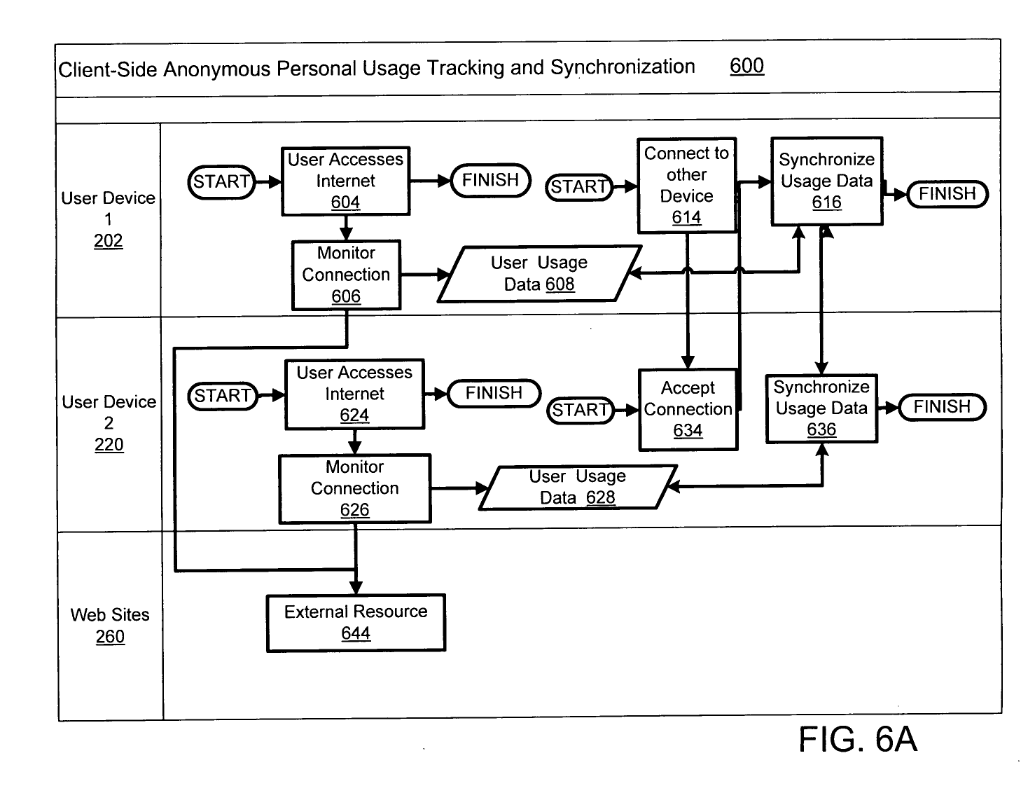

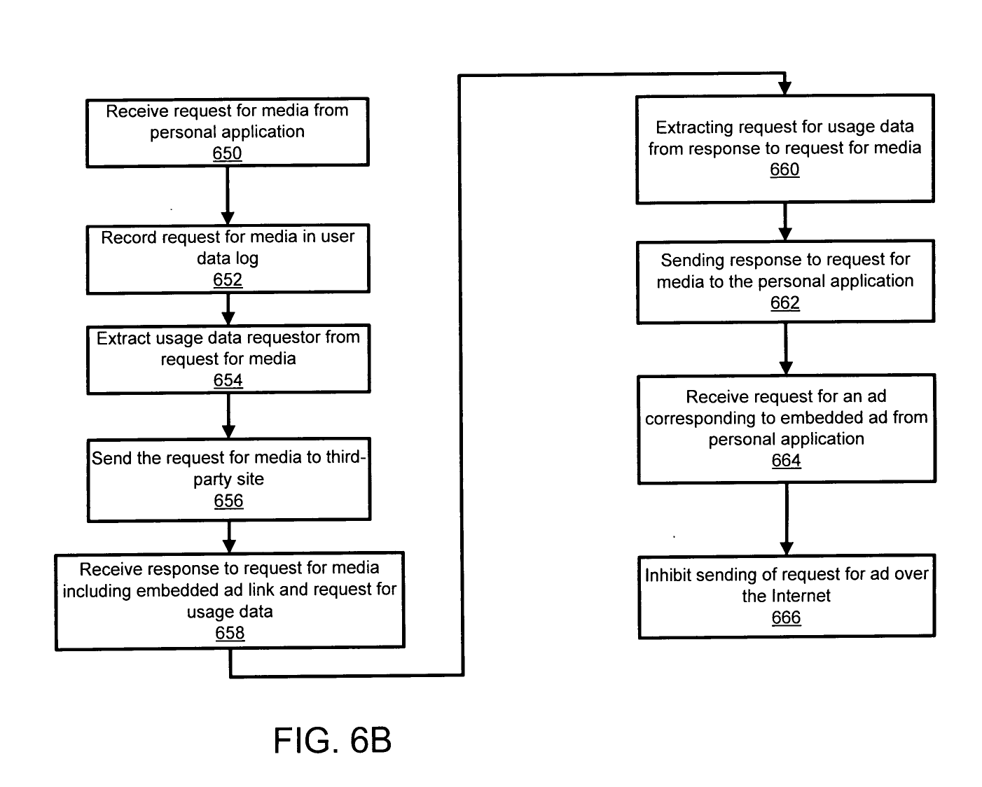

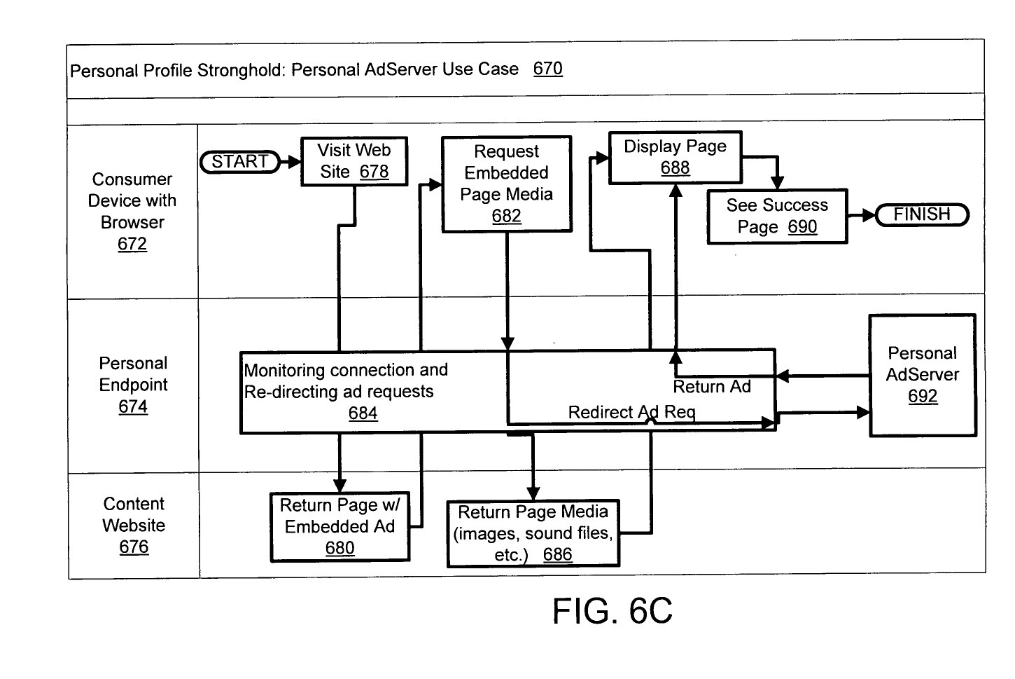

FIG. 6A is a cross-functional flow chart illustrating operation of an example of a method 600 for performing anonymous personal usage tracking and synchronization. FIG. 6A shows functions performed by devices in a system such as, for example, the system 200 shown in FIG. 2. FIG. 6A shows operations performed by the user device 1 202, the user device 2 220, and the web site 260.

The method 600 illustrated in FIG. 6A performs tracking of the usage made by a user of the Internet. The content that the user accesses on the Internet provides information that may be used to determine the user's buying, shopping and other commercial tendencies. The user may maintain this data and use it to selectively distribute the data to marketers and product/service providers based on the user's interests. The data may also be used as described below to enable a user to control or customize the commercial information (such as advertisements) that the user receives over Internet connections.

The tracking of usage may proceed in the background as the user accesses the Internet. For example, FIG. 6A depicts a user session on the Internet at 604 in which the user accesses the Internet and exchanges data with web sites available on the Internet from the user device 1 202. At step 606, a personal data endpoint on the user device 1 202 monitors the data connection. The personal data endpoint extracts data relating to the web site to which the user requests the connection, and to which a connection is made to the user. For example, data extracted may include the link identifying the web site 260 in FIG. 1B. The personal data endpoint stores the collected data as user usage data 608. The user usage data 608 may be compiled as usage data and used as described in more detail above with reference to FIG. 1B.

The tracking of usage may also proceed in the background when the user is accessing the Internet using another user device, such as the user device 2 220, that may be configured to operate in cooperation with the user device 1 202. For example, a user may use a personal computer as the user's primary access to the Internet. In the example illustrated in FIG. 6A, the user's personal computer, which may be a desktop or a laptop, or any other workstation configured for a user, is the user device 1 202. The user may also use a mobile handheld computer, or smartphone, or netbook, or other mobile computing device for access to the Internet when the user is away from the normal location of the user device 1 202. The mobile device is the user device 2 220 in the example shown in FIG. 6A. The user accesses the Internet at step 624 in a session on the user device 2 220. The user device 2 220 may include a mobile personal data endpoint for extracting the data relating to the web sites accessed by the user in a manner similar to the session that the user conducts from the user device 1 202 at step 604. A mobile personal data endpoint operating on the user device 2 220 extracts user usage data from the connections established by the user on the user device 2 220 at step 626. The user's usage data is stored as usage data at step 628.

The example shown in FIG. 6A illustrates how a single user maintains a usage data log using two user devices. The example also illustrates how the user may synchronize the usage data so that the user is not required to maintain two different usage data logs on two different devices. When the user desires to sync his usage data, the user first connects the user device 1 202 to the user device 2 220 to provide a communication link as shown at step 614. The user device 2 220 accepts the connection at step 634, and in conjunction with the user device 1 202, begins the process of synchronizing the usage data as shown at step 616. The process of syncing data between the two devices may include handshaking signals to control the exchange of data between syncing processes operating in conjunction on both devices as shown at steps 616 and 636. The exchange of data may proceed in both directions so that the result of synchronizing the devices is to achieve a mirror image between the usage data in the two devices. The exchange of data may also proceed in one direction so that one usage data store is being updated with new data from the other usage data store. The user devices 202, 220 may include status data for storing logs of the synchronizations and data about the usage data, such as the time and date on which it was stored. The status data assists in the syncing process by providing information about new data to be synced.

It is noted in FIG. 6A that the usage data and the user's personal information is not communicated to the web site 260 at step 644 when data is exchanged between the user and the web site 260. In addition, the connection created between the user and the web sites 260 created via the personal data endpoint at step 624 disables mechanisms used by third-party web sites to obtain the user's personal information or usage data. FIG. 6B is a flow chart illustrating operation of an example method for controlling communication of a user's usage data. The example method illustrated in FIG. 6B may be implemented as a computer program as part of monitoring the user's connections over the Internet. In the description below with reference to FIG. 6B, the example method is part of the functions performed by the personal data endpoint 208 in FIG. 2. It is to be understood that the personal data endpoint 208 of FIG. 2 is used as an example for purposes of illustrating operation of the method in FIG. 6B, and is not intended to limit operation of the example method in FIG. 6B to any specific implementation.

When a user begins the process of accessing media content on a web site, the user sends a request for the media from the user's personal application 204 (in FIG. 2), which for purposes of illustration is a web browser in this description. With the web browser connected via the network interface of the user device 1 202 to the Internet, the user selects a web site's address (or “URL”) for transmission over the Internet in a request for media. The web browser uses requests formatted as “HTTP” requests, which are well known to those of ordinary skill in the art. In the system 200 shown in FIG. 2, the request for media is received by the personal data endpoint 208 at step 650.

The personal data endpoint 652 records the request for media, or data related to the request for media, in the user's usage log, or usage data log, at step 652. The data recorded may include, without limitation, any of:
1. Target web site's address, which may be, for example, the site's URL, IP address if known, or any other identifier
2. Time of transmission
3. Date of transmission
4. Frequently used search terms
5. Usage data requestor, if contained in the request for media, for example, a cookie, which may include the following information:
   User identifier-previously assigned to the user by the web site
   Web site address, or URL
   User preferences for web site
   Account access information, e.g. user name and password

If the request for media includes a usage data requestor, the personal data endpoint 652 may remove it from the request for media. The usage data requestor may also be modified, or the usage data requestor may be permitted to remain part of the request for media under certain conditions. For example, if the usage data requestor is a copy of usage data requestors that have been previously stored in the usage data log, it may be permitted to remain in the request for media.

The request for media is transmitted over the Internet to the target web site at step 656. The web site responds to the request for media by sending the media content over the Internet. The media content is received by the personal data endpoint at step 658. The media content may include embedded ad links as well as usage data requestors. Usage data requestors may be included when the web site determines that the user is accessing the web site for the first time.

If the media content contains usage data requestors, the personal data endpoint may remove the usage data requestors from the media content at step 660. The usage data requestors may be discarded by performing a process known as “cookie crushing” when the usage data requestor is a “cookie.” The usage data requestors may also be modified before sending the media content to the browser. The response to the request for media is then communicated to the browser at step 662. The browser may then send a request for an advertisement based on the embedded ad link in the media content to be communicated over the Internet. The request for an advertisement is received at the personal data endpoint at step 664. The communication of the request for advertisement is stopped at step 666.

In an example implementation, the requests for advertisement may be re-configured. For example, requests for advertisement content may be re-directed to advertisement sources that provide advertisement content that is consistent with the user's interests. FIG. 6C is a cross-functional flow chart illustrating operation of an example of a method 670 in which the personal data endpoint 202 (described above with reference to FIG. 2) performs ad server functions. In the example in FIG. 6C, the user may access a web site at step 678 to initiate a web browsing session with the web site, for example. The connection to the web site 260 (FIG. 2) is initiated via the personal data endpoint at step 684, which monitors the connection. The personal data endpoint 202 communicates the request to connect to the web site on the web site 260. The web site returns a web page, which may include an embedded ad link at step 680, to the user device 202. The response to the request for media is communicated via the personal data endpoint 202. At step 682, the user device 202 process the web page, which may include displaying portions of the media on the user's display device.

The user device 202 also sends a request for the ad media related to the embedded ad link in the media content received from the web page. The personal data endpoint 202 receives the request for the ad media and redirects the request to a personal ad service 138 (FIG. 1B). The personal ad service modifies the request for ad media at step 692 by, for example, replacing the request for ad media with a request for ad media related to the user's interests. The personal ad service 138 may include preferences and properties of the original request for ad media. For example, the request for ad media may include size and position details for displaying the ad on the user's display. The reconfigured request for ad media includes a different target corresponding to a web site matching the user's interests. The personal ad service 138 may also replace the request for ad media with a replacement advertisement at step 692.

The personal ad service 138 response provides a revised ad, which is displayed on the user device 202 at step 688. The user may then access the advertisement on the page at step 690.

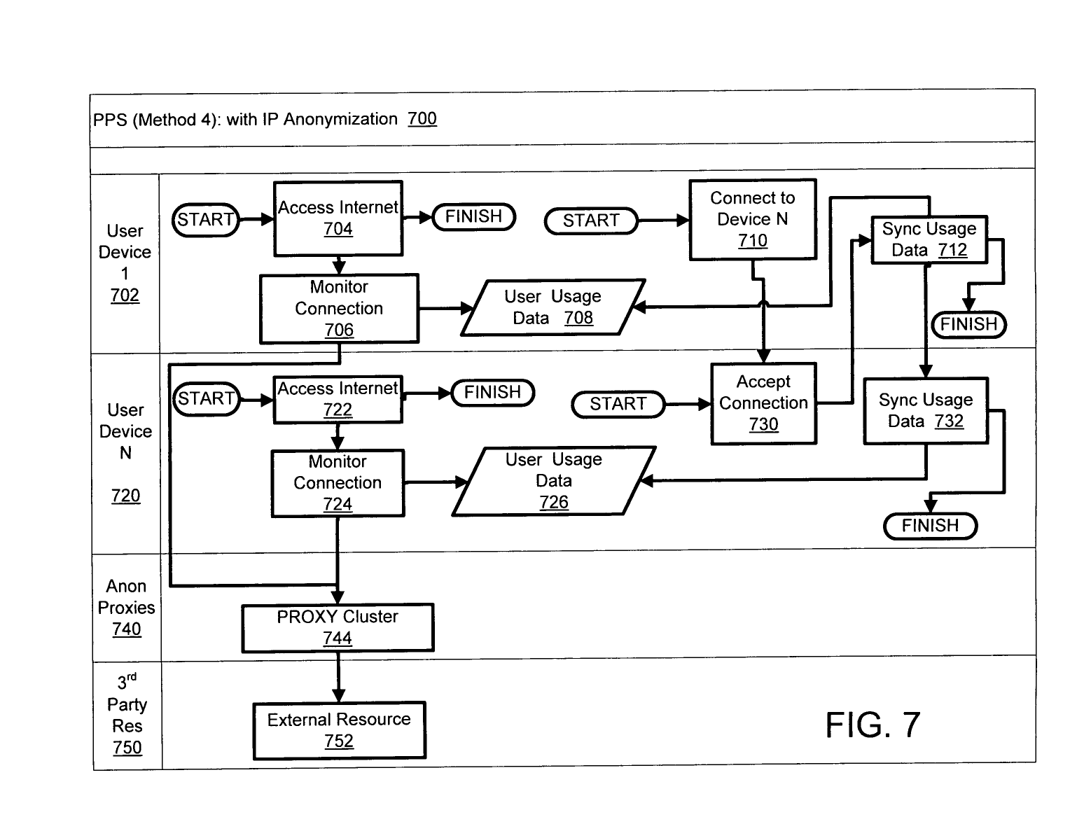

FIG. 7 is a cross-functional flow chart illustrating operation of a method 700 for performing usage tracking and synchronization in a system that includes an anonymizing proxy server. In the example method 700 in FIG. 7, the user accesses the Internet at step 704 to initiate a session with a web site 116 (in FIG. 1A). The connection is initiated and monitored via the personal data endpoint at step 706, which includes storing usage data at step 708. The connection initiation also includes the anonymizing proxy 114, which configures itself as an endpoint in a connection to the web site 116 at step 744. All connections that the user makes to providers on the Internet are made via the anonymizing proxy 114 and the personal data endpoint on the user device 202. The anonymizing proxy 114 anonymizes the connection by substituting the user's IP address in the connection request with a different IP address. During the session, the data is communicated between the web server 260 and the anonymizing proxy 114, and the anonymizing proxy 114 completes the connection to the user. The web server 260 communicates with the user via the anonymizing proxy 114 without having any information about the user or user device. The user participates in the session anonymously.

The example method shown in FIG. 7 includes steps in which the user initiates a session with the web servers 116 using the user device 2 220 at step 722 and 724. The session may be connected anonymously via the anonymizing connection at step 744. FIG. 7 also shows how the user usage data on the user device 1 202 may be synced with the user device 2 220 at steps 710, 712, 730, and 732.

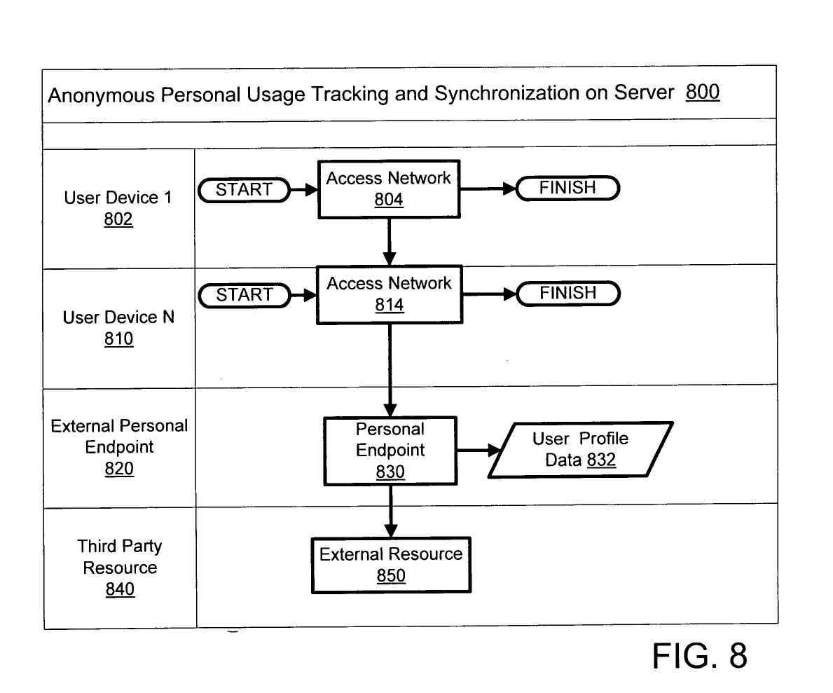

FIG. 8 is a cross-functional flow chart illustrating operation of a method 800 for performing usage tracking and synchronization using an external personal data endpoint 304 (FIG. 3). The description of the cross-functional flow chart in FIG. 8 that follows refers to the system 300 in FIG. 3.

In FIG. 3, the user devices 302-1 to 302-n are configured to access the Internet via the external proxy server 304. The external proxy server 304 includes a personal data endpoint 310-1 to 310-n and usage data log 308-1 to 308-n for each user device 302-1 to 302-n configured to access the Internet via the external proxy server 304.

Referring back to FIG. 8, to illustrate an example, the user, user 1, initiates a session on the Internet at step 804 using the user 1 device 302-1. The communication over the Internet is made via the personal data endpoint 310-1 corresponding to the user that is operating on the external proxy server 304 as shown in step 830. The personal data endpoint 310-1 tracks the user's usage of Internet services by storing information regarding the sites visited by the user in the user profile data 832. The personal data endpoint 310-1 also completes the connection to the external resources on web sites 260 at step 850.

FIG. 8 also shows the user 1 accessing the Internet using a second user device, mobile user 1 device 302-1′, which may be a portable computing device that operates as a mobile extension of the user's primary computing environment in the user 1 device 302-1. The user accesses the Internet at step 814 using the mobile user 1 device 302-1′. The user's connection to the Internet is made via the same personal data endpoint 310-1 on the external personal data endpoint 304 that is used for connecting the user's user 1 device 302-1. The usage data log is collected at step 832 for all of the user's connections to the Internet for either of the devices used by the user to connect to the Internet.

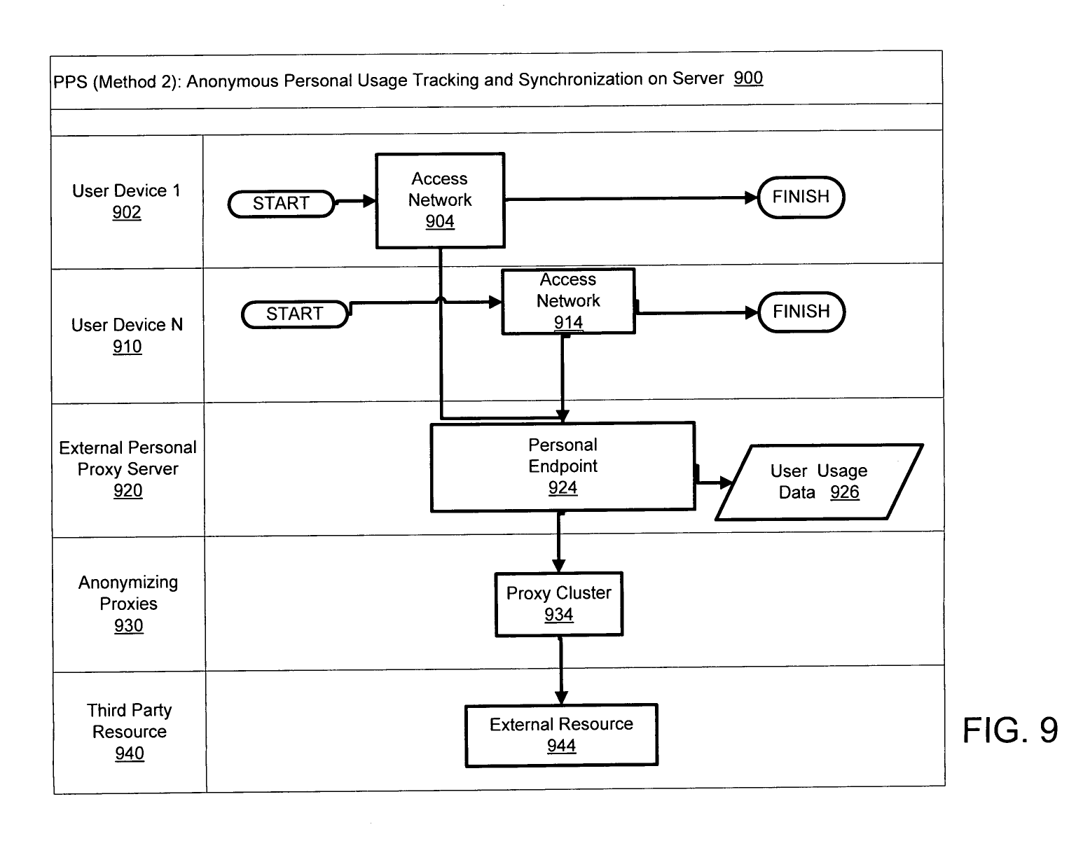

FIG. 9 is a cross-functional flow chart illustrating operation of a method 900 for performing usage tracking and synchronization in the system shown in FIG. 3 including an external personal data endpoint 304 and anonymizing proxies 114 (in FIG. 1A). The method 900 in FIG. 9 includes the steps of initiating sessions on the Internet using either the user 1 device 302-1 or the mobile user 1 device 302-1′ at steps 904 and 914, respectively. The connections are made via the personal data endpoint on the external proxy server 304 at step 924. The connections also include anonymizing proxies 114 at step 934.

As described above with reference to FIG. 7, the anonymizing proxies 114 inhibit communication of the user's IP address over the Internet. In communicating messages with a web site, the anonymizing proxy removes the user's IP address from the messages going to and from the user. The web sites communicate with the user, however, only “see” the anonymizing proxies 114.

### III. Alternative Networks

It is noted that the description of example implementations above used the Internet as an example of a public network in which the example implementations operate. It is to be understood by those of ordinary skill in the art that implementations within the scope as defined by the claims below are not limited to use of the Internet, or of the Web. Any public or private network over which enterprises advertise their products and services now known or later developed may be used in other example implementations. Public and private networks based on a variety of infrastructures may be used, such as Bluetooth, GPRS, wireless phone networks, satellite communications networks, broadcast radio networks, broadcast television networks, cable networks, power grid communications networks, and any other network over with communications connections may be established whether by wired connections or by wireless connections.

Referring to FIG. 17, an illustrative embodiment of a general computer system 700 is shown. The computer system 1700 can include a set of instructions that can be executed to cause the computer system 1700 to perform any one or more of the methods or computer based functions disclosed herein. The computer system 1700 may operate as a standalone device or may be connected, e.g., using a network, to other computer systems or peripheral devices. Any of the components discussed above may be a computer system 1700 or a component in the computer system 1700. For example, the computer system 600 may implement the intermediary 1002.

In a networked deployment, the computer system 1700 may operate in the capacity of a server or as a client user computer in a client-server user network environment, or as a peer computer system in a peer-to-peer (or distributed) network environment. The computer system 1700 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 1700 can be implemented using electronic devices that provide voice, video or data communication. Further, while a single computer system 1700 is illustrated, the term “system” shall also be taken to include any collection of systems or sub-systems that individually or jointly execute a set, or multiple sets, of instructions to perform one or more computer functions.

As illustrated in FIG. 17, the computer system 1700 may include a processor 1702, e.g., a central processing unit (CPU), a graphics processing unit (GPU), or both. The processor 1702 may be a component in a variety of systems. For example, the processor 1702 may be part of a standard personal computer or a workstation. The processor 1702 may be one or more general processors, digital signal processors, application specific integrated circuits, field programmable gate arrays, servers, networks, digital circuits, analog circuits, combinations thereof; or other now known or later developed devices for analyzing and processing data. The processor 1702 may implement a software program, such as code generated manually (i.e., programmed).

The computer system 1700 may include a memory 1704 that can communicate via a bus 1708. The memory 1704 may be a main memory, a static memory, or a dynamic memory. The memory 1704 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 1704 includes a cache or random access memory for the processor 1702. In alternative embodiments, the memory 1704 is separate from the processor 1702, such as a cache memory of a processor, the system memory, or other memory. The memory 1704 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 1704 is operable to store instructions executable by the processor 1702. The functions, acts or tasks illustrated in the figures or described herein may be performed by the programmed processor 1702 executing the instructions stored in the memory 1704. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 1700 may further include a display unit 1714, such as a liquid crystal display (LCD), an organic light emitting diode (OLED), a flat panel display, a solid state display, a cathode ray tube (CRT), a projector, a printer or other now known or later developed display device for outputting determined information. The display 1714 may act as an interface for the user to see the functioning of the processor 1702, or specifically as an interface with the software stored in the memory 1704 or in the drive unit 1706.

Additionally, the computer system 1700 may include an input device 1716 configured to allow a user to interact with any of the components of system 1700. The input device 1716 may be a number pad, a keyboard, or a cursor control device, such as a mouse, or a joystick, touch screen display, remote control or any other device operative to interact with the system 1700.

In a particular embodiment, as depicted in FIG. 17, the computer system 1700 may also include a disk or optical drive unit 1706. The disk drive unit 1706 may include a computer-readable medium 1710 in which one or more sets of instructions 1712, e.g. software, can be embedded. Further, the instructions 1712 may embody one or more of the methods or logic as described herein. In a particular embodiment, the instructions 1712 may reside completely, or at least partially, within the memory 1704 and/or within the processor 1702 during execution by the computer system 1700. The memory 1704 and the processor 1702 also may include computer-readable media as discussed above.

The present disclosure contemplates a computer-readable medium that includes instructions 1712 or receives and executes instructions 1712 responsive to a propagated signal, so that a device connected to a network 1720 can communicate voice, video, audio, images or any other data over the network 1720. Further, the instructions 1712 may be transmitted or received over the network 1720 via a communication port 618. The communication port 1718 may be a part of the processor 1702 or may be a separate component. The communication port 1718 may be created in software or may be a physical connection in hardware. The communication port 1718 is configured to connect with a network 1720, external media, the display 1714, or any other components in system 1700, or combinations thereof. The connection with the network 1720 may be a physical connection, such as a wired Ethernet connection or may be established wirelessly as discussed below. Likewise, the additional connections with other components of the system 1700 may be physical connections or may be established wirelessly.

The network 1720, which may be the same as network 1006, may include wired networks, wireless networks, or combinations thereof. The wireless network may be a cellular telephone network, an 802.11, 802.16, 802.20, or WiMax network. Further, the network 1720 may be a public network, such as the Internet, a private network, such as an intranet, or combinations thereof, and may utilize a variety of networking protocols now available or later developed including, but not limited to TCP/IP based networking protocols.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is therefore intended that the foregoing detailed description be regarded as illustrative rather than limiting, and that it be understood that it is the following claims, including all equivalents, that are intended to define the spirit and scope of this invention.

I claim:

1. An intermediary for use in a client-server architecture, the client-server architecture comprising at least one client in communication, via a network, with at least one server, each of the at least one server being operative to perform at least one unsolicited function with respect to each of the at least one client upon which one or more of the at least one server is at least partially dependent to facilitate stateful operation thereof with respect to the respective at least one client, each of the at least one unsolicited function comprising one of a first active function with respect to the respective client comprising provision of server originated data thereto or a second passive function with respect to the respective client comprising obtaining of client originated data therefrom, the intermediary comprising:
an interface in communication, via the network, with at least a first client of the at least one client and at least a first server of the at least one server and operative to, according to a direction of a user associated with the first client and derived at least in part from data indicative of previous interaction between the user and at least one of the at least one server, cause the first server to perform the at least one unsolicited function with respect to the intermediary on behalf of the first client, the stateful operation of the one or more of the at least one server at least partially dependent thereon thereby being subject to the direction of the user; and
a user interface operative to receive an instruction provided by the user to cause the intermediary to one of allow the at least one unsolicited function to be performed as if with respect to the first client, allow the at least one unsolicited function to be performed as if with respect to another client indistinguishable from at least one other of the at least one client, modify the at least one unsolicited function and perform the modified at least one unsolicited function with respect to the first client on behalf of the at least one server associated therewith, or inhibit the performance of the at least one unsolicited function.

2. The intermediary of claim 1 wherein the second passive function comprises collecting identifying information about the first client.

3. The intermediary of claim 1 wherein the first active function comprises transmitting a unique identifier to the first client to be stored thereby for subsequent retrieval.

4. The intermediary of claim 1 wherein the first active function comprises transmitting executable program code to the first client to be executed thereby to cause the first client to transmit identifying data.

5. The intermediary of claim 1 wherein the first active function comprises causing the first client to transmit a unique identifier.

6. The intermediary of claim 1 wherein the first active function comprises, in response to a request for content from the first client, adding additional content not requested by the first client thereto and transmitting the content and the additional content to the first client in response to the request.

7. The intermediary of claim 1 wherein the user is associated with another user and with a second client, the user interface being further operative to receive the instruction of the user to one of allow or inhibit the at least one unsolicited function with respect to the user, the other user, the first client, the second client, or a combination thereof.

8. The intermediary of claim 7 wherein the user is a parent and the other user is a child.

9. The intermediary of claim 1 wherein the interface is further operative to inhibit the at least one unsolicited function in exchange for a compensation from the user.

10. The intermediary of claim 1 wherein the interface is further operative to facilitate compensation to the user from a one of the at least one server to allow the performance of the at least one unsolicited function thereby at least as if with respect to the first client.

11. The intermediary of claim 1 further comprising at least one activity monitoring processor, each operative to monitor interactions of the first client comprising communications transmitted by the first client, transmitted to the first client, or combinations thereof, and store data representative of the interactions in a database from which the direction of the user is at least in part derived.

12. The intermediary of claim 11 wherein each of the at least one activity monitor is operative to monitor communications characterized by a particular communications protocol, by a particular subject matter, or combination thereof.

13. The intermediary of claim 11 wherein the user is associated with a second client, at least one of the at least one activity monitoring processor being further operative to monitor interactions of the second client comprising communications by the second client, transmitted to the second client, or combinations thereof, and store data representative of the interaction of the second client in the database.

14. The intermediary of claim 11 further comprising at least one profile processor coupled with the database, each of the at least one profile processor being operative to analyze at least a subset of the stored data representative of the interactions of the first client and generate at least one user profile based thereon, wherein the direction of the user is derived from at least one of the at least one user profile.

15. The intermediary of claim 14 wherein the at least one user profile comprises data characterizing the user at least one of demographically, firmographically, contextually, behaviorally, temporally, preferentially, or combinations thereof.

16. The intermediary of claim 14 wherein the user interface is further operative to facilitate viewing the at least one user profile, modifying the at least one user profile, augmenting the at least one user profile or combinations thereof, by the user.

17. The intermediary of claim 14 wherein the interface is further operative to facilitate access to at least a subset of the at least one user profile by a third party in exchange for compensation.

18. The intermediary of claim 17 wherein the third party comprises one of the at least one server whose performance of the first function was inhibited by the interface.

19. The intermediary of claim 17 wherein the subset of the at least one user profile is defined contextually, temporally, geographically, based on specificity, or combinations thereof.

20. The intermediary of claim 11 wherein the interface is further operative to facilitate augmentation of the database by the user.

21. The intermediary of claim 11 wherein the interface is further operative to facilitate augmentation of the database by the first client based on a temporal context, geographic context, environmental context, or a combination thereof.

22. A method of facilitating management of unsolicited server operations in a client-server architecture by an intermediary comprising a processor and an interface coupled therewith, the client-server architecture comprising at least one client in communication, via a network, with at least one server, each of the at least one server being operative to perform at least one unsolicited function with respect to each of the at least one client upon which one or more of the at least one server is at least partially dependent to facilitate stateful operation thereof with respect to the respective at least one client, each of the at least one unsolicited function comprising one of a first active function with respect to the respective client comprising provision of server originated data thereto or a second passive function with respect to the respective client comprising obtaining of client originated data therefrom, the method comprising:
causing by the processor via the interface, the interface being in communication, via the network, with at least a first client of the at least one client and at least a first server of the at least one server and operative to, according to a direction of a user associated with the first client and derived at least in part from data indicative of previous interaction between the user and at least one of the at least one server, the first server to perform the at least one unsolicited function with respect to the intermediary on behalf of the first client, the stateful operation of the one or more of the at least one server at least partially dependent thereon thereby being subject to the direction of the user; and
receiving, via a user interface coupled with the processor, an instruction provided by the user to cause the intermediary to one of allow the at least one unsolicited function to be performed as if with respect to the first client, allow the at least one unsolicited function to be performed as if with respect to another client indistinguishable from at least one other of the at least one client, modify the at least one unsolicited function and perform the modified at least one unsolicited function with respect to the first client on behalf of the at least one server associated therewith, or inhibit the performance of the at least one unsolicited function.

23. The method of claim 22 wherein the second passive function comprises collecting identifying information about the first client.

24. The method of claim 22 wherein the first active function comprises transmitting a unique identifier to the first client to be stored thereby for subsequent retrieval.

25. The method of claim 22 wherein the first active function comprises transmitting executable program code to the first client to be executed thereby to cause the first client to transmit identifying data.

26. The method of claim 22 wherein the first active function comprises causing the first client to transmit a unique identifier.

27. The method of claim 22 wherein the first active function comprises, in response to a request for content from the first client, adding additional content not requested by the first client thereto and transmitting the content and the additional content to the first client in response to the request.

28. The method of claim 22 wherein the user is associated with another user and with a second client, the user interface being further operative to receive the instruction of the user to one of allow or inhibit the at least one unsolicited function with respect to the user, the other user, the first client, the second client, or a combination thereof.

29. The method of claim 28 wherein the user is a parent and the other user is a child.

30. The method of claim 22 further comprising inhibiting the at least one unsolicited function in exchange for a compensation from the user.

31. The method of claim 22 further comprising facilitating provision of compensation to the user from a one of the at least one server to allow the performance of the at least one unsolicited function thereby at least as if with respect to the first client.

32. The method of claim 22 further comprising monitoring interactions of the first client comprising communications transmitted by the first client, transmitted to the first client, or combinations thereof, and storing data representative of the interactions in a database from which the direction of the user is at least in part derived.

33. The method of claim 32 wherein monitoring further comprises monitoring communications characterized by a particular communications protocol, by a particular subject matter, or combination thereof.

34. The method of claim 32 wherein the user is associated with a second client, the monitoring further comprises monitoring interactions of the second client comprising communications by the second client, transmitted to the second client, or combinations thereof, and storing data representative of the interaction of the second client in the database.

35. The method of claim 32 further comprising analyzing at least a subset of the stored data representative of the interactions of the first client and generating at least one user profile based thereon, wherein the direction of the user is derived from at least one of the at least one user profile.

36. The method of claim 35 wherein the at least one user profile comprises data characterizing the user at least one of demographically, firmographically, contextually, behaviorally, temporally, preferentially, or combinations thereof.

37. The method of claim 35 further comprising facilitating viewing the at least one user profile, modifying the at least one user profile, augmenting the at least one user profile or combinations thereof, by the user.

38. The method of claim 35 further comprising facilitating access to at least a subset of the at least one user profile by a third party in exchange for compensation.

39. The method of claim 38 wherein the third party comprises one of the at least one server whose performance of the first function was inhibited by the interface.

40. The method of claim 38 wherein the subset of the at least one user profile is defined contextually, temporally, geographically, based on specificity, or combinations thereof.

41. The method of claim 32 further comprising facilitating augmentation of the database by the user.

42. The method of claim 32 further comprising facilitating augmentation of the database by the first client based on a temporal context, geographic context, environmental context, or a combination thereof.

43. An intermediary for use in a client-server architecture, the client-server architecture comprising at least one client in communication, via a network, with at least one server, each of the at least one server being operative to perform at least one unsolicited function with respect to each of the at least one client upon which one or more of the at least one server is at least partially dependent to facilitate stateful operation thereof with respect to the respective at least one client, each of the at least one unsolicited function comprising one of a first active function with respect to the respective client comprising provision of server originated data thereto or a second passive function with respect to the respective client comprising obtaining of client originated data therefrom, the intermediary comprising:
means for causing by the processor via an interface, the interface being in communication, via the network, with at least a first client of the at least one client and at least a first server of the at least one server and operative to, according to a direction of a user associated with the first client and derived at least in part from data indicative of previous interaction between the user and at least one of the at least one server, the first server to perform the at least one unsolicited function with respect to the intermediary on behalf of the first client, the stateful operation of the one or more of the at least one server at least partially dependent thereon thereby being subject to the direction of the user; and
means for receiving, via a user interface coupled with the processor, an instruction provided by the user to cause the intermediary to one of allow the at least one unsolicited function to be performed as if with respect to the first client, allow the at least one unsolicited function to be performed as if with respect to another client indistinguishable from at least one other of the at least one client, modify the at least one unsolicited function and perform the modified at least one unsolicited function with respect to the first client on behalf of the at least one server associated therewith, or inhibit the performance of the at least one unsolicited function.

44. An intermediary for use in a client-server architecture, the client-server architecture comprising at least one client in communication, via a network, with at least one server, each of the at least one server being operative to perform at least one unsolicited function with respect to each of the at least one client upon which one or more of the at least one server is at least partially dependent to facilitate stateful operation thereof with respect to the respective at least one client, each of the at least one unsolicited function comprising one of a first active function with respect to the respective client comprising provision of server originated data thereto or a second passive function with respect to the respective client comprising obtaining of client originated data therefrom, the intermediary comprising a processor and a memory coupled therewith:
first logic stored in the memory and executable by the processor to, via an interface in communication, via the network, with at least a first client of the at least one client and at least a first server of the at least one server and operative to, according to a direction of a user associated with the first client and derived at least in part from data indicative of previous interaction between the user and at least one of the at least one server, cause the first server to perform the at least one unsolicited function with respect to the intermediary on behalf of the first client, the stateful operation of the one or more of the at least one server at least partially dependent thereon thereby being subject to the direction of the user; and
second logic stored in the memory and executable by the process to, via a user interface, receive an instruction provided by the user to cause the intermediary to one of allow the at least one unsolicited function to be performed as if with respect to the first client, allow the at least one unsolicited function to be performed as if with respect to another client indistinguishable from at least one other of the at least one client, modify the at least one unsolicited function and perform the modified at least one unsolicited function with respect to the first client on behalf of the at least one server associated therewith, or inhibit the performance of the at least one unsolicited function.
